(19) United States
(12) Patent Application Publication
(10) Pub. No.: US 2019/0271550 A1
(43) Pub. Date: Sep. 5, 2019

(54) System and Method for Creating, Updating, and Using Maps Generated by Probe Vehicles

(71) Applicant: INTELLIGENT TECHNOLOGIES INTERNATIONAL, INC., Miami Beach, FL (US)

(72) Inventors: David S BREED, Miami Beach, FL (US); Olexander LEONETS, Kyiv (UA); Vyacheslav SOKURENKO, Kyiv (UA); Igor LYSENKO, Chernihiv (UA); Oleksandr SHOSTAK, Kyiv (UA)

(73) Assignee: Intelligent Technologies International, Inc., Miami Beach, FL (US)

(21) Appl. No.: 16/317,622

(22) PCT Filed: Jul. 20, 2017
(86) PCT No.: PCT/US2017/042997

§ 371 Date: Jan. 14, 2019

Related U.S. Application Data
(60) Provisional application No. 62/519,247, filed on Jun. 14, 2017.
(60) Provisional application No. 62/481,881, filed on Apr. 5, 2017.
(60) Provisional application No. 62/465,610, filed on Mar. 1, 2017.
(60) Provisional application No. 62/413,686, filed on Oct. 27, 2016.
(60) Provisional application No. 62/364,896, filed on Jul. 21, 2016.

(51) Int. Cl. G01C 21/32; G06F 16/29; G06T 17/05; G01C 21/16; G01S 19/49

(52) U.S. Cl. CPC G01C 21/32; G06F 16/29; G01S 19/49; G01C 21/165; G06T 17/05

(57) ABSTRACT

System and method for managing and using a map database includes creating the database using mapping vehicles and enabling access to the database by people and other vehicles to enable use of determined position of identified landmarks, data about roads on which the mapping vehicles were driven and the images and content thereof. The database is created by driving mapping vehicles on roads, obtaining images of an area on and around roads using at least one camera assembly on each mapping vehicle, identifying common landmarks in obtained images, determining position of each mapping vehicle using a satellite positioning system such that the position at which each image is obtained by the mapping vehicle is accurately known, and determining the position of each identified landmark in consideration of determined vehicle position when the image containing the landmark is obtained.

### TECHNICAL FIELD

The present invention relates generally to systems and methods for using the Global Navigation Satellite System (GNSS) and images to create accurate maps and to locate a vehicle without the use of the GNSS system.

### BACKGROUND ART

This application uses cameras (more generally referred to as imaging devices) and an accurate navigation system to develop accurate maps usually with only a single pass of an equipped vehicle over a lane to be mapped. In contrast to more commonly used mapping systems based on lidar, the inventive system is not easily hacked and thus map security and vehicle position security is maintained.

Additional detailed discussion of background information is set forth in U.S. Pat. Nos. 6,405,132, 7,085,637, 7,110,880, 7,202,776 and 9,103,671, and U.S. patent application Ser. No. 14/570,638 filed Dec. 15, 2014. Definitions of terms used in the specification and claims may be found in these applications.

### SUMMARY OF THE INVENTION

It is an object of the present invention to provide new and improved methods and arrangements for creating accurate maps using the GNSS satellite system and photographic techniques and then accurately locating vehicles operating on roadways using only photographic techniques as a substitute for GNSS satellite location systems.

To achieve this object and others, a method and system for locating vehicles operating on mapped terrain including one or more roads includes a vehicle equipped with at least one camera and an inertial measurement unit (IMU) that provides at least one (inertial) kinematic property of the vehicle, all of which are in a set configuration relative to one another. A processor on the vehicle, or at a remote location apart from the vehicle, converts images from the camera(s) and locates defined objects, such as poles, referred to herein as landmarks, and compares the location in an image of such landmarks with their location on a map if present on the map. Later in the localization mode, any discrepancies between the mapped location and the image determined location are used to correct the IMU such that when the corrected IMU is used in the comparison calculations, the image locations and the mapped location of the landmarks are made coincident.

Other improvements will now be obvious to those skilled in the art. The above features are meant to be illustrative and not definitive.

There are disclosed several processors or controllers, that perform various control operations. The specific form of processor is not important to the invention. In its preferred form, the computing and analysis operations are divided into several cooperating computers or microprocessors. However, with appropriate programming well known to those of ordinary skill in the art, the inventions can be implemented using a single, high power computer. Thus, it is not applicant's intention to limit the invention to any particular form or location of processor or computer. For example, it is contemplated that in some cases, the processor may reside on a network connected to the vehicle such as one connected to the Internet.

Further examples exist throughout the disclosure, and it is not applicant's intention to exclude from the scope of the inventions the use of structures, materials, or acts that are not expressly identified in the specification, but nonetheless are capable of performing a claimed function.

### BRIEF DESCRIPTION OF DRAWINGS

Various hardware and software elements used to carry out the invention described herein are illustrated in the form of system diagrams, block diagrams, flow charts, and depictions of neural network algorithms and structures. Preferred embodiments are illustrated in the following figures:

FIG. 1 illustrates a Wide Area Differential Global Navigation Satellite System (WADGNSS) system with GNSS satellites transmitting position information to a vehicle and to base stations which transmits directly or indirectly a differential correction signal to the vehicle.

FIG. 2 is a diagram showing a combination of a GNSS system and an inertial measurement unit (IMU).

FIG. 3 illustrates a car driving on a lane and imaging a sign landmark from various positions during its travel.

FIG. 4 is a plot of errors in locating a pole landmark as a function of the number of images acquired and spacing of the images.

FIG. 5 is a plot of errors for poles or other landmarks located at various distances off the road and the number on images considered when the images are equally spaced over 100 meters.

FIG. 6 is a photogrammetry flowchart illustrating map creation.

FIG. 7 is a flowchart illustrating an algorithm for locating landmarks during map creation.

FIG. 8 is a flowchart with calculations performed in the cloud for map creation.

FIG. 9 is a flowchart with calculations performed on-vehicle for image compression.

FIG. 10 is a depiction of a parking spot reservation or management system.

FIG. 11 is a depiction of an image with a landmark and anchor point.

FIG. 12 is a flow chart of a method for managing updates to a map database.

FIG. 13 illustrates a vehicle with a camera, two GNSS antennas and an electronics package.

FIG. 14 is a detail of the electronics package shown in FIG. 13.

FIG. 15 is a detail of the camera and GNSS antenna shown in FIG. 13.

FIG. 16 illustrates use of two cameras.

FIG. 17 is a block diagram of electronics system of FIG. 14.

FIG. 18 is an implementation of the invention using a commercially available camera.

FIG. 19 is an enlarged view of a camera assembly shown in FIG. 18.

FIG. 20 illustrates use of two commercially available cameras which are not collocated.

FIG. 21 illustrates a first embodiment wherein an inventive system is integrated into a production vehicle with camera assemblies incorporated into A-Pillars of the vehicle.

FIG. 22 illustrates an embodiment similar to that shown in FIG. 21, wherein an inventive system incorporates a third camera providing an approximate 180° total field of view (FOV).

FIG. 23 illustrates an embodiment similar to that shown in FIG. 21, wherein an inventive system includes two collocated camera assemblies.

FIG. 24 illustrates lens image barrel distortions.

FIG. 25 illustrates distortions caused when a rolling shutter camera is used.

FIG. 26 illustrates an embodiment wherein a system is integrated into a production vehicle with four camera assemblies incorporated into a vehicle roof, at the midpoints of the sides, such that a small portion of the FOV of each camera overlaps with two of the other cameras.

FIG. 27 is the same as FIG. 26 with the cameras placed in the corners of the vehicle roof

FIG. 28 illustrates an embodiment like FIG. 26 wherein a system is integrated into a production vehicle with eight camera assemblies incorporated into a vehicle roof such that a significant portion of the FOV of each camera overlaps with four other cameras.

FIG. 29 is a flowchart of a parking spot reservation or management system in accordance with the invention.

FIG. 30 illustrates an embodiment similar to that shown in FIG. 21, wherein a system in accordance with the invention incorporates three roof-mounted cameras each providing a 120° field of view (FOV) for complete surround-vehicle monitoring.

FIG. 31 illustrates an embodiment like FIGS. 21-23 and 30 wherein a system is integrated into a production vehicle with three camera assemblies incorporated into a vehicle roof such that a small portion of the FOV of each camera overlaps with at least one other camera as well as observing a common area of the vehicle roof for registration purposes.

FIG. 32 illustrates a method of using a carrier wave from a common satellite and relaying it to a mapping vehicle from three or more RTK stations to provide a location method which does not require the vehicle to communicate with the GNSS satellites.

FIG. 33 is a flowchart on how IMU errors are corrected using photogrammetry to eliminate the need for the GNSS satellites allowing a vehicle to locate itself using landmarks and a map.

### BEST MODE FOR CARRYING OUT INVENTION

### 1. Accurate Navigation General Discussion

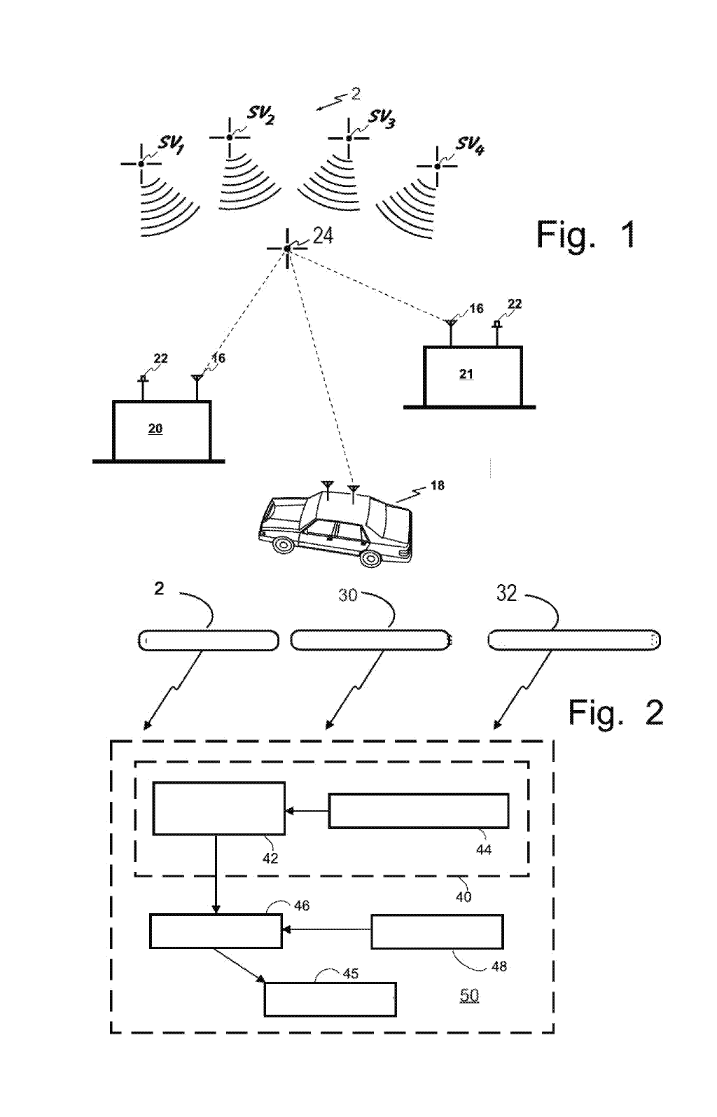

FIG. 1 illustrates a prior art arrangement of four satellites 2, designated SV₁, SV₂, SV₃ and SV₄ of a global navigation satellite system (GNSS), such as the Global Positioning System (GPS), that operatively transmit position information to receivers of base stations 20 and 21, such as by an antennas 22 associated with base stations 20, 21. Base stations 20, 21 transmit a differential correction signal via associated transmitters, such as a second antenna 16, to a geocentric or low earth orbiting (LEO) satellite 24 or to the Internet by some other path. LEO satellite 24 transmits differential correction signals to a vehicle 18 or the corrections are obtained from the Internet or by some other path. One preferred path, as described below, is where base stations 20 and 21 are Real Time Kinematic (RTK) base stations which are nearby the vehicle 18 and through comparison of the phases of the satellite carrier frequencies, centimeter level positioning of the vehicle 18 is obtained.

In the case of Wide Area Differential GNSS (WADGNSS), base station 20 and/or 21 receives and performs mathematical analysis (using a processor, processing system or the like situated at least partly at the base station 20, 21) on all signals received from a number of base stations 20, 21 that cover the area under consideration and forms a mathematical model of errors in GNSS signals over the entire area. For the continental United States (CONUS), a group of 13 or more geographically distributed base stations are operated by OmniSTAR. By considering data from the entire group of base stations, errors in GNSS signals for the entire area can be estimated, resulting in a one sigma position accuracy of about 6-10 cm or better over the entire area. Corrections can then be uploaded to the geocentric or LEO satellite 24, or to the Internet, for retransmission to vehicles 18.

Alternatively or additionally, corrections can be made available to the vehicle 18 via the Internet or other appropriate communication system. In this manner, each of a plurality of vehicles 18, or componentry at least partly thereon (a processor, processing system, positioning system or the like), is able to determine its absolute position to within less than about 10 centimeters. Wide area corrections can be further corrected when there are additional local stations that are not part of the WADGNSS system.

FIG. 2 is a diagram of a system 50 showing a combination 30, 32 of the GNSS, DGNSS (differential GNSS) and RTK processing system(s) 42 and an inertial measurement unit (IMU) 44. The GNSS system includes a unit for processing the received information from satellites 2 of the GNSS satellite system (FIG. 1), information from the LEO satellite(s) 30 of the DGNSS system (the DGNSS corrections), information from the RTK base stations (the RTK differential corrections) and data from IMU 44. IMU 44 preferably contains one or more accelerometers and one or more gyroscopes, e.g., three accelerometers and three gyroscopes. Also, IMU 44 may be a MEMS-packaged IMU integrated with the GNSS, DGNSS and RTK processing systems 42 which serve as a correction unit.

GNSS is used as representative of any or all GNSS satellite systems including the United States GPS, Russian GLONASS, Chinese BeiDou or Compass and the European Galileo systems as well as other similar systems deployed or under development.

Map database 48 in system 50 works in conjunction with a navigation system 46 to provide information to the driver of the vehicle 18 (FIG. 1) such as position on a map display, route guidance, speed limit, road name etc. Thus, the display system and/or the guidance system in the vehicle 18 has its operation modified by the information provided, the invention thus constituting a system to alter operation of a vehicular component based on information provided thereto. It can also be used to warn the driver that motion of the vehicle 18 deviates from normal vehicular motion or operation. The warning system is another example of a vehicular component that has its operation changed or alerted in response to the provided information, so that the invention may also be considered a system to activate a vehicular warning system. This situation arises for example, when it is determined that the operator is operating the vehicle 18, or the vehicle is otherwise being driverlessly operated, such that it is about to cross an edge of a travel lane, run off the road, cross a center (yellow) line, go onto a shoulder of a travel lane or roadway, run a stop sign, or run a red stoplight (all of which would be considered deviations from normal motion or operation).

Map database 48 contains a map of roadways to an accuracy of a few centimeters (1 σ), i.e., data on edges of lanes of the roadway and he edges of the roadway, and position of all stop signs and stoplights and other traffic control devices such as other types of road signs as well as other landmarks which affect vehicular operation. Motion or operation of the vehicle 18 can be analyzed relative to the data in the map database 48, e.g., data about edges of the travel lanes, instructions or limitations provided or imposed by traffic control devices, etc., and a deviation from normal motion or operation of the vehicle 18 detected.

Map database 48 and other map databases disclosed herein are resident primarily, but not exclusively, on computer storage media that stores data on physical hardware. The hardware constituting the map database includes associated electronic componentry known to those skilled in the art to allow for addition of, access to, modification of and/or removal of data from the physical hardware to enable use of and changes to the map database.

Navigation system 46 is coupled to the GNSS and DGNSS processing system 42 via any known system coupling technique(s). For this system, the driver is warned if any of the above events is detected by a vehicle control or driver information system 45 coupled to the navigation system 46. Driver information system 45 can comprise one or more warning devices capable of generating or activating an alarm, a light, a buzzer or other audible noise generator, and/or a simulated rumble strip for yellow line and “running off road” situations and a combined light and alarm for stop sign and stoplight infractions. Driver information system 45 may also be a sound generator only or sound and vibration generator as in a simulated rumble strip.

In order for the driver information system 45 to operate as a warning system to provide an accurate warning to the driver or other vehicle occupant if the vehicle is a “driverless” vehicle, map database 48 must contain maps which are accurate to centimeters. Creation of map database 48 and its use for vehicle and/or landmark position are important parts of this invention.

In recent years, a local area differential correction system known as Real Time Kinematic, or RTK, differential system has become widely available and is a preferred system for creating accurate maps herein. In this system, local stations are established which, over time, determine their exact position within a centimeter or less. Using this information, local stations can aid in providing corrections to nearby moving vehicles, allowing them to determine their positions to within a few centimeters or less through a comparison of satellite carrier frequency phases as received at the RTK station and vehicle or through corrections received from the RTK base stations. RTK base stations determine their positions by averaging estimated positions over time and thereby averaging out errors in GNSS signals. By this method, they converge to an accurate determination of their position. When an RTK base station or vehicle determines its position, it is meant that hardware and/or software at the RTK base station and/or on the vehicle is configured to receive signals or data and derive its position therefrom.

### 2. Map Creation, Description of the Photogrammetry Based Mapping System

Maps created from satellite photographs are readily available. Such maps show the nature of the topography including roads and nearby road structures. Accuracy of such roads is often limited to many meters and thus satellite-created maps are often insufficiently accurate for vehicle route guidance purposes and other purposes described herein. Various mapping companies provide significant corrections to these maps through deployment of special mapping vehicles which, typically through use of lidar or laser-radar technology, created the maps in use for route guidance by vehicles worldwide. Such maps, however, are generally only accurate to a few meters.

Although sufficient for route guidance, this accuracy is not sufficient for autonomous vehicles guidance where decimeter centimeter level accuracy is required to prevent vehicles from crossing lane markers, running off the road, and/or impacting fixed objects such as poles, barrier dividers, trees or curbs. This is especially a problem in low visibility conditions where laser radar system can be of marginal value. Techniques described herein solve this problem and provide maps to centimeter level accuracy.

In current mapping systems, to maintain such maps, a fleet of mapping vehicles continuously operates such that all roads in a particular area are periodically remapped in order to record any changes missed by other monitoring systems. Maps are typically updated no more often than monthly and thus do not show changes which have occurred since the latest monthly update. Additionally, all roads are not visited during a month by mapping vehicles and thus most changes are not recorded in a timely manner.

In the invention, the mapping function is accomplished utilizing multiple probe vehicles, which are otherwise ordinary vehicles, each equipped with one or more cameras, an IMU and an accurate localization system. Such a system can be called map crowdsourcing. A receiver for obtaining WADGNSS is possibly available on the vehicle for use in areas where RTK DGNSS is not available.

As each probe vehicle traverses a roadway, each vehicular camera obtains images of space around the vehicle and transmits these images, or information derived therefrom, to a remote station off the vehicle, using a transmitter which may be part of a vehicle-mounted communication unit. This communication can occur in a variety of ways including a cellphone type communications system, the Internet using broadband such as WiMAX, LEO or GEO satellites, DSRC or even Wi-Fi where it is available or any other telematics communication system. Information can also be stored in memory on the vehicle for later transmission.

The remote station can create and maintain a map database derived from the information transmitted by the probe vehicles. When a section of roadway is first traversed by a probe vehicle, the remote station can request that a full set of processed images be sent/uploaded from the probe vehicle depending on available bandwidth. When sufficient bandwidth is unavailable, images can be stored on the vehicle, along with position information when each image was acquired, for later uploading. Additional processed images can be requested from other probe vehicles until the remote station determines that a sufficient image set has been obtained, i.e., a processor that is configured to process images at the remote station determines that a sufficient image set has been obtained. Thereafter, the probe vehicles can monitor the terrain and compare it to the on-vehicle map (from map database 48) and notify the remote site if discrepancies (or differences) are discovered. Additionally, ordinary vehicles which have one or more cameras but do not have the RTK system, can compare obtained images with on-vehicle maps and notify an off-vehicle site if changes have occurred.

When RTK data is available, a sufficient number of images with sufficient accuracy can be obtained from a single pass of the probe vehicle on a lane to allow an accurate map of the lane and its immediate surroundings to be created, as opposed to requiring many passes of probe vehicles as in conventional systems before a sufficient number of images are obtained to create an accurate map.

If a GNSS receiver is placed at a fixed location, with appropriate software, it can eventually accurately determine its position without the need for a survey. It accomplishes this by taking a multitude of GNSS data and making a multitude of position estimates, as the GNSS satellites move, and applying appropriate known algorithms. By averaging position estimates, which may require collecting over as much as a 24-hour time period, the estimated position gradually approaches the exact position. This is a method by which local RTK stations are created. This process can get more complicated when known and invariant errors are present, such as the presence of a reflecting surface that create multipath images. Software exists for removing these anomalies and, in some cases, they can be used to improve position accuracy estimates. Since there is usually some flexibility in the placement of RTK stations, they are preferably placed where such multipath problems are not present.

For the purposes of this disclosure, a probe vehicle can be basically a production vehicle to which has been installed either equipment for creating the initial map or for localization from an existing map and one or more cameras. In the first case, the vehicle will generally obtain its position using information derived from satellites and may include RTK based localization.

In a probe vehicle of the first type, the corrected or uncorrected GNSS signals are used to correct drift errors in the IMU and it is the IMU which is used by the vehicle to provide an estimate of its position at any time. If the GNSS signals are the only available information, then the vehicle location, as represented by the IMU, will contain significant errors on the order of many meters. If WADGNSS is available, these errors are reduced to on the order of a decimeter and if RTK DGNSS is available, these errors are reduced to a few centimeters or less. The GNSS satellite system is continuously improving and more frequencies are being made available. Each frequency is refracted a different amount as it passes through the atmosphere. By measuring these differences, an estimate can be made of total refraction and thus the path traveled by the signal can be corrected thereby improving measurement accuracy.

When a probe vehicle acquires an image, it records position and pointing angle of the camera as determined by the IMU. This position and pointing angle are used to determine a vector to a point on an object, a landmark, in the image such as a pole. After two images have been obtained, position of the pole can be determined mathematically as the intersection of two vectors to the same point on the pole. This location will be in error due to the accuracy of the IMU, that is the position of the vehicle, and the accuracies in the imaging apparatus.

Since imaging apparatus errors are invariant, such as imperfections in the lenses, they can be removed through calibration of the apparatus. Distortion due to lens aberrations can be mapped and corrected in software. Other errors, due to barrel distortions or shutter timing in a rolling shutter camera, can similarly be removed mathematically. Remaining errors are thus due to the IMU. These errors are magnified based on distance from the vehicle to the landmark.

In the same manner as the fixed GNSS RTK receiver gradually determines its exact position through averaging multiple estimates, position of the reference point on a pole can be determined by averaging position estimates. When the IMU position is determined only using GNSS readings, many position estimates are required since the IMU errors will be large. If WADGNSS is available, then many fewer position estimates are necessary and with RTK DGNSS, only a few position estimates are required. These few position estimates are obtained by a single pass of a vehicle, explained below. This process favors use of nearby landmarks, due to the error magnification effect, but even further away landmarks will be accurately located if sufficient position estimates are available.

As mentioned above, it takes two images to obtain one position estimate, provided the same landmark is in both images. Three images provide three position estimates by combining image 1 with image 2, image 1 with image 3 and image 2 with image 3. The number of position estimates grows rapidly with the number of images by the formula n*(n−1)/2. Thus, forty-five position estimates are obtained from ten images and 4950 position estimates are obtained from one hundred images.

Initially, multiple images can be obtained by a single probe vehicle but, as the system becomes widely adopted, images from multiple probe vehicles can be used, further randomizing any equipment systemic errors which have not been successfully removed. With a single probe vehicle traveling at up to 100 kph, images can be obtained as frequently as every 1-3 meters providing a sufficient number of images for a centimeter accurate landmark position calculation from a single vehicle pass for landmarks near to the lane boundaries.

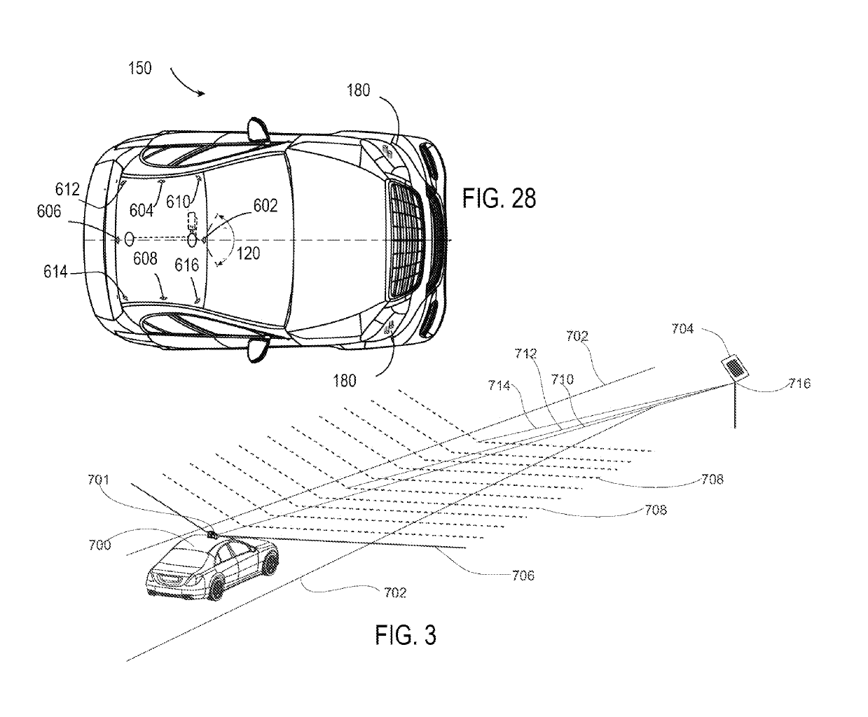

FIG. 3 illustrates an equipped vehicle 700 driving on a lane 702 and imaging a sign landmark from various positions during its travel using an imaging device 701. Lines 706 illustrate the field of view of the camera which in this case is 120°. Dashed lines 708 which are parallel to 706 illustrates the field of view of the camera as it travels down the lane 702 toward a landmark sign 704. Sign 704 has a defined point or anchor point 716. Dashed lines 708 are spaced at approximately 2 m in this image. Lines 710, 712 and 714 illustrate various vectors from the imaging device 701 to the anchor point 716 as the vehicle 700 travels down the road.

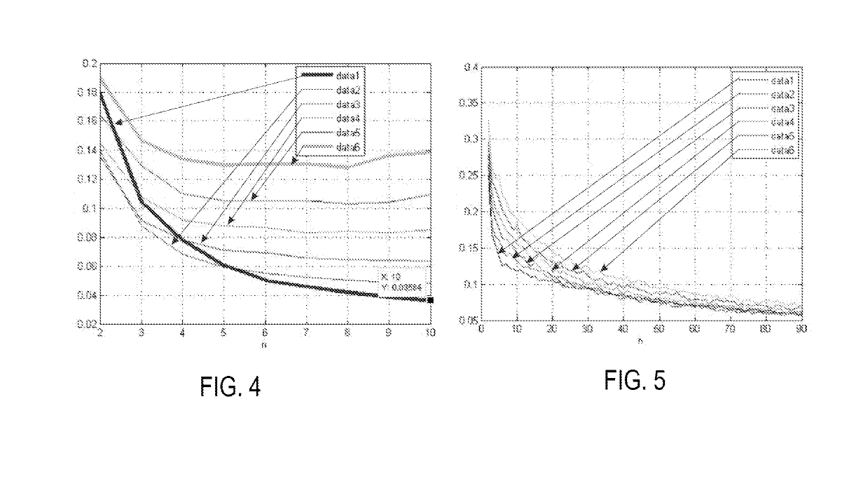

FIG. 4 is a plot of errors in locating an anchor point on a landmark as a function of the number of images acquired and spacing of the images. Data1 corresponds to a spacing of 1 m, Data2 of 2 m, Data3 of 3 m, Data4 of 4 m, Data5 of 5 m and Data6 of 6 m (all measurements herein are approximate measurements). These curves represent the accuracy in meters as seen on the vertical axis based on the number of images, horizontal axis, and spacing of the images. For example, when the spacing is 1 m (Data1) the accuracy is 18 cm for two images and less than 4 cm for 10 images. Data2 with a spacing of 2 m gives better results than the one meter spacing up to approximately five images. For this analysis, the camera had a field of view of 120° and a pixel density of 33 pixels per degree. The GPS coordinate error at one Sigma was 8 mm and the course error was 0.1°.

FIG. 5 is a plot of the errors for poles located at various distances off and to the side of the road and the number on images considered when the images are equally spaced over 100 meters. Data1 is for a landmark 5 m off the road, Data2 10 m, Data3 15 m, Data4 20 m, Data5 25 m and Data6 30 m. The poor results of this plot for a number of images less than 50 illustrates that images taken more than 50 m away from the vehicle do not contribute significantly to the accuracy of the calculation. At 50 images per hundred meters, the images are taken every 2 m and thus the results of this plot are comparable to those of FIG. 4. An interesting conclusion from this plot is that there is very little loss of accuracy for landmarks which are as much as 30 m off the road. The specification of the camera and GPS and course errors are the same as for FIG. 4.

The pole is one example of a landmark used in the creation of accurate maps. Other landmarks include any invariant (fixed in position) structure with a characteristic which can be easily located, such as the right edge of a pole at its top or midpoint or at a point where the pole intersects the ground, or any other agreed-upon reference point. Examples of other landmarks are:
Poles including signs, street lamps, fence poles, traffic lights, mile posts,
Road lane markings, parking lanes, bike and bus lanes,
Other painted road markings,
Intersections, pedestrian crossings,
Road edges, shoulder edges,
Building edges, windows,
Overhead bridges, tunnels,
Curbs, guard rails and barriers,
Advertising signs, billboards,
Railroad crossings, toll stations, toll gantries,
Other man-made structures (arches, statues, other points of interest),
Bridge edges,
Edges of gantries,
Fence and wall edges.

For each landmark, a representative point, an anchor point, can be chosen for position definition purposes. In most cases, landmarks will be limited to man-made objects, however, in some cases, natural objects such as rocks and trees can be used. In many of these landmarks, a particular point, such as midpoint of a pole, needs to be selected as a representative or position-representing or anchor point. Some landmarks, such as a curb, road edge or painted lane marker, do not have a distinctive beginning or end that appears in a single image. Even in such cases, the line does begin and end or is crossed by another line. The distance traveled from a starting or crossing point can be defined as the representative point or the point where the line deviates from a straight line by a defined amount. Alternately, a point on a line can be selected which is the intersection of a line perpendicular to the line and which passes through the anchor point of another landmark.

Some objects, such as trees and rocks or lakes or cliffs, do not lend themselves to be chosen as landmarks and yet their placement on a map for safety reasons is important, i.e., to be placed on the map so that vehicles can avoid impacting with them. For such objects, a more general position can be determined, but the object may not be used for map accuracy purposes or for localization. A discrimination algorithm to select which landmarks to use for map accuracy purposes and which to include in the map can be designed. The algorithm is installed in the map creation processor, and thus may not use cliffs as landmarks when determined to be present in images but could use fixed roadside poles when determined to be present in images and the position of cliffs can still be mapped.

Satellite-created maps are available which show character of terrain so that objects such as lakes, farm fields, forests and grass lands do not need to be recorded by the inventive mapping system. Since satellite-created maps are generally not sufficiently accurate for route guidance purposes, such maps can be made more accurate using the invention since position of landmarks observable on the satellite-created maps can be accurately established and the satellite-created maps appropriately adjusted so that all aspects of the terrain are accurately represented.

Initially in the mapping process, complete images are transmitted to the cloud. Alternately, areas such as lakes and fields can be eliminated prior to transmission when they are readily available from satellite maps. As the map is established, only information relative to landmarks needs to be transmitted, greatly reducing the required bandwidth. Furthermore, once the desired accuracy level has been obtained, only data relevant to map changes is transmitted, i.e., an automatic updating process. A computer program at the vehicle, e.g., executed by a processor on the vehicle 18, is configured to identify lakes and fields in images and eliminate them from the continued image processing. The computer program also identifies information relative to landmarks and other information in the images. The computer program further obtains current accuracy level, assesses whether it is the desired accuracy level and if so, determines map changes and thus restricts data transmission to only map changes.

Computer programs in the cloud, i.e., resident at a hosting facility (remote station) and executed by a processor and associated software and hardware thereat, adjust satellite images and incorporate the landmarks to create a map for various uses described herein. The probe vehicles can continuously acquire images and compare position of landmarks in those images with their position in the map database and when a discrepancy (difference) is discovered, new data is transmitted to the cloud for map updating. By this method, an accurate map database is created and continuously verified using probe vehicles and a remote station in the cloud that creates and updates the map database, and otherwise manages the map creation and updating process (e.g., via a computer program at the remote station). To facilitate this comparison, each landmark is tagged with a unique identifier, also performed by a computer program on the vehicle or at the remote station.

To summarize, position of the vehicle is determined by the IMU and accuracy of the IMU is initially controlled by the navigation system and the RTK system, if available. Later, accuracy of the IMU is correctable by position of sensed landmarks as described below.

### 3. Map Enhancements Using Satellite Imaging and Supplemental Information

When processing multiple images at the remote station, using, for example, stereographic photogrammetric techniques using dual images, images or image-derived data are converted to a map including objects from the images. This is achieved by identifying common objects in images, for example by neural networks or deep learning techniques, and using position and pointing information from when the images were obtained to place the objects on the map. Images may be obtained from the same probe vehicle, taken at different times and including the same, common object, or from multiple probe vehicles and including the same, common object. Preferably, for initial map creation, required images are taken from a single passage of the probe vehicle on a lane for creating a map of that lane and nearby landmarks referred to as the ONEPASS™ system). Since the required accuracy for one pass or single pass mapping is obtainable from the RTK or equivalent system, the same system can be used for rapid and accurate map updating whenever there is a change in the road geometry and/or that of nearby landmarks. When sufficient probe vehicles are equipped with the inventive system, with or without RTK, this provides a previously unavailable capability for continuous accurate map updating. After the initial map is created, highly accurate IMU position corrections are determined from observing unchanged landmarks without the need for an RTK system, thereby significantly reducing the cost of on-vehicle navigation hardware and software. Map updating and maintenance becomes an automatic and inexpensive process accomplished using production vehicles with a minimum of added equipment which has previously not been available.

By using the above method, an accurate map database is automatically constructed and continuously verified without requiring special mapping vehicles. Other map information can be incorporated into the map database at the remote station such as locations, names and descriptions of natural and man-made structures, landmarks, points of interest, commercial enterprises (e.g., gas stations, libraries, restaurants, etc.) along the roadway since their positions are recorded by probe vehicles.

Once a map database is constructed using more limited data from probe vehicles, additional data can be added using data from probe vehicles upgraded to obtain different, additional data than the initial probe vehicles, thereby providing a continuous enrichment and improvement of the map database. Additionally, the names of streets or roadways, towns, counties, or any other such position-based names and other information can be made part of the map. Even crowdsourcing from people local to a particular mapped region can add information to the maps over the Internet.

Changes in roadway position due to construction, landslides, earthquakes, accidents etc. is automatically determinable by probe vehicles. These changes are rapidly incorporated into the map database and transmitted to vehicles on the roadway as map updates for the navigation systems in the vehicles 18. The invention is thus a system that provides map updates to navigation systems on vehicle to cause the navigation systems to provide up-to-date map data on their displays and/or audibly via speakers. These updates are transmitted preferably using a ubiquitous Internet such as WiMAX, or equivalent, cellphone networks and especially 5G systems or any other appropriate telematics method. All vehicles in developed countries will eventually have permanent Internet access which will then permit efficient and continuous map updating.

Although WADGNSS differential corrections are applied at the remote station and need not be considered in the probe vehicles, thus removing the calculation and telematics load from the probe vehicle, this invention contemplates more accurate position determination than determinable by using WADGNSS. See, for example, U.S. Pat. No. 6,243,648 and similar techniques described in patents of the current applicant. The remote station, for example, may know DGNSS corrections for the approximate position of the vehicle at the time that images or GNSS readings were acquired. Over time, the remote station would know the exact positions of infrastructure-resident features such as the pole in a manner similar to fixed GNSS receiver discussed above. Since this removes the possibility of one pass mapping, RTK systems are preferred at least for initial map development, after which they are no longer needed.

In this implementation, which is preferably used after the initial map is created, the remote station knows mounting locations of the vehicle-mounted camera(s), the GNSS receivers and IMU on the vehicle and relative to one another and view angles of the vehicle-mounted camera(s) and its DGNSS corrected position which should be accurate within 10 cm or less, one sigma, for WADGNSS (i.e., the computer program or computer at the remote station). By monitoring movement of the vehicle and relative positions of objects in successive pictures from a given probe vehicle and from different probe vehicles, an accurate three-dimensional representation of the scene can be developed over time.

Once road edge and lane locations, and other roadway information, are transmitted to the vehicle, or otherwise included in the database (for example, upon initial installation of the system into a vehicle), very little additional bandwidth is required to include other information in a communication transmitted to and received by the vehicular communication system, such as the position of businesses that a traveler would be interested in, such as gas stations, restaurants etc., which could be done on a subscription basis or based on advertising.

Sensors which sense environmental or other information related to road conditions, such as icing, or related to the presence of animals or pedestrians adjacent to or on the road, can be coupled to communication devices that communicate to passing vehicles when such sensed information is of interest to the passing vehicle for safety or other reasons. A system on the vehicle can then selectively pass this information to the cloud-based map to provide information to vehicles which approach the area at a future time. Addition and removal of temporary information from the cloud map and its later transmission to vehicles is part of the map database management system (see U.S. Pat. No. 9,518,830).

As a probe vehicle travels, it images many objects potentially hazardous to other vehicles such as deer or other animals on or adjacent to the roadway, objects that have fallen off trucks, parts of disintegrated truck tires, black ice or heavy snow on the roadway, fog or smoke and accidents. Such objects or conditions when they occur suddenly can cause accidents and thus their identification and temporary placement on a map can lead to safer driving. The pattern recognition or other software resident on the probe vehicle should be trained or otherwise adjusted to recognize these conditions. As new conditions are recognized, probe vehicle software can be updated automatically from the cloud.

### 4. Description of the Map Creation Process

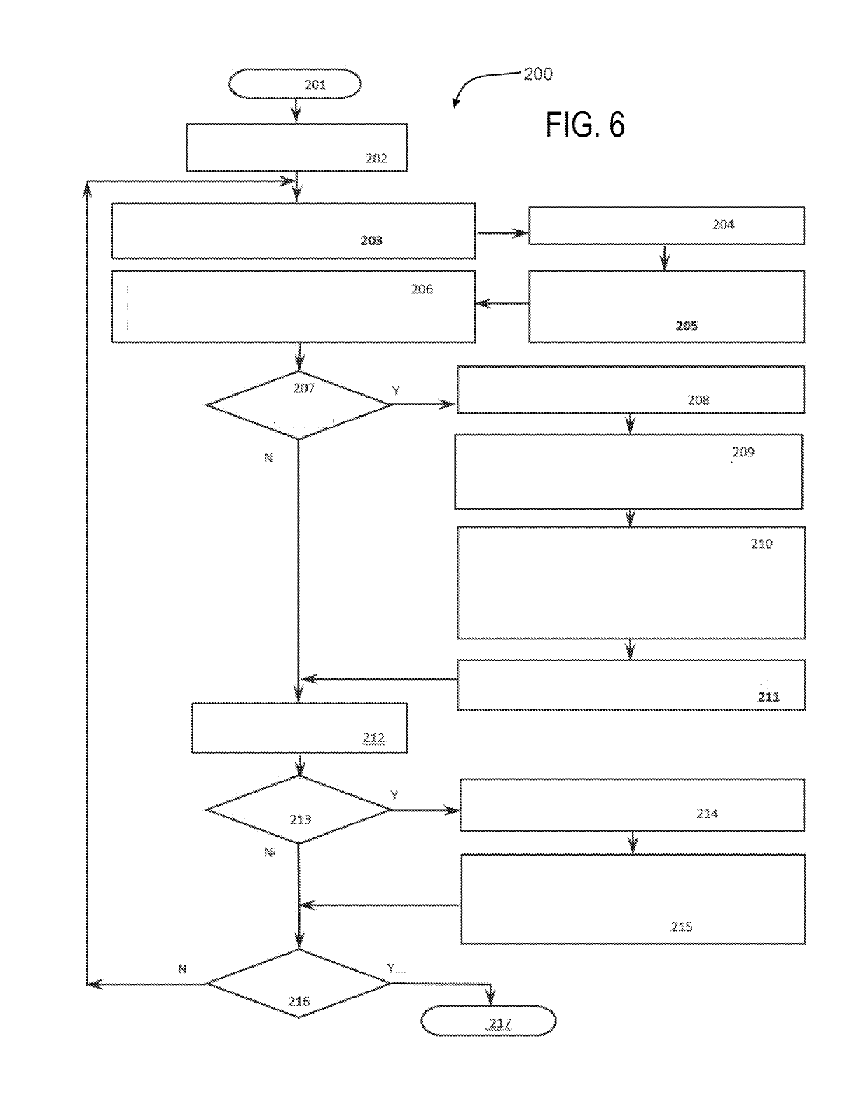

FIG. 6 is a photogrammetry flow chart illustrating exemplifying map creation of the invention generally at 200.

Step 201 is to begin.

Step 202 is setting of initial data (initializing) including the Kalman filter's parameters.

Step 203 is IMU-data reading (detecting) with a frequency of, e.g., 100 Hz: linear acceleration \vec{A}, angular speed \vec{ω}.

Step 204 is error compensation for the IMU.

Step 205 is calculation of the current longitude λ, latitude ϕ, altitude h, Roll, Pitch, Yaw, and linear speed \vec{V}_{GNSS}.

Step 206 is reading the GNSS-data with RTK correction (if available), detected with frequency 1, . . . , 10 Hz: longitude λ_{GNSS}, latitude ϕ_{GNSS}, altitude h_{GNSS,} linear speed \vec{V}_{GNSS}.

Step 207 is a query as to whether there is new reliable GNSS data.

If so, step 208 brings the GNSS and IMU measurements to common time (synchronization), followed by step 209, calculation of the observation vector: \vec{V}=[(λ−λ_{GNSS})Rₑ·cos(ϕ_{GNSS}); (ϕ−ϕ_{GNSS}); Rₑ; h−h_{GNSS}; \vec{V}−\vec{V}_{GNSS}] where Rₑ=6371116 m is the average Earth radius.

Step 210 involves recursive estimation with the Kalman filter: \hat{\vec{X}}=\vec{K}·\vec{Y}, \hat{\vec{X}}=[Δλ, Δϕ, Δh, \vec{ΔV}, \vec{ΔΨ}, \vec{ΔB}], \vec{ΔΨ}=[ΔRoll, ΔPitch, ΔYaw] is a vector of orientation angle errors, \vec{ΔB} is a vector of IMU errors, \vec{K} is a matrix of gain coefficients, and step 211 performs error compensation for longitude λ, latitude ϕ, altitude h, Roll, Pitch, Yaw, and linear speed \vec{V}.

Thereafter, or when there is no new reliable GNSS data from step 207, step 212 is taking an image (if available) with frequency 1, . . . , 30 Hz.

Step 213 is a query as to whether a new image is available.

If so, step 214 brings the IMU measurements to the time of the still image (synchronization), followed by step 215 transferring the following data to the server: the current image, coordinates (longitude λ, latitude ϕ, altitude h, Roll, Pitch, Yaw), linear speed \vec{V}, camera ID, etc.

Thereafter, or when there is no new image available, step 216 is a query as to whether to terminate operation.

If so, step 217 is the end. Otherwise, the process returns to step 203.

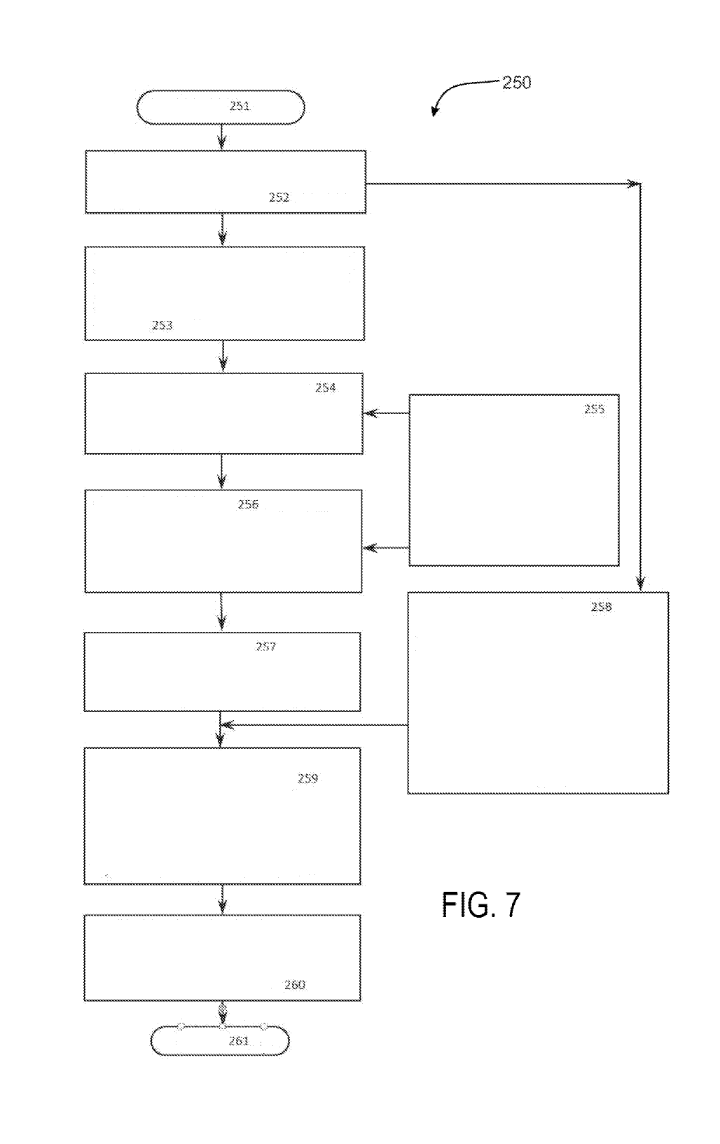

FIG. 7 is a flow chart illustrating an exemplifying algorithm for locating landmarks during a map creation process, illustrated generally at 250.

Step 251 is to begin.

In step 252, the input data are N still images and coordinates of the device (longitudeᵢ, latitudeᵢ, altitudeᵢ, pitchᵢ, rollᵢ, yawᵢ,), i=1, . . . , N.

Step 253 is landmarks recognition: determine actual pixel coordinates (x_{det ij}, y_{det ij}) of the landmarks at images, j=1, . . . Jₘₐₓ, where Jₘₐₓ is the number of recognized landmarks (Jₘₐₓ is different for each picture).

Step 254 is distortion correction: using the camera calibration data, evaluate undistorted pixel coordinates (x_{s ij}, y_{s ij}) from actual coordinates (x_{det ij}, Y_{det ij}) by Newton's iteration technique.

In step 255, camera calibration provides:
focal lengths:
f′_{pixels x} and f′_{pixels y};
principal point's position:
x_{cen} and y_{cen};
distortion coefficients:
α_{dist k}, k=1, . . . , kₘₐₓ.
(This procedure may be performed only once for each camera sample).

Step 256 is the local angles calculation:

$$tg {ω}_{x i , j} = \frac{{x}_{cen} - {x}_{s i , j}}{{f}_{pixels x}^{′}} , \\ tg {ω}_{y i , j} = \frac{{y}_{cen} - {y}_{s i , j}}{{f}_{pixels y}^{′}} , \\ {θ}_{i , j} = arc tg \sqrt{{tg}^{2} {ω}_{x i , j} + {tg}^{2} {ω}_{y i , j}} , \\ {γ}_{i , j} = arc {tg}_{2} \frac{tg {ω}_{y i , j}}{tg {ω}_{x i , j}} .$$

Step 257 is the local directions calculation:

$${\vec{F}}_{i , j} = ( \begin{matrix}{f}_{1 i , j} \\ {f}_{2 i , j} \\ {f}_{3 i , j}\end{matrix} ) = ( \begin{matrix}- cos {θ}_{i , j} \\ - sin {θ}_{i , j} cos {γ}_{i , j} \\ - sin {θ}_{i , j} sin {γ}_{i , j}\end{matrix} ) .$$

Step 258 is rotation matrices calculation (using data input in step 252):

$${\vec{R}}_{i} = {\vec{R}}_{roll , i} {\vec{R}}_{pitch , i} {\vec{R}}_{yaw , i} , \\ where$$

$${\vec{R}}_{yaw , i} = [ \begin{matrix}cos ( {yaw}_{i} ) & sin ( {yaw}_{i} ) & 0 \\ - sin ( {yaw}_{i} ) & cos ( {yaw}_{i} ) & 0 \\ 0 & 0 & 1\end{matrix} ] , \\ {\vec{R}}_{pitch , i} = [ \begin{matrix}cos ( {pitch}_{i} ) & 0 & - sin ( {pitch}_{i} ) \\ 0 & 1 & 0 \\ sin ( {pitch}_{i} ) & 0 & cos ( {pitch}_{i} )\end{matrix} ] , \\ {\vec{R}}_{roll , i} = [ \begin{matrix}1 & 0 & 0 \\ 0 & cos ( {roll}_{i} ) & sin ( {roll}_{i} ) \\ 0 & - sin ( {roll}_{i} ) & cos ( {roll}_{i} )\end{matrix} ] .$$

Step 259 is solving the set of (3i) linear equations with (3+i) unknowns:

{\vec{X}ₒ+r_{i,j}\vec{R}ᵢ\vec{F}_{i,j}=\vec{X}ⱼ}ᵢ, i≥2

by the least-squares method, where r_{i,j} is the radial distance from the device to the j-th landmark at the i-th image. Local Cartesian coordinates \vec{X}ⱼ are previously converted from GNSS data.

Step 260 provides results which are the landmark's local coordinates

$${\vec{X}}_{o} = ( \begin{matrix}{x}_{o} \\ {y}_{o} \\ {z}_{o}\end{matrix} )$$

and distances r_{i,j}. Finally, vector \vec{X}ₒ is converted to GNSS coordinates.

Step 261 is the end.

Using this process, a vehicle traveling at 100 kph can acquire more than 10 images of a particular landmark. All landmarks in an image are recognized using neural network or deep learning algorithms and when a landmark is recognized, an anchor point is identified for that landmark which will be used as the location point for that landmark. For a pole, for example, the anchor point can be the center point at which it is attached to the earth, the top or where a sign or other discontinuity occurs. The anchor point of a landmark is determined and then identified in each image, and then pairs of images are used to locate the anchor point by calculating vectors from the camera obtaining the image to the anchor point and determining their intersections. For each pair of images, one position estimation can be obtained. If 10 images are available and they are combined two at a time, 45 position estimates of the anchor point are obtained. If, for each image, the position and orientation of the camera is accurately known using RTK GNSS, for example, 45 position estimates yield an estimate of the position of the anchor point to within 10 centimeters (one sigma) of its actual position on the earth.

Use of RTK GNSS correction methods is currently preferred. However, there is continued technical progress being made in this important field and other methods of accurately determining the location and orientation of the camera(s) on a vehicle are expected to emerge. Academic research facilities are involved in developing enhanced technologies. One software program which, when working in conjunction with GNSS receivers that are only slightly better than those found standard in most smartphones, can provide positioning data down to the order of centimeters. The algorithm works against some of the more common signal interference problems and could eventually be designed to run on a smartphone's CPU and not require a dedicated remote server.

RTK is rapidly becoming ubiquitous. Where it is not yet installed, satellite-based DGNSS systems can be used resulting in some degradation in the position estimates of anchor points. This can result in requiring more passes of a lane to obtain 10 cm accuracy as the errors in the position and orientation of the camera are averaged out. Thus, whereas 10 cm accuracy can be achieved with one pass of a vehicle when RTK is available, either 2 or more passes will likely be required or slightly less accuracy achieved when RTK is not available. Since RTK stations are not particularly expensive, such stations can be installed on a temporary basis during the creation of the initial map. The issue of mapping in urban canyons and tunnels is discussed below.

### 5. System Implementation

Generally, the map will be created at one or more central locations, usually referred to as the cloud, which receives information from probe vehicles. Information sent from probe vehicles to the cloud (embodied as a processor or processing system) depends on the onboard hardware and software capabilities. Initially, entire images acquired by probe vehicles are transferred to the cloud in compressed form. Later, uninteresting features such as the sky, grass land, water and other features which are unlikely to contain landmarks, can be filtered from the images prior to transferring to the cloud. Still later, once landmark recognition software is in place on the probe vehicles, only landmark information is transferred to the cloud via the vehicular communications system. Finally, when the initial map has been created by the map management system, probe vehicles need only transfer landmark information when such landmarks are missing or inaccurately represented on the map.

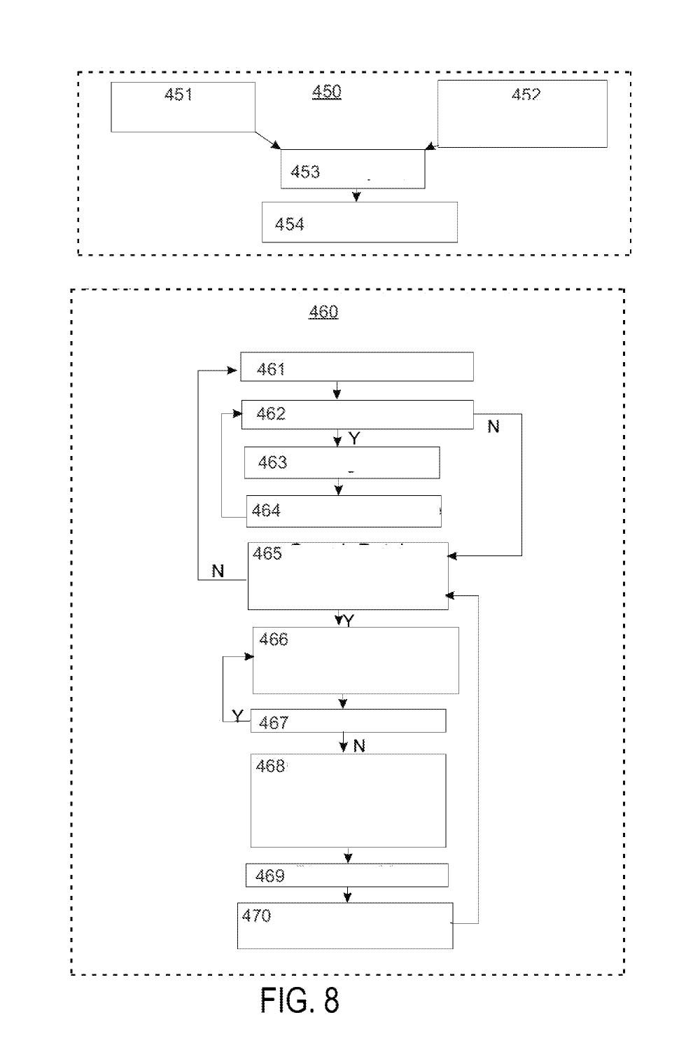

FIG. 8 is a flow chart with calculations performed in the “cloud” for a map creation method in accordance with the invention.

On the vehicle 450, the following steps occur:
Step 451, acquire image by an image acquisition device;
Step 452, acquire IMU angles and positions from the IMU;
Step 453, compress the acquired data for transmission to the cloud via a processor; and
Step 454, send the compressed data to the cloud via a communications system.

In the cloud 460, the following steps occur:
Step 461, receive an image with associated IMU data from a mapping vehicle via an information receiver;
Step 462, identify a landmark using a pattern recognition algorithm such as neural networks or deep learning executed by a processor or processing system,
Step 463, assign an ID when a landmark is identified by a processor;
Step 464, store the landmark and assigned ID in a database; and when there are no identified landmarks, Step 465, search the database for multiple entries with the same ID via a search program executed by a processor. If there are none, the process reverts to step 461. If there are multiple ID entries in the database as determined in step 465, step 466 is to combine a pair to form a position estimate by calculating the intersection of vectors passing through a landmark reference or anchor point, using a processor. The assigned ID is created by the processor so that it is unique to a landmark type and location. No two landmarks should have the same ID.
Step 467 is a query as to whether there are more pairs, and if so, the process returns to step 466. If not, the process proceeds to step 468, combining position estimates to find most probable position of the landmark via a processor, step 469, placing the landmark position on a map via a processor, and step 470, making updated map data available to vehicles via a telecommunication distribution system. From step 470, the process returns to step 465.

System processing as depicted in FIG. 8 will generally be in use during early stages of map creation. Since many landmarks have not been selected, it may be desirable to retain all images acquired to allow retroactive searching for new landmarks which have been added. Later, when the map is secure and few new landmarks are being added, retention of the entire compressed images will no longer be necessary and much of the data processing can take place on the vehicle 450 (not in the cloud 460) and only limited data transferred to the cloud 460 by the vehicular communications system. At this stage, the bandwidth required will be dramatically reduced as only landmark information is transmitted from the vehicle 450 to the cloud 460. Even in the early stages, entire images need not be retained, only those portions which contain landmarks

As the system matures, new landmarks can be identified and software changes sent to probe vehicles to recognize these new landmarks. When one is found, either image information including vehicle camera location and pointing information can be sent to the cloud and the landmark position determined there or, preferably, the vehicle will determine the position of the landmark, assign an ID and send the result to the cloud for inclusion in the map.

Cloud 460 represents a location remote from the vehicle 450, most generally, an off-vehicle location which communicates wirelessly with the vehicle 450. The cloud 460 is not limited to entities commonly considered to constitute the “cloud” and may be any location separate and apart from the vehicle at which a processing unit is resident.

To handle the amount of information sent to the cloud 460 during the initial map creation, images and position information may be retained on probe vehicle 450 while it is acquiring such images and sent to the cloud 460 when the vehicle 450 has returned to its storage location and then through a high speed wired or WI-FI connection.

Once the hardware and software has been upgraded on the probe vehicles 450 so that most landmarks can be recognized on the vehicle 450, the entire image no longer needs to be retained in the cloud 460. Then, the landmarks can be recognized on the vehicle 450, an ID assigned by a processor on the vehicle 450, and a much smaller amount of information needs to be uploaded by the communications system on the vehicle 450 to the cloud 460. Additional landmarks can be added later but once the vehicle system is trained to recognize a new landmark, it will note that the landmark is missing on the cloud-based map and it can then upload the information. At this stage, retaining the database of entire images is not required.

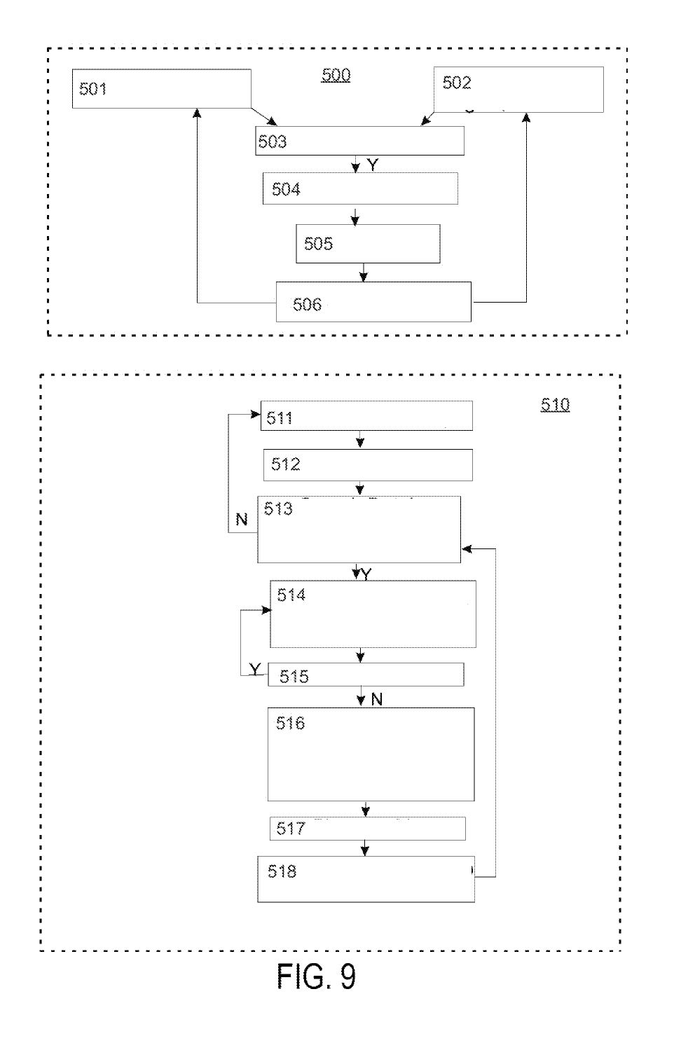

FIG. 9 is a flowchart with calculations performed on a vehicle for the second stage of the system implementation.

On the vehicle 500, the following steps occur:
Step 501, acquire image by an image acquisition device;
Step 502, acquire IMU Angles and Positions from which the image was acquired from the IMU;
Step 503, identify a landmark using a pattern recognition algorithm such as neural networks or deep learning executed by a processor, or processing system;
Step 504, assign an ID to the identified landmark using the processor;
Step 505, compress the acquired landmark data, ID and location, for transmission to the cloud using the processor; and
Step 506, send the compressed acquired data to the cloud using a communication system.

In the cloud 510, the following steps occur:
Step 511, receive an image using an information receiver;
Step 512, store the received image in a database using a processor;
Step 513, search the database for multiple identical ID entries using the processor, and when one is found,
Step 514, combine a pair to form a position estimate using a processor. If no multiple identical ID entries are found, additional images are received in step 511.
A query is made in step 515 as to whether there are more pairs of multiple identical ID entries using the processor and if so, each is processed in step 514, If not, in step 516, position estimates to find most probable position (of the vehicle 500) are combined using the processor and in step, 517, the vehicle position is placed on a map using the processor. In step 518, the updated map is made available to vehicles using a telecommunication distribution system.

When using the OnePass™ protocol, all the calculations needed to determine the location of a landmark can take place on the vehicle thereby significantly reducing the information sent to the cloud. That is, only the landmark ID and its location needs to be sent.

Once the map has been created and stored in a map database on the vehicle 500, the only transmissions to the cloud 510 relate to changes or accuracy improvements to the map. This greatly reduces bandwidth requirements at a time that the number of vehicles using the system is increasing.

### 6. Map Database Management Techniques

As described above regarding FIGS. 8 and 9, there are two stages to the map creation and maintenance process. Stage 1 (FIG. 8) where the initial map is created and stage 2 (FIG. 9) where a previously created map is updated. During stage 1, a dedicated fleet of vehicles are used which have RTK differential correction hardware and software. Such vehicles obtain centimeter level position accuracy used to determine position and pointing direction of the vehicle-mounted camera to very high accuracy. This permits determination of the position of a landmark located near or on the road to within 10 centimeters from 10 or fewer images which can be acquired while the vehicle is traveling at 100 kph or less, for example. During stage 2, production vehicles can obtain their positions with similar accuracies without the need for the RTK system through triangulation techniques from mapped landmarks. When a vehicle discovers a new or changed landmark, it can upload the new information to its own database and then to the cloud wirelessly.

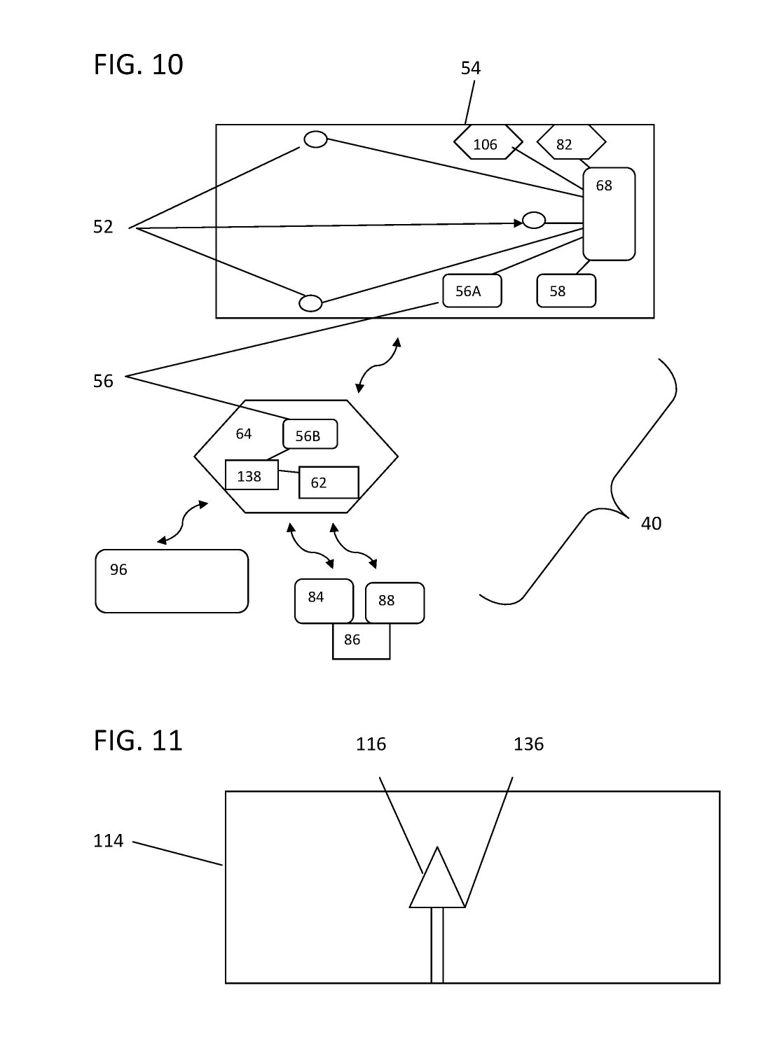

More specifically, FIG. 10 shows a schematic of a system 40 that can function as a map database management system on vehicles 54 (only one of which is shown) that includes camera assemblies or imaging systems 52 that obtain images of an environment exterior of the vehicle 54 during its movement on a road. Only a single imaging system 52 can be provided. In some embodiments though, the system 40 operates with a feed of previously obtained images and thus an imaging system 52 is not required, only a database of images. System 40 also includes a database 56, at least partly on the vehicle 54, that initially does not contain information about all possible landmarks and positional information. The database 56 (embodied in one or more memory components 56A, 56B) may be resident partly on the vehicle (database 56A) and partly at a server 64 at a remote site separate and apart from the vehicle 54 (database 56B) with the parts 56A, 56B of the database 56 communicating with each other using a communications system 58 on the vehicle 54 and another communications system 62 at the remote site 64.

A processor 68 is coupled to any imaging system 52 (or image database) and analyzes images of the environment exterior of the vehicle 54 to determine the presence of one or more of a plurality of known landmarks of different types in the images. Important to some embodiments of the invention, each landmark has a unique identification and an anchor point specific to the type of the landmark. As shown in FIG. 11, an image 114 includes a triangular yield sign 116, and the anchor point 136 determined for yield sign is the lower right corner. The system installer determines the anchor point for each different type of landmark.

The processor 68 is also connected to the communications system 58, and its connections may be any known connections, e.g., wired or wireless. The processor 68 represents any type of unit that is capable of performing the functions described below as being performed by the processor. Processor 68 may be considered a processing unit, computer, and the like. Moreover, the processor 68 may be embodied in multiple parts that are separate from one another, e.g., one part 68 being on the vehicle 54 and another part, processor 138, at the server 64 at the remote site separate and apart from the vehicle 54.

For each landmark determined to be present in an image, the processor 68 determines a position for the landmark based on vehicle position when the image including the landmark is obtained and a vector between the vehicle and the anchor point on the landmark. The initial position of the landmark may be determined using only one image taken while the vehicle is in one position. This vector is a line with direction between the geographic position of the vehicle and the anchor point, and may be easily determined by the processor 68 in any known mathematical processing technique. A satellite-based position determining system (GPS) 82 may be used to determine vehicle position. The processor 68 also determines whether the database 56 includes presence of the landmark at approximately the landmark position. By approximately, it is meant within, for example, a few centimeters. The “approximate” nature of the position also depends on the size of the landmark so for a large landmark, the position could be within a range of a few meters from the position in the database.

When the processor 68 determines that the database 56 does not include presence of the landmark, the processor 68 considers that landmark to be a new landmark, assigns a unique identification to the new landmark and selects, based on the image including the landmark, a type of the new landmark from among the different types of landmarks. This functionality is achieved by a computer program resident in computer-readable media on the vehicle 54 and executed by the processor 68 with interaction with the database 56. Through image analysis, the landmark type can be determined, e.g., a stop sign is one type of landmark and image analysis enables recognition of an octagonal sign structure which is identified as a stop sign. The processor 68 updates the database 56 to include the assigned identification, the selected type and position information about the new landmark. In one embodiment, the processor 68 assigns the unique identification to the new landmark by deriving the unique identification based on the selected type of type and anchor point specific to the selected type of landmark.

Position information about the new landmark is derived from analysis of multiple images taken when the vehicle is in different positions, which is necessary to obtain multiple vectors from the vehicle to the same anchor point on the landmark. One vector from the vehicle to the anchor point is derived or determined from each image taken at a different position and the intersection of the vectors is considered to be the accurate landmark position. Use of multiple images containing the same landmark in accurate landmark positioning determination is described herein.

The communications system 58 is coupled to the processor 68 and facilitates transmission of updates to the database 56B to the remote site server 64 separate and apart from the vehicle 54 or to communications system on other vehicles. This constitutes distribution of the database update.

Each landmark is assigned an ID or tag which uniquely identifies that landmark, i.e., by the processor 68. This ID can be created by the processor 68 by combining the landmark anchor point location information and type. A stop sign, for example, can have one type designation and a painted line, signifying the boundary of a lane, another type designation. For each landmark identified, the location of an anchor point can be determined and identified, which can also be part of the ID for that landmark. For the stop sign, for example, the anchor point can be the top, center or bottom of the sign or where the sign pole on which the stop sign is mounted enters the ground. For a lane marking line, many options are available such as every 10 meters from the start of the line segment or, better, a point on a line that is perpendicular to the lane line and passes through the anchor point of another adjacent landmark such as a pole. A set of rules can be established for each landmark type which unambiguously identifies the location of the anchor point. A vehicle thus can identify a landmark in an image and, using established rules, know where the anchor point is based on the ID of the landmark as represented on the map (see FIG. 11). The vehicle can then correct its IMU by comparing its determination of the landmark anchor point position with that listed on the map. Once this IMU correction is made, the vehicle can check whether all landmarks found in the images acquired are consistent with those that have been mapped. If a discrepancy is discovered, the vehicle can report that discrepancy to the map database management system in the cloud for possible map correction.

Accordingly, there may be a plurality of different types of landmarks, e.g., triangular signs, oval signs, circular signs, square signs, diamond-shaped signs, rectangular sizes of one size, rectangular sizes of another size, octagonal signs, traffic light poles, guardrails, mile markers, overpasses, route markers, historic markers, differently shaped state highway signs, and the like. Each differently sized and/or shaped sign or landmark may be assigned a unique anchor point, and its ID derived therefrom or based thereon. The anchor point may be selected based on the shape of the sign. It is ideal to select the anchor point of a specific type of landmark so that it is present in all images of the landmark. Without the identified presence of an anchor point in an image of the landmark, some embodiments of the method are not practicable.

When a new landmark is identified, i.e., one that is not in the database 56, the shape and/or size of the landmark is determined, e.g., using pattern recognition analysis techniques on the landmark in the image, and the type of the landmark is then selected from among the plurality of different types. For example, a new landmark determined to be octagonal and having the size of a known stop sign is considered to be a stop sign. The identification of this landmark is then generated based on its identification as a stop sign. The anchor point is therefore a function of or based on the type of landmark, and different types of landmarks will have different anchor points. If an anchor point for a stop sign is the bottom left corner of the stop sign, the anchor point for a rectangular speed limit sign may the upper left corner.

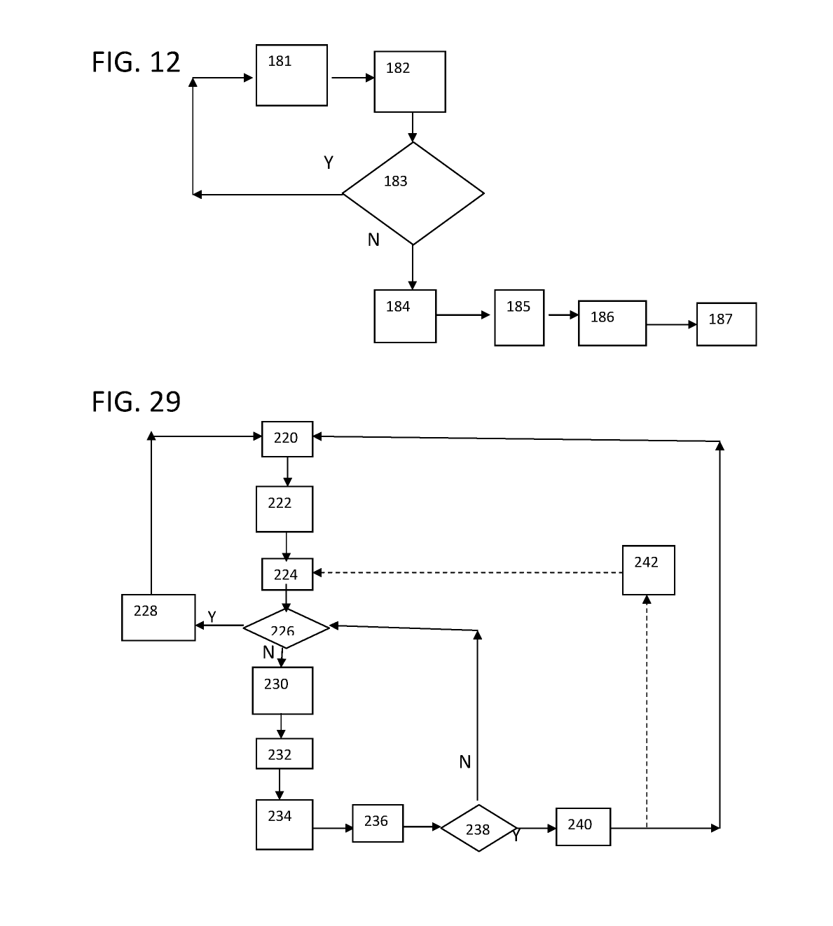

An exemplifying method for managing a map database using the vehicle 54 is shown in FIG. 12 and includes the basic steps of image analysis 181, i.e., analyzing images of an environment exterior of a vehicle obtained during movement of the vehicle to determine the presence of one or more of a plurality of known landmarks of different types in the images. Each landmark has a unique identification and an anchor point specific to the type of the landmark. After image analysis 181 (of even a single image), approximate position determination 182 occurs, i.e., a determination is made of a position approximate for the landmark based on vehicle position when the image including the landmark is obtained and a vector between the vehicle and the anchor point on the landmark for the purposes of determining, in step 183, whether a database of landmark and positional information includes presence of the landmark.

When it is determined in step 183 that the database does not include presence of the landmark, new landmark processing 184 occurs. This entails considering this landmark to be a new landmark, assigning, using the processor 68, a unique identification to the new landmark, and selecting, using the processor 68 and based on the image including the landmark, a type of the new landmark from among the different types of landmarks. In step 185, database 56 updating occurs, i.e., the database 56 is updated to include the assigned identification, the selected type and position information about the new landmark. Position information about the new landmark is explained above and requires use of multiple images taken when the vehicle is in different positions and each of which includes the same landmark. This results in obtaining multiple vectors from the vehicle to the same anchor point on the landmark, a respective vector from the vehicle to the anchor point is derived or determined from each image taken at a different position. The vector intersection is considered to be the accurate landmark position.

In step 186, distribution of the update of the database 56 occurs to enabling access to the database 56 using a communications system on at least one other vehicle to enable a vehicular navigation system on that vehicle to provide navigation, guidance and/or display functionality based on contents of the updated database 56.

Optional features of the method include a provision for the occasions when it is determined in step 183 that the database includes presence of the landmark at approximately the first position value. In this case, the landmark can be used to derive the vehicle position by correcting the determined position estimate of the vehicle using derived positional correction information, in step 187. As such, the vehicle position is obtained by determining, using the satellite-based (GPS) position determining system 82, a position estimate of the vehicle when the image including the landmark is obtained, accessing the database 56 of landmarks and positional information to retrieve a second position value for the landmark from the database 56, and analyzing, using the processor 68, the first and second position values for the landmark and deriving positional correction information based on differences between the first and second position values.

Deriving the vehicle position by correcting the determined position estimate of the vehicle using the derived positional correction information may entail correcting data from an inertial measurement unit (IMU) 106 on the vehicle that is used for vehicle position determining purposes (see also FIG. 2).

Correcting data from the IMU 106 may be achieved by establishing a set of rules for each of the different types of landmarks that identify location of the anchor point of that type of landmark, identifying, using the processor 68, one of the landmarks in an obtained image and determining the type of the landmark, determining, using the processor 68, a first estimation of the location of the anchor point by applying the established rules and the determined type of landmark to the landmark, and determining, using the processor 68, a second estimation of the location of the anchor point by determining an identification of the landmark in the database 56 and then retrieving positional information for the landmark from the database 56. Further, the first and second estimations are compared, the IMU 106 corrected based on the comparison, and data from the IMU 106 as corrected is used to generate positional information about the vehicle 54.

In one embodiment, it is possible to maintain the database 56 at least partly at the server 64 separate and apart from the vehicle. In this case, a map update is generated using the processor 138 at the server 64 separate and apart from the vehicle based on the communication transmitted from the vehicle 54 using communications systems 58, 62. The map update can then be distributed to other vehicles for inclusion in their vehicle-resident map database. For example, it is possible to direct a transmission from communications system 62 receivable by the communications system 58 on another vehicle that causes display of map data on a display of the vehicular navigation system based on the position of that vehicle. It is also possible to direct a transmission that causes automatic guidance of that vehicle using a throttle, braking or steering system and/or direct a transmission that causes change in operation of a throttle, braking or steering system on that to cause it to alter its movement.

When at least part of the database 56 is at a remote location server 64 (part 56B), the determination in step 183 may entail establishing communications between the processor 68 and the part of the database 56 at the remote location (part 56B) using communications systems 58, 62. Updating the database 56 in step 185 entails directing a transmission from the communications system 58 to the part of the database 56 at the remote location (56B) including the assigned identification, the selected type and position information about the new landmark.

Through the above-described system, the fleet of vehicles which create the initial map will contain the more expensive RTK differential GNSS hardware, software and licensed connections to the RTK information provider (phase 1) whereas the production vehicles will not need this equipment since they will obtain their accurate position information from the positions of the mapped landmarks.

### 7. Vehicular Crash Notification System

Displacement and angular coordinates of a vehicle equipped with the apparatus of this invention is accurately known as is its position on the roadway. If the vehicle runs off the road or impacts a barrier or other known road furniture, this will be known as soon as it occurs based on accurate map and vehicle data, and a message is sent to the cloud indicating that an accident may have occurred. Furthermore, the IMU can detect that the vehicle has abruptly decelerated or rolled over and thus an accident is likely. If there is no further communication to the cloud, it can be assumed that the vehicle has in fact become involved in a serious accident. Further communication, if it occurs, can be used to verify the position of the vehicle and whether it has continued traveling down the roadway. Thus, the first communication can serve as an alert which can be cancelled or confirmed through a subsequent communication or lack thereof.

The IMU on the vehicle provides valuable information to the roadway management system. By analyzing the IMU record, clues can be obtained as to the cause of an accident. If the vehicle skidded prior to the accident, then perhaps the road was icy. If there was an impact prior to the accident, this may be indicative of a rock or other debris on the roadway which ought to be removed. An impact with a deer or other animal may also be diagnosed and the police can be notified.

Traffic accidents are one of the leading causes of fatalities. An important indicator of survival rates after an accident is the time between the accident and when first responders are dispatched to the scene. Reducing this time can significantly reduce mortality rates. The invention minimizes time between an accident and notifying first responders thereby saving lives.

### 8. Road Repair Required Determination Techniques Using Probe Vehicle

The IMU is used to detect anomalies and problems in the surface of the roadway. A pothole or unusual vibration, for example, is easily detected by the vertical accelerometer in the IMU. As a result, dimensions and position of a pothole or other anomaly can be characterized, recorded and sent to the cloud for forwarding to a road maintenance authority for that road. Once a pothole starts developing, it can be repaired at relatively low cost whereas if time passes without attention, it can become a hazard to vehicle travel. Many vehicles are seriously damaged and serious accidents are caused by potholes and other road related problems. Using the invention, the cost and injuries caused by potholes can be substantially reduced.

The IMU also measures the yaw angular velocity of the vehicle and this measurement provides an indication that the vehicle is sliding. This information can be augmented by other information from vehicle sensors including anti-lock sensors. Such sliding can be indicative of the presence of a slippery roadway caused, for example, by ice. Other sensors on the vehicle, if present, can be used to confirm, but the suspected presence of ice or a slippery roadway caused by hydroplaning can be reported to the cloud and vehicles in the vicinity can be notified of the suspected condition.

### 9. Congestion Mitigation

Congestion on roadways robs users of their time. Many users would gladly pay more for use of the road to avoid this loss of time. This is often achieved through use of special lanes where users pay an additional toll to use the special lanes which have less congestion. The amount of the toll varies depending on time of day and/or congestion on the road. The toll can be high, for example, during rush hour and low in the middle of the night. The driver decide whether to use the higher priced lanes at the beginning of a stretch of roadway and once that decision is made, he cannot leave that higher tolled lane until the end of a segment which sometimes carries him beyond the exit that he desires. These higher tolled lanes, sometime called HOT lanes, require a substantial addition to the infrastructure by partitioning off certain lanes in themselves slow down traffic and thus create congestion. Furthermore, HOT lanes are frequently narrow and can themselves be a cause of an accident.

Using the invention, the vehicle accurately knows what lane it is using and thus the information is present to charge tolls based on lane usage and the amount of such usage. Some drivers will always use the HOT lanes even when the traffic is light since they value their time more than others who will stay in the slow lanes even when the traffic is heavy. For other drivers, they may want to move in and out of the HOT lanes depending on the local congestion level. The amount charged for the use of a HOT lane can vary depending on its use so that the traffic always moves uncongested in the HOT lanes. If a HOT lane becomes congested, then the toll can be eliminated as the system has failed. The higher tolls collected can be applied to increase capacity of the road such that when equilibrium is achieved, the HOT lanes will always provide congestion free travel (see U.S. Pat. No. 9,053,633, 9,691,188 and 9,595,139). Private companies can bid on solving a particular congestion problem and can charge tolls for doing so.

This concept allows tolling by lanes, which is facilitated by communication to the cloud for toll collection and by raising money for new roads, or lanes or tunnels, eliminates the congestion problem. As pointed out by Elon Musk, many layers of tunnels can be created, thus there is no limit on the traffic that can be accommodated. Higher tolls will cause drivers to adjust their driving patterns to travel at different times or on different routes depending of their particular time value.

By turning this process over to private industry, better roads will be built since construction to repair roads reduces tolling revenues. Today, some highways need to be repaired a year or two after they have been built whereas others can last up to twenty or more years without repair.

Using this invention, all vehicles will be connected to the cloud for maintaining updated maps on each vehicle and in the cloud. The state of congestion can be part of the information which is temporarily added to the cloud database. Since this connection will already exist, to use it for tolling purposes does not require additional infrastructure. Users can be continuously informed on the cost to their destination depending on the lane that they are occupying and may be advised of alternate routes that take them off the congested roadways but require a longer trip time.

### 10. Map Software Business Methods

The map database and its operation can be implemented through a general operating system. Several operating systems exist and each can be free much like windows 10 and iOS. Funds to support development, implementation and operation of a map database may come from a tolling system. Different automobile manufacturers may team up with map operating system suppliers and adopt the map system supplied by that supplier. A vehicle operator, under one system, can be charged a per mile charge for operating on roadways. The amount of this charge can depend on the road, the lane on that road being traveled and the time of day. The charge can cover construction and maintenance of the road. Additionally, this charge can cover the maintenance of the operating system including the map database. Since gas tax-based revenue systems are rapidly becoming obsolete due to electric and hybrid vehicles, a new general tolling system is becoming a necessity.

A portion of the per mile charge can also be allocated to pay the cost of enforcement, emergency and first responders, and fire department activities related to the road. Other routine maintenance activities including snowplowing, debris removal can also be covered by this per mile charge. Basically, all fees and expenses to build and maintain the roadways are paid for through a per mile charge to the road user. The per mile charge will be collected by the operating system company and distributed according to an agreed formula to cover the above costs.

Either the government or, on its own initiative, a private company can submit a proposal to upgrade a particular roadway. Part of that proposal will be a proposed additional per mile charge which can be based on the lane used and time of day. This charge will then be part of the per mile formula which is distributed to the private company that performed the road upgrade. In this manner, roads will be continuously improved without any cost to the government or to taxpayers other than through a toll for use of the upgraded facility.

Development of map software and its maintenance is the responsibility of the operating system company. This work can be contracted out to software development companies on a competitive basis. Intellectual property rights should be respected during this process.

When a new road needs to be built and land is required, the government will acquire the land at a fair market price and will be reimbursed for that land out of the per mile fees which can also include reimbursement for any lost taxes which the government would otherwise have collected had the land not been allocated for road construction. By the above process, all roads are built and maintained and paid for by the users of those roads through a per mile charge. Additional fees can also be collected from advertising. Companies can pay a fee to have their positions identified on the map database, for example.

### 11. Description of Probe Mapping Vehicle Systems

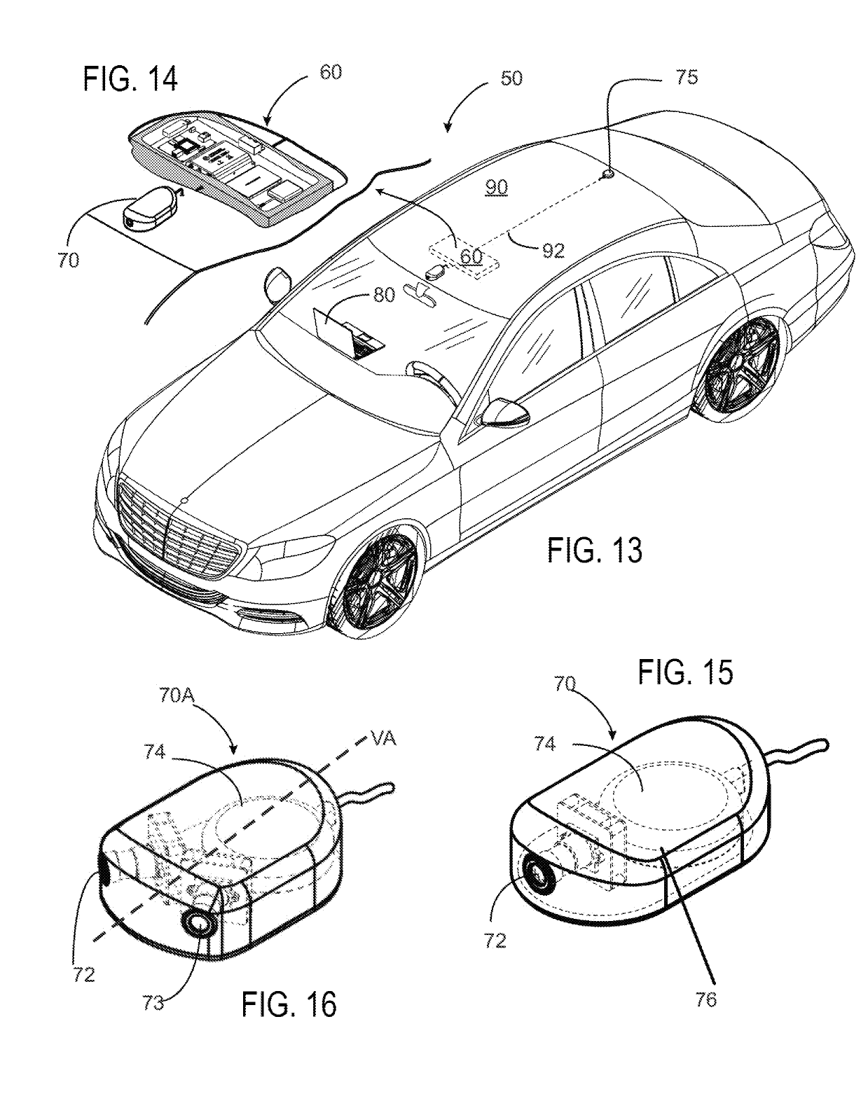

Considering FIGS. 13-16, of which FIG. 13 illustrates a vehicle with a camera unit (imaging system) 70 and two GNSS antennas, one antenna 74 being situated within the camera unit 70 and the other antenna 75 mounted at the rear of a vehicle roof 90. An electronics assembly or package 60, which can be attached to the underside of the roof 90 within the headliner (not shown), houses the operating system and various other components described below (FIG. 14). A coupling 92, e.g., a wire, connects the electronics package 60 to the antenna 75 at the rear of the roof 90. The camera unit 70 is forward of the electronics package 60 (FIG. 14).

FIG. 15 shows a detail of the camera unit 70 including a camera assembly 72 and antenna 74 rearward of the camera assembly 72 in the same housing 76. FIG. 13 illustrates an alternate configuration where two camera assemblies 72, 73 are used. The illustrated camera assemblies may be commercially available See3CAM_CU130-13MP from e-con Systems. Each camera assembly 72, 73 is preferably equipped with a lens having a horizontal field of view of about 60° and somewhat less in the vertical direction. A GoPro® camera can be substituted for the See3CAM. An alternate camera with a 120° FOV is discussed below. As used herein, an imaging system or a camera assembly is often interchangeable with a camera, and is often generally referred to as an imaging device.

In FIG. 16, a housing 70A includes the two camera assemblies 72, 73 pointed or oriented with their imaging direction in directions of, for example, plus and minus 30°, respectively, relative to a vehicle axis VA extending halfway between the openings of the camera assemblies 72, 73. Thus, with each camera assembly 72, 73 having a 60° horizontal field of view (FOV), the camera unit 70 has a combined field of view of about 120°. The chosen lens has a uniform pixel distribution. With 3840 pixels in the horizontal direction, this means that there will be approximately 64 pixels per degree. One pixel covers an area of about 0.81 cm by about 0.81 cm at a distance of about 30 meters. Most landmarks will be within 30 meters of the road edge and many within 10 to 15 meters. An alternative arrangement uses a single camera having a 120° field of view and for the same 3840 pixels in the horizontal direction will result in each pixel covering twice the area at 30 meters. Pixel density of cameras increases each year, so it is expected that a single 120° field of view camera is a preferred implementation.

Two antennas 74, 75 are used to provide information to a processor in electronics package 60 in order to give an accurate measurement of the vehicle heading direction or yaw. This can also be determined from the IMU when the vehicle is moving. If the vehicle is at rest for an extended time, the IMU can give a poor heading measurement due to drift errors.

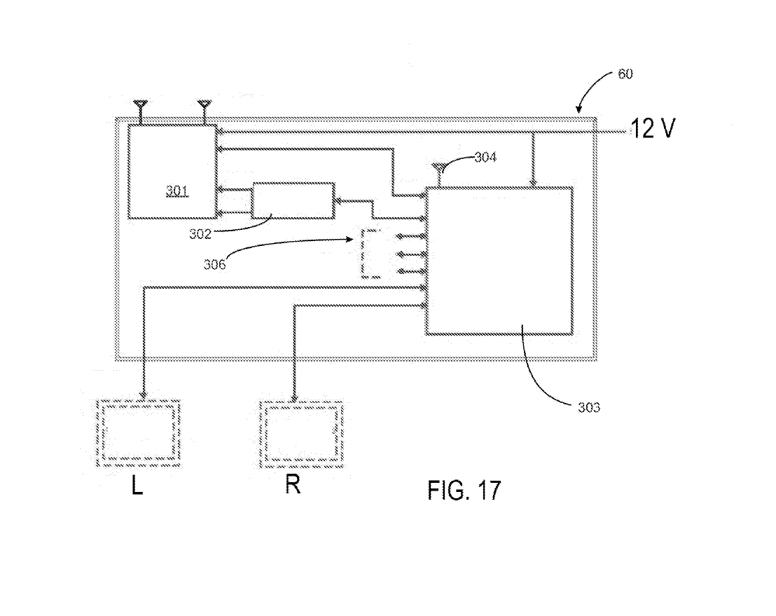

Components which make up the electronics package 60 are shown in FIG. 17 discussed below.

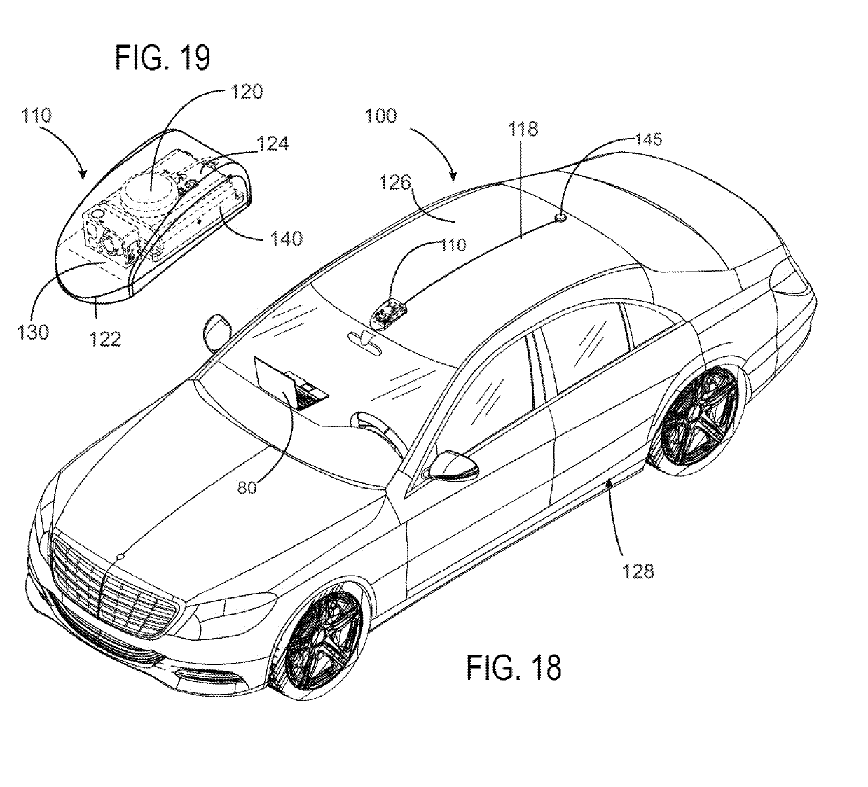

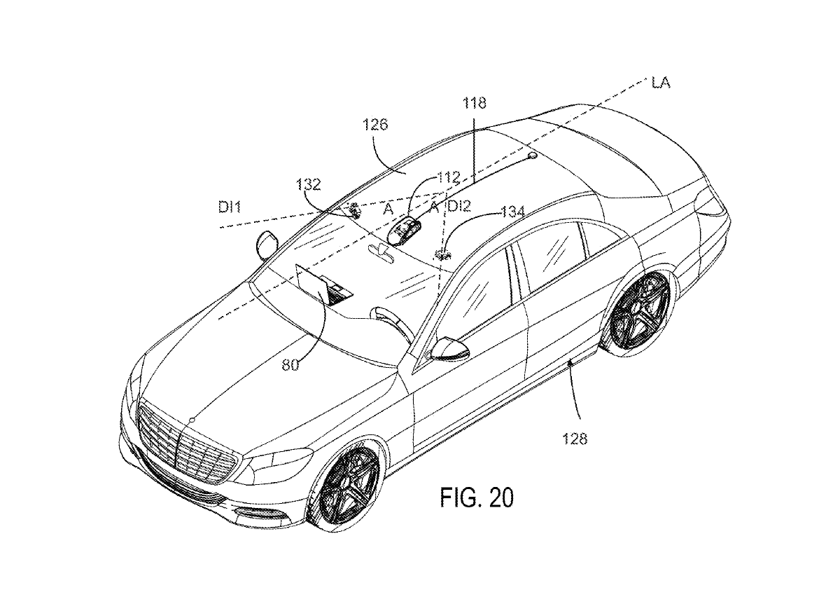

Additional inventive systems are illustrated in FIG. 18 with a single camera assembly and in FIG. 20 with two camera assemblies which are separately located, i.e., spaced apart from one another. The system is illustrated generally at 100 in FIG. 18 and comprises a camera assembly 110 which comprises a GoPro® HERO Black camera 130 or equivalent imaging device, an Advanced Navigation assembly 140, discussed below, and a GNSS antenna 120, all in a common camera assembly housing 122. Internal circuitry 124 connects the antenna 120, camera 130 and navigation assembly 140 in the housing 122. This circuitry 124 may include a processor (see FIG. 19).

The assembly 110 can be mounted onto the exterior surface of a roof 126 of a vehicle 128 along with a second GNSS antenna 145 coupled thereto by a coupling connection 118, e.g., a wire. Mounting means to provide for this mounting may be any known to those skilled in the art for attaching external vehicular components to vehicle body panels and roofs,

In FIG. 20, two camera assemblies 132, 134 are placed on lateral sides of the exterior surface of the roof 126 and rotated at an angle so that their FOVs do not significantly overlap (from the position shown in FIG. 17 wherein the field of view is substantially symmetrical about a longitudinal axis LA of the vehicle 128). This rotation results in a positioning of the camera assemblies 132, 134 such that a longitudinal axis of each housing 122 is at an angle of about 30° to the longitudinal axis LA of the vehicle 128. It is possible to construct the housing 122 to have its longitudinal axis substantially parallel to the longitudinal axis LA of the vehicle 128, but the camera assemblies angled with their imaging direction at an angle of about 30° to the longitudinal axis LA of the vehicle 128 is preferred since it provides for some overlap in the fields of view which can be used for registering the cameras to each other. Thus, the configuration or positioning criteria is for the imaging directions DI1, DI2 of camera assemblies 132, 134, respectively, to be at an angle A of about 30 degrees to the longitudinal axis LA of the vehicle 128 (see FIG. 20) can be used. Other angles can also be used depending on the requirements of the implementation.

If 60° lenses are used in each camera assembly 132, 134, then the angle of rotation can be slightly less than about 30° so that all areas within slightly less than a 120° FOV except a small triangle in the center and in front of the vehicle 128 are imaged. The navigation and antenna assembly 112 is shown mounted in the center of the exterior surface of the roof 126 as an example of a mounting location.

An alternate configuration providing potentially greater accuracy is to move camera assemblies 132, 134 to positions that are as close as possible to the navigation and antenna assembly 112, moving the navigation and antenna assembly 112 slightly rearward so that the camera assemblies 132, 134 would be very close to or touching each other.

For some systems, a portable computing device with a processor, such as a laptop 80 as shown in FIGS. 13, 18 and 20, can be provided to receive, collect and process the image, navigation and IMU data. Laptop 80 may be resident in the vehicle 128 as shown in FIGS. 13, 18 and 20 during use and removable from the vehicle 128 when desired, or permanently fixed as part of the vehicle 128.

In some implementations, the only processing by the laptop 80 will be to tag received images with displacement and angular coordinates of the camera(s) for each image and to update the IMU 44 with corrections calculated from the navigation unit and to compress the images. The IMU 44 may be part of the navigation unit. Images will then be retained on the laptop 80 and transferred either immediately or at some later time to a remote station via, for example, the telecommunications capability of the laptop 80. Preferably, significant compression, including the removal of the sky and other unneeded image information, will be accomplished on the vehicle prior to transmission to the remote site. Trained neural networks or deep learning systems can be used to significantly reduce the image file size prior to transmitting it to a remote site. Eventually, when the map is largely implemented, only landmark notations and locations will be retained and transferred to the remote site if necessary.

At the remote station, there will likely be another processing unit that will further process the received data to create a map as described herein. In other implementations, the images will be processed by a computer program executed by the processing unit on the vehicle to search for landmarks using, for example, pattern recognition technology, such as neural networks or deep learning, which are configured or trained to recognize poles and other landmarks in the images. In this case, only the landmark data is transferred to the processing unit at the remote station for processing by the computer program. Initially, the first process will be used but after the map is fully developed and operational, only landmark data that indicates a map change or error, or temporary additions to the map, is transmitted to the processing unit at the remote station.

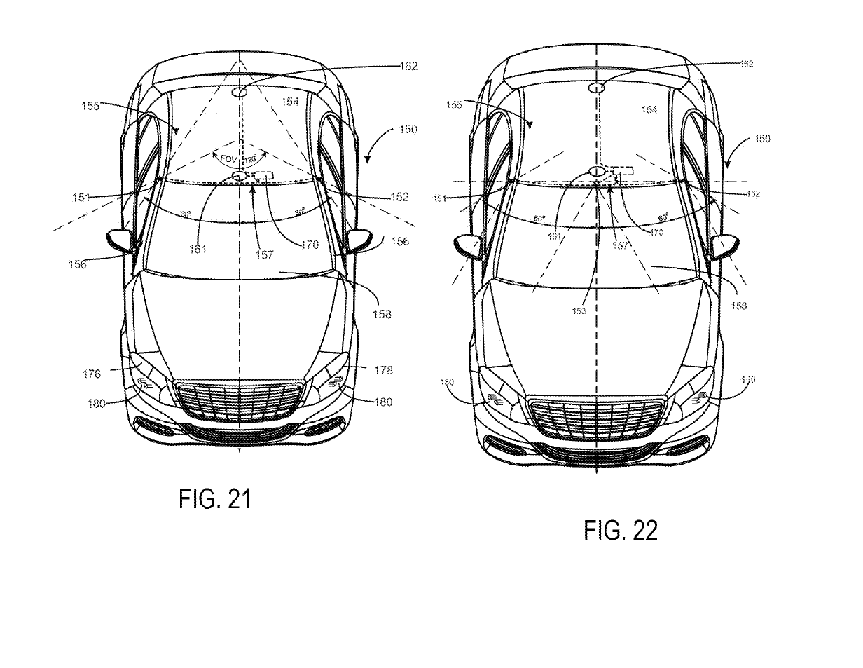

FIG. 21 illustrates integration of a mapping system of the invention into a production vehicle 150 with camera assemblies 151, 152 incorporated into A-Pillars 156 of the vehicle 150. Antennas 161, 162 are integrated into or in conjunction with a surface 154 of the roof 155, in a manner known to those skilled in the art, so that they are preferably not visible. Navigation and other electronics are integrated into a smartphone-sized package 170 and mounted below the roof 155 into or above a headliner 157 of the vehicle 150.

FIG. 22 is similar to FIG. 21 and incorporates a third camera assembly 153 in the headliner 157 thereby providing an approximate 180° total FOV where each camera assembly separately has an about 60° FOV. In an alternative implementation, each of the three cameras can be configured with an about 120° FOV such that the three FOV's overlap by an amount such as 15°. The combined FOV of the assembly then becomes 3*120-4*15 or 300°. If the overlapping sections are used to establish registration of the three camera assemblies 151, 152, 153 such that the images can be adjusted so that they comprise one 300° continuous image which is registered with the camera assemblies and IMU 44, then, many more images can be obtained of a landmark as the vehicle passes resulting in greater location accuracy. Furthermore, such a combined image can be used to compare landmarks such as buildings with previous street view images of such landmarks and changes can be registered to keep street view images up to date. Currently, the Google Street View images of a given area can be years old since they are rarely updated. Furthermore, signs which can only be read looking to the side of the vehicle 150 are readable and thus can be captured in images for further map improvements.

Registration of the three camera assemblies 151, 152, 153 can be accomplished by forcing the overlapped images to exactly coincide by rotating the images and noting the location of the pixels containing common images or parts thereof. Since the forward-looking camera is registered with the IMU so that the pointing direction of every pixel is accurately known, by this method the pixels in the side looking cameras are also similarly registered. Additional camera assemblies can of course be registered in a similar manner such as one looking to the rear or aimed in another direction of interest. By this method, every object within the view of the vehicle camera assemblies can be accurately located and by two such location determinations, the relative velocity vector of each such object can also be determined which information can be used for collision avoidance and other safety issues. Pixels at the top and bottom of the images should be registered in this manner so that the pointing angles of the different camera assemblies are the same in the overlapped portion of the image.

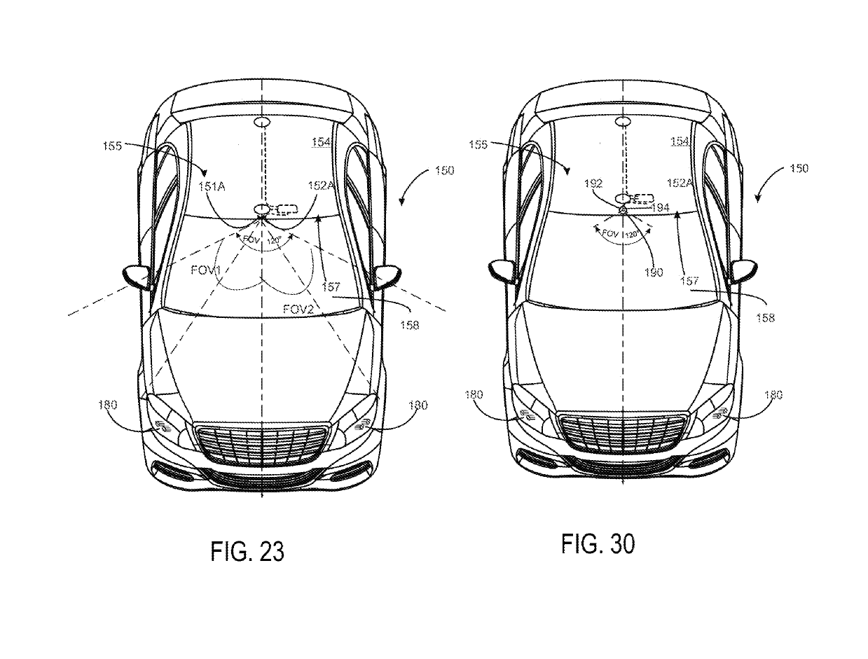

FIG. 23 is like FIGS. 21 and 22 and illustrates an embodiment having two camera assemblies 151A, 152A collocated in the center of the vehicle. The field of view of camera assembly 151A is designated FOV1 while the field of view of camera assembly 152A is designated FOV2, and with each of FOV1 and FOV2 being about 60°, the total FOV is about 120°. Similarly, if the FOVs of each of the three camera assemblies 151A, 152A is about 120°, the camera assemblies can be used as described above for street view and surround-vehicle monitoring. In FIGS. 21-23, production intent designs of the system are presented which show that only lens of the camera assemblies 151, 151A, 152, 152A and 153 are observable protruding from near the interface between a windshield 158 and the vehicle roof 155. From this location, a relatively large portion of each obtained image is blocked by the vehicle roof 155 and windshield 158 and in particular much of the image would be lost for angles exceeding 60° if, for example, a 90° lens were used. Since there is little to be gained from using a 90° lens and the number of pixels per degree would decrease to approximately 43 from 64, the 6020 lens is considered preferred for some of these embodiments.

Cameras assemblies 151, 151A, 152, 152A and 153 do not need to be mounted at the same location and if they were placed at the edges of the vehicle roof 155 at the A-Pillar 156, as in FIG. 22 for example, then advantages of a different angle lens, such as 90° or 120°, could be persuasive. The tradeoff here is in the registration of the camera assemblies with the IMU 44. The system relies for its accuracy on knowing the location and pointing direction of the camera assemblies which is determined by the IMU 44. If the location of the camera assemblies and its pointing direction are not accurately known relative to the IMU 44, then errors will be introduced. The chance of an unknown displacement or rotation occurring between the camera assemblies and IMU 44 is greatly reduced if they are very close together and rigidly mounted to the same rigid structure. This is a preferred configuration and requires that the devices be mounted as close as possible together as illustrated in FIG. 23 for two camera assemblies and a FOV of 120°. Alternately, the overlapping FOVs can provide the necessary information for the combined camera registration

When the system is used for determining vehicle location in poor visibility situations, IR flood lights 180 are provided at the front on each side of the vehicle 150 to augment illumination of headlights 178 of the vehicle 150. The camera assemblies in this case are preferably, and possibly required to be sensitive to near IR illumination.

In some embodiments, additional camera assemblies or wide angle lenses can be provided which extend the FOV to 180° or more. This will allow the mapping system to also monitor street view scenes and report changes.

Embodiments illustrated in FIGS. 21-23 can incorporate passive IR for position of the vehicle 150 under low visibility conditions, such as at night. However, this generally will require additional imagers as cameras which are sensitive to visual and near IR are usually not sensitive to long wave thermal IR.

Electronics used in package 60 of FIG. 13 are shown as a block diagram generally at 60 in FIG. 17. An important component of the electronics package 60 is the GNSS aided inertial navigation system including an Attitude and Heading Reference System (AHRS), collectively referred to herein as the AN 301. The AHRS generally comprises sensors on three axes that provide acceleration and attitude information including roll, pitch and yaw, otherwise known as the IMU. They are designed to replace traditional mechanical acceleration and gyroscopic flight instruments and provide superior reliability and accuracy. A preferred system used herein is called the Spatial Dual and is manufactured by Advanced Navigation of Australia.

When used with RTK differential GNSS, the horizontal position accuracy is about 0.008 m, the vertical position accuracy is about 0.015 m and the dynamic roll and pitch accuracy is about 0.15° and the heading accuracy is about 0.1°. When the system is in serial production, a special navigation device is provided having similar properties to the AN 301, potentially at a lower cost. Until such time, the commercially available AN may be used.

AN 301 contains the IMU, having components described elsewhere herein, and two spaced apart GNSS antennas. Antennas provide the ability to attain accurate heading (yaw) information. In addition, the AN 301 contains a receiver for receiving differential corrections from OmniSTAR and RTK differential correction systems. RTK is becoming available in a significant part of the world and provides the greatest accuracy. Also, for one time mapping purposes, an array of RTK stations can be temporarily installed. When RTK is not available, the OmniSTAR system can provide differential corrections with less accuracy, on the order of about 0.1 m. Accurate mapping can be obtained with either system and even without any differential corrections; however, a greater number of images are required, the lower the position and angular accuracy that is available. When RTK is available, 10 cm landmark position accuracy can be obtained on a single pass by an image acquiring vehicle whereas up to 10 passes may be required when only OmniSTAR is available and perhaps 50 to 100 passes when no differential corrections are available.

In FIG. 17, 302 represents the USB2 to GPIO-General purpose input/output module, 303 the processor, 304 the Wi-Fi or equivalent communications unit and 306 the expansion USB ports for additional cameras.

If the vehicle is operating in a region where ubiquitous high speed internet is available, then the vehicle navigation display of the vehicle navigation system, or on an occupant's smartphone, is continuously updated by a connection to the cloud over the internet. Otherwise, the display of the vehicular navigation system can be generated by a vehicle-based processor. In either case, accurate position of the vehicle on the map being displayed by the navigation system can be represented for route guidance purposes and the presence of points of interest highlighted.

Once accurate three-dimensional maps are available, as can be accomplished using the invention, this information can be combined with the kinematic information of the vehicle, such as its velocity, to provide a warning to the driver via a warning system, or the autonomous driving system, that the vehicle velocity is too high for the upcoming curve, for example.

If side view cameras are present, the location of driveways, for example, and other features which can only be seen looking to the side can guide the vehicle into driveways.

### 12. Mapping Issues

In a preferred implementation of the map management system, a special group of managed probe vehicles create the initial map under control of a mapping team. These vehicles follow predetermined paths to cover all roads in the region to be mapped with a minimum of overlap. In this manner, a few hundred vehicles, for example, can map an entire country in as little as one to two years. Such vehicles can operate with an accurate GNSS correction system, such as the RTK correction system, ubiquitously available in several countries or can be temporarily installed. Once a region is mapped, additional vehicles will not need this RTK system since they can correct their IMUs using their cameras and maps. This substantially reduces the equipment cost of subsequent production vehicles for general distribution.

Creation of the initial map, using these managed probe vehicles, will likely be done during daylight hours and when the weather is good and snow and other interferences are not present. It should also be done when traffic is light so that other vehicles do not interfere with the images. Once the map is created, then the map management system is extremely tolerant to these interferences.

During map creation, there remain problems related to tunnels and urban canyons. The GNSS signals are corrupted by multipath, for example, or are not available. A solution to these issues relies on accuracy of the IMU and being able to detect that the GNSS signals are absent or corrupted. There is extensive literature describing methods of determining that GNSS signals are reliable, and in some cases correcting received signals. The issue reverts to how to handle a situation when GNSS signals are not present or not reliable.

The vehicle knows its position and orientation from the IMU which contains three accelerometers and three gyroscopes. These six devices drift or degrade in accuracy with time and thus the RTK system is used to correct the drifting errors in these devices. In some cases, this can be done every 0.1 second. The rate at which these corrections are needed depends on accuracy or quality of the IMU. Some IMUs need to be corrected every second or more often, whereas others can go for many seconds and for expensive IMUs, even minutes without correction. Better IMUs are more expensive, but they do exist . Also, making multiple passes through a tunnel or urban canyon when traffic is light provides more data to aid in increasing accuracy of the anchor point positions. Both of these approaches achieve the 10 cm accuracy desired and the particular approach chosen depends of the IMU technology state at the time. One approach is to allocate more accurate IMUs to a portion of the managed mapping vehicle fleet and direct their image acquisitions to problem areas. A vehicle with an accurate IMU can map a many mile long tunnel in one pass, for example, if it is equipped with a sufficiently accurate IMU such as the Systron Donner IMU.

Other techniques are used to determine the drift rate for the IMU including stopping the vehicle from time to time since while the vehicle is stopped, the IMU components should not be drifting. In this case, even though the current drift can be stopped, the error cannot be corrected by this method. Partial correction techniques may be used. For example, some mapping systems do not attempt to determine absolute position of landmarks, but can determine their position relative to other landmarks Relative positions of landmarks can be accurately determined with the inventive mapping system even if errors in the absolute positions are increasing. Thus, maps can still accurately display relative positions of all landmarks while the absolute positions are improving from multiple runs of the mapping vehicles. Also, frequently the location of the start and end of a segment is accurately known and the intermediate points have their positions relative to other landmarks accurately known. Combining this data results in all points being accurately known.

This can be entirely transparent to the map user. For example, TESEO DRAW firmware for ST's multi-constellation positioning chips enables navigation devices to provide continuous, accurate location and turn-by-turn instructions even when satellite signals are poor or unavailable, such as in tunnels, covered car parks, or multi-level highways. TESEO DRAW also enhances performance in built-up areas, such as in urban canyons, where conventional navigation systems can lose accuracy. Although the TESEO DRAW firmware in conjunction with ST's positioning system improves position accuracy of a vehicle in tunnels and urban canyons, it is insufficient to allow for 10 cm accuracy calculations of landmark positions from a single pass. Multiple passes, however, will lead to this accuracy.

Another approach is based on the principle that there are electromagnetic spectrum frequencies which are not significantly attenuated by passing through buildings or significant depths of the earth. A pseudolite system operating at one or more of such frequencies can be established either on a temporary or permanent installation to transmit GNSS and correction information, including a pseudo-RTK system, to solve the tunnel and urban canyon problem. However, since other less expensive solutions are available, such an installation is probably not necessary except in some extreme locations.

When creating the map database, use can be made of aerial images or maps which show roads in urban canyons, for example. In many cases, there are points along that road where accurate GNSS signals are obtained and accurate position calculations can be made. In many cases, the road is straight between such points so that knowing some points accurately can allow the road to be accurately mapped in its entirety. Even for tunnels, the beginning and end of the tunnel can be accurately mapped and maps of the tunnel created during its construction, for example, can be used to facilitate the accurate mapping of the entire tunnel.

There are many objects in the environment which are not generally suitable to be used as landmarks, such as trees and lakes, but where their location is nevertheless required to be noted on maps. Generally, anchor points on such objects are difficult or not possible to define and may even move over time. Such objects can be noted and assigned an approximate location which can be changed from time to time by other probe vehicles as necessary. Thus, a vehicle will know that a tree exists which should be avoided even though its location within a few centimeters is not precisely known. Where sufficient landmarks are not present, they can be easily added, if necessary, for the mapping and localization purposes. An example can be the placement of poles along the edge of a cliff or lake.

One of the defined landmarks on a road is a painted line, such as a lane marker. In many cases, this line has worn off and is barely observable or may not even be present at all. The inventive mapping system, using line painting standards, knows where the missing line is supposed to be and can note it on the map. Thus, an autonomous vehicle can operate as if the line existed until it in fact does exist, at which point the map can be changed, if necessary, to reflect the precise location of the newly painted line. Unpaved roads do not generally have lines and this feature can be very useful when such a road, or any other road, is snow covered, for example.

Due to motion of tectonic plates or earthquakes, entire land masses can move centimeters either in a short period, as in the case of an earthquake, or over the period of a year as in the case of the tectonic plate motion. Once this movement is known, maps can be adjusted to account for their effects.

To summarize, the inventive image-based mapping system accomplishes everything that lidar-based or other mapping systems can accomplish with more accuracy and at a fraction of the cost.

### 13. Image Distortions

Several distortions can arise in an image taken by a camera assembly. Some are due to aberrations in the lens of the camera assembly which are local distortions caused when the lens contains an imperfect geometry. These can be located and corrected for by taking an image of a known pattern and seeing where deviations from that known pattern occur. A map can be made of these errors and the image corrected using that map. Such image correction would likely be performed during processing of the image, e.g., as a sort of pre-processing step by a processing unit receiving the image from a camera assembly.

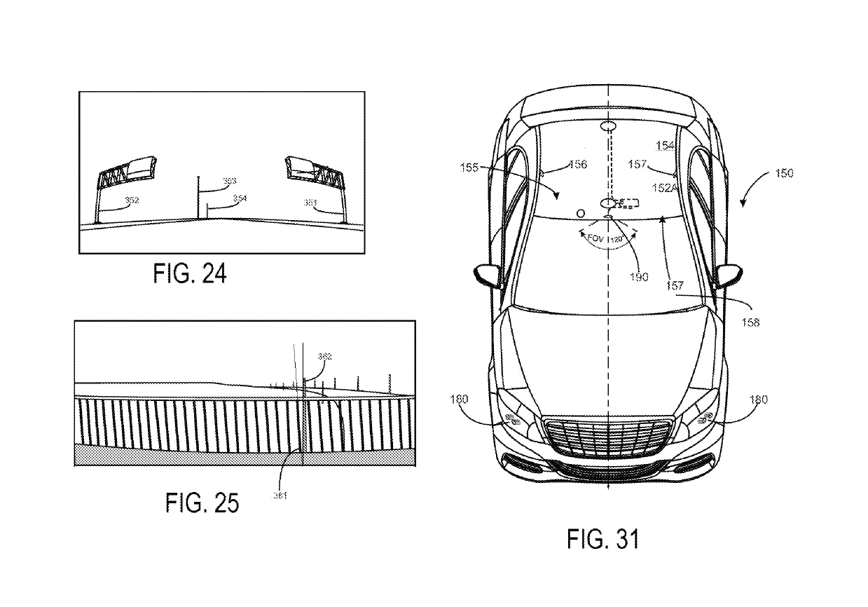

Barrel distortions are caused by distortions arising from use of a curved lens to create a pattern on a flat surface. They are characterized by a bending of an otherwise straight line as illustrated in FIG. 24. Straight poles 351, 352 on lateral sides of the image are bent toward the center of the image while poles 353, 354, already located in or near the center, do not exhibit such bending. This distortion is invariant with the lens and can also be mapped out of an image. Such image correction would likely be performed during processing of the image, e.g., as a sort of pre-processing step by a processing unit receiving the image from a camera assembly. The amount of distortion is a function of the lens design. Lenses can and are being designed with minimum barrel distortion, for example, and such lenses can be used in the invention.

Cameras generally have either a global or a rolling shutter. With the global shutter, all pixels are exposed simultaneously, whereas with the rolling shutter, first the top row of pixels are exposed and the data transferred off of the imaging chip and then the second row pixels are exposed, etc. If the camera is moving while the image is being obtained with the rolling shutter, vertical straight lines appear to be bent to the left as shown by nearby fence pole 361 compared with distant pole 362 in FIG. 25. Correction for rolling shutter caused distortion is more complicated since the amount of distortion is a function of, for example, the shutter speed, the vehicle velocity and the distance of the object from the vehicle. Shutter speed can be determined by clocking the first and last data transferred from the camera assembly. Vehicle speed can be obtained from the speedometer or the IMU, but the distance to the object is more problematic. This determination requires the comparison of more than one image and the angle change which took place between two images. By triangulation, knowing the distance that the vehicle moved between the two images allows determination of the distance to the object. Correction for rolling shutter distortion is thus computationally difficult and, therefore, a preferred camera for practicing inventions is the global shutter camera. If a landmark has already been mapped and the images are being used to locate the vehicle for the purpose of correcting the IMU, then the distance to the landmark is known from the map and the correction caused by the rolling shutter is easier.

By the above methods, all known distortions can be computationally removed from the images, e.g., by one or more processors processing the images or data derived therefrom.

An important part of some embodiments of the invention is a digital map that contains relevant information relating to a road on which the vehicle is traveling. The digital map, stored in a database in electronic form, usually includes location of the edge of the road, edge of the shoulder, elevation and surface shape of the road, character of the land beyond the road, trees, poles, guard rails, signs, lane markers, speed limits, etc. These data, or information, are acquired in a unique manner and the method for acquiring the information either by special or probe vehicles and its conversion to, or incorporation into, a map database that can be accessed by the vehicle system is part of this invention.

Maps in the map database may also include road condition information, emergency notifications, hazard warnings and any other information useful to improve safety of the vehicle road system. Map improvements can include presence and positions of points of interest and commercial establishments providing location-based services. Such commercial locations can pay to have an enhanced representation of their presence along with advertisements and additional information which may be of interest to a driver or another occupant of the vehicle. This additional information could include the hours of operation, gas price, special promotions etc. Position of the commercial establishment can be obtained from probe vehicles and the commercial establishment can pay to add additional information to the map database to be presented to the vehicle occupant when the position of the establishment is presented on the map being displayed in the display of the navigation system.

All information regarding the road, both temporary and permanent, should be part of the map database, including but not limited to speed limits, presence of guard rails, width of each lane, width of the highway, width of the shoulder, character of the land beyond the roadway, existence of poles or trees and other roadside objects, location and content of traffic control signs, location of variable traffic control devices, etc. The speed limit associated with locations on the maps may be coded such that the speed limit depends upon the time of day and/or the weather conditions. In other words, the speed limit may be a variable that changes from time to time depending on conditions. Other information may also be variant dependent on, e.g., the time of day and ambient conditions.

It is contemplated that there will be a display for various map information which will always be in view for the passenger and/or driver at least when the vehicle is operating under automatic control. Additional user information can also be displayed on this display, such as traffic conditions, weather conditions, advertisements, locations of restaurants and gas stations, etc.

Very large map databases can now reside on a vehicle as the price of memory continues to drop. Soon, it may be possible to store the map database of an entire country on the vehicle and to update it as changes are made. The area that is within, for example, 1000 miles from the vehicle can certainly be stored and as the vehicle travels from place to place, the remainder of the database can be updated as needed though a connection to the Internet, for example.

In view of the foregoing, the invention contemplates a method for providing map information to an operator of a vehicle in which a map database is formed to reside on the vehicle, e.g., after installation on the vehicle, and which includes for example, data about lanes that the vehicle can travel, on locations of a boundary or edges of the travel lanes, data about traffic control devices in the database, data about guard rails along travel lanes and/or data about inanimate objects such as poles and trees alongside the travel lanes. The database is managed to ensure that it has current information about a travel lane on which the vehicle is currently situated. This may entail establishing wireless communications to the vehicle to enable data to be provided to the vehicle resident database, e.g., from other vehicles and/or from the infrastructure.

Among other features, management of the database may include transmitting from the vehicle requests, for example, to a central map management facility or infrastructure, to ascertain whether the database has current map data for the current location of the vehicle and surrounding locations. For example, a latest date and time of each segment of the map database may be broadcast, or supplied by a live Internet connection, to that portion of earth covered by the map database segment to enable the vehicle, when it approaches or enters each discrete portion of earth, to compare its date and time of the map database segment with the broadcast latest date and time. If the processor of the vehicle realizes that its date and time of a file of the map database segment differ from the broadcast or Internet received date and time, it can automatically initiate a transmission to receive the latest map data for inclusion in its database or simply be programmed to accept and process a transmission of the map data (broadcast map updates). If the database has the latest map data, the processor can be designed to prevent processing of the transmitted map data since it is unnecessary.

Map data may be received using infrastructure-to-vehicle communication, Internet communication and/or a communications system in the vehicle. Map data may also be transmitted to the vehicle for a section to be traveled by the vehicle to be included in the database from infrastructure as the vehicle passes by the infrastructure in advance of the section to be traveled. The database may be limited to map data within a predetermined distance from the vehicle and additional map data provided to the database for areas for map data is not included in the database via a wireless communication to the vehicle as the vehicle travels toward the area for which map data is not included in the database. Map data from the database may be displayed to an occupant of the vehicle on a display in the vehicle or on a portable communications device used by the vehicle occupant when present in the vehicle.

An exemplifying arrangement for providing map information to an operator of a vehicle includes a database arranged in the vehicle as described above, a communications system arranged on the vehicle and arranged to establish communications with infrastructure, and a processor coupled to the database and the communications system for managing the database to ensure that the database has current information about a travel lane on which the vehicle is currently situated. When necessary, the processor establishes wireless communications via the communications system to enable data to be provided to the database.

Initial maps showing roadway lane and boundary location for the continental United States, for example, can be installed within the vehicle at the time of manufacture. The vehicle, i.e., the processor thereon, can check on a section-by-section basis whether it has the latest update information in the database for the current and surrounding locations where it is being operated. One method of verifying this information is if a satellite or Internet connection periodically broadcasts the latest date and time or version that each segment was most recently updated. This data is analyzed by the processor. Alternatively, the processor on the vehicle can check the Internet for such information if it has a live Internet connection. This matrix would amount to a small transmission requiring perhaps a few seconds of airtime.

Additional emergency information could be broadcast in between the periodic transmissions to cover accidents, trees fallen onto roads etc. If the periodic transmission were to occur every five minutes and if the motion of a vehicle were somewhat restricted until it had received a periodic transmission, the safety of the system can be assured.

If the vehicle finds that it does not have the latest map information, vehicle-to-infrastructure communication, Internet communication (Wi-Fi, Wi-max or equivalent), or the cell phone in the vehicle, can be used to log on to the Internet, for example, and missing data downloaded. An alternate is for the GEOs, LEOs, or other satellites, to broadcast map corrections directly.

When mention is made of the vehicle being operative to perform communications functions, it is understood that the vehicle includes a processor, processing unit or other processing functionality, which may be in the form of a computer, which is coupled to a communications unit including at least a receiver capable of receiving wireless or cellphone communications, and thus this communications unit is performing the communications function and the processor is performing the processing or analytical functions.

Map data may be off-loaded from a transmitter on the highway itself or at a gas station or other structure beside the road, for example. In this case, vehicles would only obtain map information needed soon and map information would always be up to the minute. As a minimum, temporary data communication stations can be placed before highway sections that are undergoing construction or where a recent blockage has occurred, as discussed above, and where maps have not yet been updated. Such an emergency data transfer would be signaled to all approaching vehicles to reduce speed and travel with care. Such information could also contain maximum and minimum speed information which would limit the velocity of vehicles in the area.

Other locations for transmitters include anywhere on or alongside a roadway on which the vehicles travel, any vehicle-accessible commercial or public location such as malls, at the vehicle operator's home or place of business, and even on a road sign. Moreover, if information about weather or road conditions in vicinity of the transmitter is obtained, e.g., via vehicles traveling the vicinity of the transmitter, a maximum speed limit for roads near the transmitter can be determined by a traffic monitoring facility based on the information about weather and/or road conditions and provided to the transmitter for transmission to vehicles. This speed limit would then be conveyed to signs associated with, in or on roads affected by weather and/or road conditions.

There is other information particularly useful to a vehicle operator or control system, including weather conditions, especially at the road surface. Such information could be obtained by road sensors and transmitted to all vehicles in the area by a permanently installed system (see U.S. Pat. No. 6,662,642). Such road sensors could be embedded in or alongside the road surface to obtain data about the road surface with data being directed to transmitters for transmission to vehicles in range of the transmitter and traveling or expected to travel over the road surface in or alongside which the sensors are embedded. The transmission technique may be as described herein for transmitting information to vehicles from infrastructure-based transmitters.

Alternately, there have been recent studies that show that icing conditions on road surfaces can be accurately predicted by local meteorological stations and broadcast to vehicles in the area of such icing conditions. If such a system is not present, then the best place to measure road friction is at the road surface and not on the vehicle. The vehicle requires advance information of an icing condition to have time to adjust its speed or take other evasive action. The same road-based or local meteorological transmitter system could be used to warn operators of traffic conditions, construction delays etc. and to set the local speed limit

In general, information provided to the transmitters for transmission to vehicle operators can be weather information, road surface information, traffic information, speed limit information, information about construction, information about points of interest (possibly restricted based on position of the vehicle), information about presence of animals in proximity to the road, information about signs relating to the road, accidents, congestion, speed limits, route guidance, location-based services, emergency or other information from police, fire or ambulance services, or information generated by probe vehicles. Probe vehicles are generally those vehicles which precede the host vehicle in time along the same highway or in the same area.

Once one vehicle in an area has discovered an icing condition, for example, this information can be immediately transmitted to all equipped vehicles through a communication system. Icing and other such conditions could be sensed and the information transmitted automatically by hardware on the vehicle without driver involvement.

Any information sensed by a vehicle traveling on a roadway, including the maintenance state of the roadway itself, is automatically monitored and relevant information transmitted automatically over the Internet, or equivalent, to a central control station, or centralized data source monitored and controlled thereby, along with appropriate pictures if available. This includes road condition monitoring such as for potholes etc., transmitting warnings of slippery roads, bad weather, changed speed limits and construction zones including the sending of photographs or video of any place where the road and/or traffic appears to be improperly functioning such as resulting from an accident, impact with a deer, mudslide, rock slide, etc. Other examples include highway spills, boxes fallen from vehicles, and reporting of vehicle and other fires including brush fires, the reporting of any anomaly can be done by pictures or a recorded voice. Furthermore, visibility conditions, which can be used for setting speed limits and for setting the maximum speed that a vehicle is permitted to travel, can be reported if the vehicle has such measuring equipment. All such reporting except that requiring a voice input can be done automatically or initiated by a vehicle occupant. Use of pictures in creating and maintaining the map database was discussed above.

If output of the IMU pitch and roll sensors is additionally recorded, a map of the road topography can be added to the map to indicate side-to-side and forward-to-rear slopes in the road. This information is used to warn vehicles of unexpected changes in road slope which may affect driving safety. It can also be used along with pothole information to guide road management as to where repairs are needed.

Eventually, all cars will be connected to a combination of a broadcast and/or local network (e.g., mesh or ad-hoc) system for collision avoidance and ubiquitous Internet connections for map-based road hazards that are discovered by the vehicle. As a vehicle travels down a road and discovers an accident for example, a photograph of that accident can be stored and uploaded to the Internet for interpretation by a human operator or an algorithm which can download a message based on the map location of the accident to warn other vehicles in the vicinity until the accident is cleared up, which can be determined by another probe vehicle. This can be an automatic action by the vehicle operating system or it can be initiated by the driver.

There should not be any obstacles on the highway and when one is discovered, it can be automatically photographed and uploaded to the remote station via the Internet for proper handling in terms of warnings and removal of the hazard. Until the time comes when this network is everywhere, alternate systems can partially fill in the gaps such as XM radio and other satellite-based systems. This could be used only for downloading map changes. For uploading information, the vehicles would wait, maintaining data to be sent to a database until they have a direct Internet or other connection.

Many additional map enhancements can be provided to improve highway safety. For example, the mapping camera can include stoplights in its field of view and as the vehicle is determined to be approaching the stoplight, i.e., is within a predetermined distance which allows the camera to determine the status of the stoplight, and, since the existence of the stoplight will be known by the system, as it will have been recorded on the map, the vehicle will know when to look for a stoplight and determine the color of the light. It could maintain speed or slow down accordingly, which would be especially useful for self-driving vehicles

More generally, a method for obtaining information about traffic-related devices providing variable information includes providing a vehicle with a map database including location of the devices, determining location of the vehicle, and as the location of the vehicle is determined to be approaching the location of each device, as known in the database, obtaining an image of the device using for example, a vehicle-mounted camera. This may be performed by the processor which interfaces with the map database and the vehicle-position determining system. Images are analyzed to determine status of the device, which entails optical recognition technology.

Once the status of the devices, e.g., stoplights, is known from the image analysis, it becomes possible to control the vehicle based on the status of the device or to warn the driver to take appropriate action. Additionally, if the device is a stoplight, a determination may be made whether the driver of the vehicle is slowing the vehicle when the stoplight is red and if not, automatically causing the vehicle the slow down or stop via a control system of the engine or transmission. Status of the device can also be displayed to a driver of the vehicle.

Where RTK GNSS is available, a probe vehicle can know its location within a few centimeters and in some cases within one centimeter. If such a vehicle is traveling at less than 100 kph, for example, at least three to four and as many as ten images can be obtained of each landmark near the road. From these images, the position of each landmark can be obtained to within 10 centimeters which is sufficient to form an accurate map of the roadway and nearby structures. Thus, a single pass of a probe vehicle is sufficient to provide an accurate map of the road without using special mapping vehicles.

### 14. Mapping Using Probe Vehicles

An important feature of this invention is the ability to rapidly create the initial map by using a fleet of vehicles having equipment such as RTK differential corrections to GNSS satellite data which permits the accurate location and pointing direction of a vehicle mounted imager. This permits a small fleet of vehicles to rapidly create an initial accurate map of a region or country. For this initial map generation, data can be transferred to the map management site, hereinafter called the cloud, through a high speed wired or wireless connection. Once the initial accurate map has been created, data transfer to the cloud will be necessary only for temporary conditions, when a new landmark appears, one has been moved or an error has been discovered. This data transfer to the cloud can then be through a wireless connection and the total amount of data will be small and thus should not be a bandwidth issue. This method as described herein whereby multiple images from a single vehicle during one pass are combined to accurately locate a landmark is important to this invention.

As discussed above, using the inventive system, new landmarks can be defined and added to the map database. Software for each equipped vehicle can be updated wirelessly with the new landmark definition and thereafter whenever the vehicle encounters a landmark meeting the new definition, the location information is sent to the cloud operating system and incorporated into the map database.

### 15. Mapping Vehicle and Production Vehicle

A dedicated mapping vehicle may be used for creating the initial map database. This vehicle can be a modified production vehicle with some additional equipment. Particularly, the location of the mapping vehicle will be derived using RTK corrections. RTK stations will need to be positioned in the area to be mapped such that the mapping vehicle will preferably have line of sight access to the RTK station which will be no more than 30 km from the vehicle. Under these conditions, the vehicle should be able to determine its position within an accuracy of less than 1 cm. As part of the mapping process, these RTK stations will be pre-positioned sufficiently in advance of the travel of the mapping vehicle such that they have established their position. Using this process, the OnePass™ mapping system can be accomplished.

An alternate and less expensive approach is to use wide area differential GPS. Since this yields a vehicle location accuracy of 10 cm or less, multiple passes may be required to obtain the desired mapping accuracy of landmarks to 10 cm. Note that these measurements are based on one sigma.

Initial data collection may involve sending highly compressed images of the area to be mapped to the cloud. Since this involves significant data, the mapping vehicle may record the data for later transmission to the cloud. Once a sufficient number of landmarks have been defined and the pattern recognition software is available on the mapping vehicle, the amount of data transmitted to the cloud can be limited to data relating to landmarks only. Although this will be significantly less than sending compressed images, the dataflow will still be significant since the area being mapped has not previously been mapped. Once the initial map is completed, the amount of data is substantially reduced since only changes to the maps are uploaded. In any case, substantial onboard data recording capability will likely be required for the mapping vehicle.

There are locations where an RTK station will not have sufficient view of the satellites to determine its location. This includes tunnels and, in some cases, urban canyons. For example, when a mapping vehicle enters a tunnel, its IMU may accurately know the position of the vehicle. Depending on the length of the tunnel, the IMU may lose significant accuracy by the time it exits the tunnel and again is able to be corrected. Various mathematical operations can be performed on the data to fit a smooth curve from the entrance and exit of the tunnel. Similarly, the tunnel can be traversed in both directions and multiple times to further reduce the errors. To further minimize this problem, a more expensive IMU can be chosen for the mapping vehicles, or for a subset of these vehicles which are used for mapping such areas.

Additional equipment required for mapping vehicles will increase the costs of these vehicles relative to production vehicles. At most, a few hundred vehicles will be required to map a large country and thus the cost differential is probably not significant compared to the system development costs.

Requirements for production vehicles differ from mapping vehicles. Production vehicles determine their location, known as localization, by determining positions of landmarks in images obtained by the vehicle's camera. These images are processed to determine errors in the IMU and the IMU is then corrected. The GNSS satellites are not used in this process and thus a GNSS receiver is not required for a production vehicle. It may be present for other vehicle-resident systems but it need not be part of the mapping system. Similarly, an RTK receiver is not required. Additionally, an onboard data recorder is not needed. Elimination of this hardware substantially reduces the cost of the vehicle-resident localization and mapping system.

A high-speed connection to the cloud is desirable but not required for the mapping vehicles but is likely to be required for production vehicles. Finally, the mapping vehicles can select the environment when mapping is conducted and thus problems such as rain, snow, fog, driving under low visibility conditions such as at night, do not need to be considered. However, since the production vehicles are to obtain their positions from landmark images, visibility is important, which may require the addition of illumination around the vehicle by infrared spotlights or radar. This additional equipment is mainly required when production vehicles are used under low visibility conditions which is not advisable in general.

### 16. Surround Vehicle Monitoring

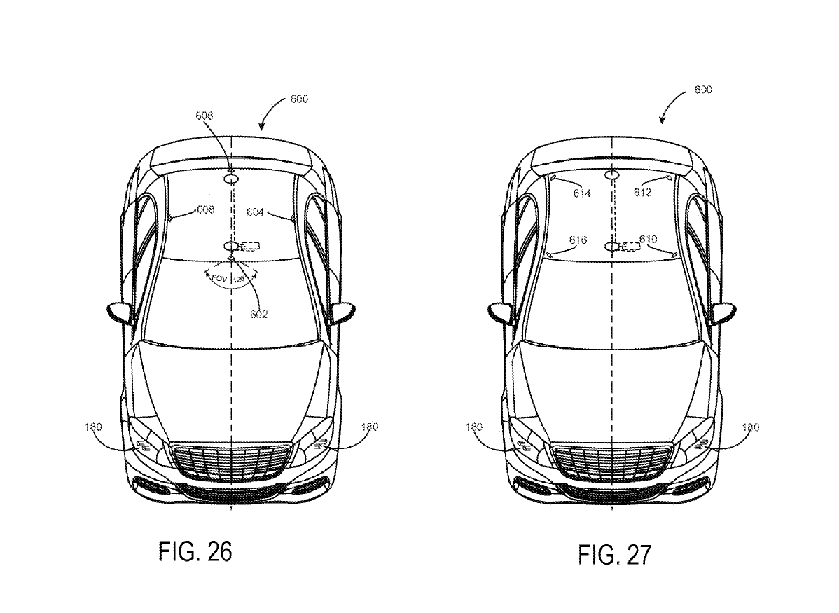

FIG. 26 illustrates an embodiment wherein a system is integrated into a production vehicle 600 with four camera assemblies 602, 604,606, 608 incorporated into a vehicle roof, at the midpoints of the sides, such that a small portion of the FOV of each camera overlaps with two other cameras. FIG. 27 is like FIG. 26 with the cameras 610, 612, 614,616 placed on the four corners of the vehicle roof.

Cameras installed on a vehicle which record the surrounding environment for mapping purposes need to be accurately registered to the IMU as well as to each other. A small displacement error such as caused by thermal expansion of the supporting material can be tolerated but even a slight rotation can cause serious mapping errors. Ideally a single camera assembly would be mounted on the vehicle roof which is capable of capturing the entire 360° environment surrounding the vehicle but such a camera would need to be raised significantly above the vehicle roof so that the vehicle itself does not interrupt too much of the view. Such an installation would be subject to damage causing displacements and rotations of the assembly relative to the vehicle plus it would not be esthetically pleasing.

To capture the 360° surround view, therefore, requires multiple cameras placed on the outer edge of the vehicle. Images from these cameras are stitched together to obtain the complete 360° view. The problem is simplified if the cameras all lie in the same approximately horizontal plane. This arrangement renders the mapping of lines painted on the roadway and other objects which are near to the vehicle as it travels down the road. It can be difficult to obtain usable images of such a painted line using a single forward-facing center mounted camera.

All four cameras must be registered to the IMU and to each other if accurate image data is to be obtained. The pointing angles of all cameras must be accurately known if the landmark locations in the environment are to be determined. Once assembled on the vehicle, the camera locations relative to the IMU and to each other should be accurately known and are unlikely to change significantly during the life of the vehicle. A 1 cm change, for example, is unlikely and probably of little significance if it occurred. Larger displacements would only occur in the case of an accident and in this case, the repair facility would need to perform a recalibration procedure. Angular rotations are much more serious and even very slight relative rotations must be considered. For example, for a 20 MP camera with a field of view of 30° vertical by 120° horizontal, 1 pixel is about 0.5 centimeter at 30 meters. Cameras on the vehicle, therefore, should not be out of alignment by more than about 1 pixel.

The four cameras are positioned on the sides or corners of a plane slightly below the roof of the vehicle, each with a 120° FOV, then the FOV of each camera will overlap 15° with each of its two adjacent cameras. Each camera should lie in the plane of the others and be pointed with its axis parallel to the plane. As the vehicle drives, 15° of each camera field of view will overlap with the adjacent cameras. If any of the cameras rotate unexpectedly relative to the others, the overlapping sections will no longer show the same image. Since the cameras will all be factory aligned, it is likely that only a single camera will have rotated and thus it ought to be easily spotted. If all cameras are located on the same plane, then the distance to the reflecting object in the environment should not matter. All of the pixels in the overlapping part on one camera should show the same image as the corresponding pixels on the adjacent cameras. There will, of course, be a slight angular misalignment of adjacent cameras due to the different mounting locations. A thin rectangular object will cover a slightly different number of pixels in one camera than in the other. The images, therefore, can be processed mathematically until the best fit in the overlapping regions is obtained. This will involve rotating the offending camera image by pitch, yaw and roll until the best fit of the pixel alignment occurs.

An alternate approach is to project laser beams from the vehicle at the top and bottom of the overlapping areas, for example, such that the reflections show up in all of the images permitting easy rotation of the images so that the laser illuminated points align.

Images can be continuously compared as the vehicle proceeds down the roadway and an algorithm developed which selects which images to be used for this best matching process. In some images, a 1 pixel misalignment can cause a significant mismatch and thus this process should converge to a one or two pixel accuracy.

Thus, using this simple technique of the best fit algorithm, the relative rotation errors in the four cameras can be substantially eliminated allowing the tracking of objects as they leave one imager and enter the FOV of the adjacent imager. Similarly, if the IMU is registered to one of the four cameras, it becomes registered to all four. Relative displacements of the four cameras must also be taken into account.

Since cameras are cheap, as is processing power, adding an additional 4 cameras to the vehicle will not add significant additional cost. FIG. 28 illustrates an embodiment as in FIGS. 26 and 27 combined wherein a system in accordance with the invention is integrated into a production vehicle 150 with eight camera assemblies 602, 604, 606, 608, 610, 612, 614, 616 incorporated into the roof of the vehicle such that a significant portion of the FOV of each camera overlaps with four of the other cameras. Each camera has at least 60° within the overlapping FOV of four other cameras for registration purposes. The same analysis that applies to FIG. 26 applies here. If desired, the four additional cameras can have different imaging properties, such as being sensitive to near IR, to improve visibility in bad weather.

A roof mounting location has been assumed as a preferred location. This can be problematic for convertibles, for example. There may be other considerations that dictate a set of locations that are lower than the roof so this invention is not to be limited to roof or near roof mounting locations. It is desirable however, that the cameras lie in a plane.

When multiple cameras are used, they can be electrically connected using teachings of WO2016191662 and U.S. provisional patent application Ser. No. 62/491171. Thus, especially if the vehicle already has assignee's wire harness design, incremental cost of adding a camera to the vehicle is limited to the cost of the camera, additional processing power and an insignificant additional wiring cost.

Surround vehicle monitoring, as disclosed regarding FIGS. 21-23 and 30 benefits from illumination. Sunlight provides this illumination in the daytime and flash eye-safe IR or a continuous flood IR can be used in the absence of sunlight. Cameras will then need to be capable of sensing near IR but this is readily achievable. The biggest drawback is the lack of colors and therefore, street view changes which involve color will need to be discovered during daytime. If flash IR is in the eye-safe zone, the intensity can be very high. Additionally, a range gating capability can be added providing the capability of measuring the distance to objects in the image. Distance, of course, can be measured more simply using multiple images as discussed herein.

Surround vehicle monitoring at night can be very useful for locating pedestrians and animals which otherwise might not be observed. Both can then be placed on a temporary map if it is judged that such information would be useful to other passing motorists.

### 17. Vision Based Location

Surround vehicle monitoring can also be used for collision avoidance purposes. Using the principles disclosed herein, the location, orientation and velocity vector of nearby vehicles can be determined and collisions predicted. Once again, flash IR or IR floodlights can be useful at night for those areas not covered by the headlights. Teachings of this invention allow location of other vehicles and objects near the vehicle to be accurately determined using the vector system.

18. Parking Spot Location Based on Probe Vehicles with Cameras

Production vehicles with the system of this invention, while continuously acquiring images of the space around the vehicle, can be programmed to recognize empty parking places and make this information available to the cloud. A municipality, or other governmental or private organization, can make this information available to vehicles which are looking for parking places. A reservation system can be created which assigns such places to roving vehicles significantly reducing city traffic. Studies have shown that more than 30% of city traffic congestion is caused by people looking for parking places. Using the teachings of this invention, a vehicle which is looking for a parking place can be directed to a temporary waiting location and then notified of the location of a parking place when one becomes available.

Referring again to FIG. 10, basic components of a system 40 that can serve as a parking reservation system in accordance with the invention includes the imaging systems 52 on one or more vehicles 54 (only one of which is shown in FIG. 10), the database 56 embodied in one or more memory components (56A, 56B), and the communications system 58 on the vehicle 54 that communicates with communications systems on other vehicles and with the communications system 62 coupled to the server 64 by means of which the parking reservation system 40 is managed.

Database 56 includes map data that includes data about permissible parking spots which may be obtained from various sources known to those skilled in the art to which this invention pertains, e.g., municipal entities or other parking regulation authorities. Permissible parking spot data may be additionally or alternatively derived from processing of images obtained by the imaging systems 52.

The processor 138 at the server 64, which may be single unit or multi-unit assembly of processing units or components, performs the functions described below and includes whatever hardware and software is necessary to effect such functionality, which would be readily ascertainable by those skilled in the art to which this invention pertains. Some of the processing components may be resident on the vehicle 54 while others may be resident at the server 64 situated at a site separate and apart from the vehicle 54, and possibly separate and apart from any vehicles involves in the parking reservation system 40. It is possible though to site the server 64 entirely on one of the vehicles participating the parking reservation system 40 and use its functionality through the communications systems 58 on the vehicles 54. Typically though, each vehicle 54 would include a processor 68 for performing some vehicle-resident functionality needed for the parking reservation system 40, and the respective communications system 58.

To enable use of the parking reservation system 40, each vehicle 54 includes a positioning system 82 arranged at least partly on the vehicle 54, coupled to the processor 68, and which provides its current position, which is considered the current position of the vehicle 54. The current position is used by the vehicle processor 68 and/or can be transmitted to the server 64 by the communications system 58.

The server 64 may be coupled to a parking fee charging system 96 that charges fees for parking based on, for example, location of the parking spot, type of vehicle, and time. Any such system may be used in the invention.

A penalty assessment system 84 is coupled to the server 64 and manages assessment of a penalty for an owner of a vehicle 54 that occupies an assigned available parking spot other than the vehicle to which the available parking spot has been assigned. That is, parking reservation system 40 assigns available parking spots to specific vehicles and if a vehicle other than the one to which the parking spot is assigned occupies the spot before the assigned vehicle arrives at the assigned spot, this vehicle is assessed a penalty by the penalty assessment system 84.

The penalty assessment system 84 includes a data obtaining system 86 that obtains data about the vehicle that occupies the assigned available parking spot. This data obtaining system 86 may include the imaging systems 52 on the vehicles 54, or other sources, such as data input manually using a user interface by personnel monitoring the parking spots and conveyed via communications system 62 coupled to the server 64. A computer program resident in computer-readable medium is executed to cause the processor 138 to access a data registry of information about vehicles via the communications system 62, e.g., as part of the database 56, to identify an owner of the vehicle 54 that occupies the assigned available parking spot other than the vehicle 54 to which the available parking spot has been assigned using the data obtained by the data obtaining system 86. The penalty assessment system 84 then generates and directs a notification via the communications system 62 to the identified owner about an assessed penalty. The notification may cause a visual and/or audible messages, e-mail, mailed letter, debit charge, credit charge, etc. to the owner.

In a similar manner, the communications system 62 is able to communicate with a parking ticket issuance entity 88. In this case, the processor 138 generates and directs a notification to the parking ticket issuance entity 88 using the communications system 62 of unlawful presence of a vehicle occupying the assigned available parking spot other than the vehicle to which the available parking spot has been assigned. This may cause a ticket to be issued by the parking ticket issuance entity 88. The ticket may be delivered to the owner, identified using the data obtaining system 86 in the manner described above for a notification.

FIG. 29 is a flowchart of the manner in which parking reservation system 40 operates. The processor 138 at server 64 executes a software program that is configured to wait for requests for available parking spots from vehicles 54 via the cooperating communications systems 58, 62. Each request is generated by the processor 68 on the vehicle 54 and includes position of each vehicle 54 obtained using the positioning system 82 associated with the vehicle 54. Upon receiving each request (in step 220), the processor 138 logs a time at which each request is received in association with the vehicle identification provided with or in the request (step 222). Prior to, simultaneous with and/or after step 222, the processor 138 accesses the map database 56 obtained in any of the ways described herein or incorporated by reference herein, and identifies position of an available parking spot (step 224). It is also possible for the processor 138 to identify available parking spots before a request is made so that it can store the position of available parking spots. Depiction of step 224 following step 222 is thus for illustration only and does not limit the order of the method steps.

Identifying available parking spots may entail analyzing images obtained by the imaging systems 52 in the vehicles 54 participating in the parking reservation system 40 to ascertain whether there are parking spots in any of the obtained images that are not occupied and thus available. This may be achieved by determining when in an image, a vehicle is not present in one of the permissible parking spots, which are identified in the map database 94 or derivable therefrom.

When one of the permissible parking spots is identified by the processor 138 as being available in step 224 and only one vehicle 54 has sent a request as determined in step 226, that vehicle 54 may be assigned the parking spot irrespective of the distance between the current position of the vehicle 54 and the parking spot, step 228.

However, when multiple vehicles 54 provided requests for available parking spots to the server 64 as determined in step 226 and they have been logged in by the processor 138 (stored in a memory component available to the processor 138), the processor 138 then accesses the map database 56 and determines a travel path of each parking spot-requesting vehicle 54 from a current position of each such vehicle 54 to the available parking spot, step 230. Prior to, simultaneous with and/or after step 230, the processor 138 determines a time that each of the vehicles providing a request is waiting for assignment of an available parking spot, step 232. Depiction of step 232 following step 230 is for illustration only and does not limit the order of the method steps.

With this information, the processor 138 assigns the available parking spot to one of the vehicles providing a request based on both the determined travel paths of each of the vehicles to the available parking spot and the determined time that each of the vehicles is waiting for an assignment of an available parking spot, step 234. Thereafter, the processor 138 generates and sends via the communications systems 58, 62, a notification to the vehicle 54 providing the request to which the available parking spot has been assigned of its assigned available parking spot, step 236.

The notification sent to the vehicle providing the request to which the available parking spot has been assigned may be displayed on a display in the vehicle, may cause activation of a vehicle guidance system to cause the vehicle to be automatically guided to the assigned available parking spot, and/or may cause activation of a vehicle guidance system to cause audible and/or visual directions to be provided to guide a driver of the vehicle to the assigned available parking spot.

Optionally, in step 238, the processor 138 monitors for reception via the communications systems 58, 62 of a confirmation or acknowledgement from the vehicle providing the request to which the available parking spot has been assigned of its assignment of the available parking spot. The acknowledgement is generated by the processor 68 on the vehicle 54 in response to reception of the assignment of the available parking spot and contains an intent to occupy the available parking spot. The occupant of the vehicle 54 can intentionally not direct a confirmation. If an acknowledgement is not received within a set period of time, e.g., 30 second or 60 seconds, the processor 138 may be configured to re-assign that parking spot to another vehicle 54.

Alternatively, evidence of an indication that the vehicle 54 does not want the available parking spot may be effected by a “decline” or reject transmission that is initiated by the occupant of the vehicle 54 using a user interface, and sent by the processor 68 of the vehicle 54 to the processor 138 through the communications systems 58, 62. This would cause assignment of the available parking spot to another vehicle in the manner described above, proceeding to step 230 and considering the remaining vehicle.

Processor 138 considers an available parking spot to be occupied once acknowledgement has been received via the communications systems 58, 62 and before the available parking spot has been occupied, step 240. Processor 138 would refrain from assigning another vehicle to that available parking spot even though not yet occupied.

Another optional feature after processor 138 receives requests for available parking spots is for the processor 138 to store the location of designated pre-positioning areas and then, if a parking spot is not available, generate and direct an instructional message in step 242 to the vehicle providing the request to move to a designated area to pre-position for an identified soon-to-be available parking spot. Once a parking spot is available in step 224, the processor 138 assigns the available parking spot to one of the vehicles 54, which may be in a pre-positioning area or not, and generates and sends via the communications systems 58, 62, a notification to a vehicle 54 of its assigned available parking spot, steps 226-236.

Other methods for managing parking spots are also possible and considered to be part of the invention provided they include one or more of the aspects described above, either the basic method or the optional enhancements.

It is also possible to factor in the destination of the occupants of the vehicle in the method to potentially minimize walking of the occupants between the assigned parking spot and their destination. Thus, the request for a parking spot would also include the destination and the processor 138 would consider the current position of the vehicle, the waiting time and the destination of the occupant when determining assignment of a parking spot.

A significant advantage of the inventive system is that, in contrast to many other systems such as IBM's smart city solution, no additional infrastructure is required. In the IBM system, magnetic sensors are installed and maintained in the pavement beneath the parking space and a remote reader must be installed which communicates to the city administration of the status of the parking space. One estimated cost for the installation only of sensors in parking spaces is $1,400 per space. The inventive parking spot location system becomes instantly available once the mapping system is installed on a production vehicle and it can cover all parking spaces at no cost to the city.

An additional feature is that parking meters and the associated administration can be eliminated. Since the system will know that the vehicle has parked in a designated space and for how long, the vehicle can be billed automatically as with road tolling. Again, vastly simplifying the parking space allocation and charging system. Even the confusing parking regulation signs can be removed and the vehicle operator will not be assigned a spot that is reserved for local residents, doctors etc. The enforcement of parking laws also becomes automatic, removing that cost from local governments. Parking in no parking zones can result in instant fines after an unheeded warning eliminating that hazard. Parking space pricing can become demand pricing which depends on the time of day and the demand for parking spots. This will result in a fairer distribution of parking facilities and greater revenue for the city.

The images acquired by the vehicle can also accurately measure the size of an available parking space and make that information available to the parking spot searching vehicle so that the fit can be determined prior to assigning the spot to the vehicle.

### 19. Street View

Google Street View provides a service which allows a user to view an image of the street at a location, including structures which are adjacent to the street, on the Internet. A user, for example, can see what a site looks like without having to travel to the site. These street views are obtained using special vehicles which travel the country taking pictures in all directions around the special vehicle. However, since Google has a limited number of such vehicles, a site may not be updated for months or even years and, in the interim, it can change substantially. Many commercial establishments may no longer occupy a given site, new roads may have been installed or altered, or a building may have been torn down or altered exteriorly since the last photographs were acquired. The probe mapping vehicles and production vehicles of this invention can eliminate this latency by providing updates when the site has changed. This can be done automatically and at little cost once the system is in place.

FIG. 30 illustrates an implementation wherein three cameras 190,192,194, each with a 120° FOV, are housed in a glass housing. All three cameras and the IMU are rigidly attached to the base of the assembly which is leveled and attached to a surface 154 of the vehicle roof 155. Other components of the system are as described with respect to FIGS. 21-23.

FIG. 31 illustrates an embodiment like FIGS. 21-23 and 30 wherein a system is integrated into a production vehicle with three camera assemblies, 190, 156, 157, incorporated into the vehicle roof such that a small portion of the FOV of each camera overlaps with at least one other camera as well as observing a common area of the vehicle roof for registration purposes. Since any two cameras see the same portion of the roof, they can be registered with each other and the position and angle of each pixel of each camera can be determined accurately from the IMU. Other registration methods are described below.

Since the three cameras are aligned, leveled and registered with the IMU and each other, they combine to form a very accurate near 360° surround view of the vehicle environment (“surround-vehicle monitoring”). For mapping purposes, many more images can now be available of landmarks as they are passed by the vehicle providing many more position estimates which significantly improves the landmark location accuracy. For street view purposes, images of surrounding structures can be captured and compared with the existing street view database and when changes are detected, new images can be uploaded to the cloud resident map.

A preferred implementation for street view purposes is illustrated in FIGS. 26-28. These implementations provide for accurate registration of the cameras with respect to the IMU and other cameras so that position information of landmarks and other objects in the images will be considerably more accurate than when using the FIG. 31 implementation.

Using views from side viewing cameras, details of sites can be obtained to permit, for example, automatic guiding of an autonomous vehicle up a driveway and to the front door of a destination. Another application allows the recording of available street parking spots which can be uploaded and made a part of the map for people looking for a place to park.

Normally, the headlights may not provide sufficient illumination for street view observations when using this information to guide a vehicle up a driveway, for example, during nighttime driving and an additional aid, e.g. near IR floodlights such as 180 in FIGS. 21-23, can be provided. In this case, the camera assemblies are sensitive to near IR frequencies.

A system that enables viewing of images of physical premises obtained by a vehicle (probe vehicles or mapping vehicles disclosed herein) will be described primarily with reference to FIG. 10. The system includes the positioning system 82 arranged at least partly on the vehicle 54 (it may require use of satellites in orbit and thus is only partly on the vehicle 54) and that provides position of the vehicle 54, and one or more of the imaging systems 52 on the vehicle 54 that obtain images, in this case, they are positioned and oriented to obtained images of physical premises. The position and pointing direction of each imaging system 52 relative to the vehicle 54 is known. The memory components 56A, 56B contain, for this embodiment, a database of images of the physical premises. The processing system (one or both of processors 138, 68) are coupled to each imaging system 52 and the positioning system 82.

Multiple functions are performed by the processing system, including, associating position of each imaging system 52 when each image was obtained by the imaging system 52 to that image (tagging each image with position of the imaging system when it was taken), identifying at least one point on each object in any image obtained by any imaging system 52, identifying a plurality of images obtained by one or more of the imaging systems 52 that contain the same object and have different associated positions, and determining the position of each identified point on each object based on the known position and pointing direction of the imaging systems 52 when each of the images used to determine the position of each identified point was obtained by the imaging systems 52. The processing system also manages the database 56 to include data about each object including an identification of each object and the determined position of at least one point on the object, and the images including the object.

The server 64 coupled to the database 56 controls access to the database 56 to enable retrieval of images from the database 56. The server 64 is configured to provide at least one image including an object upon entering the identification of that object or a physical location associated with that object.

As to more specifics about how the processing system determines the position of each identified point on each object, it may perform this function by determining a virtual vector from the imaging system 52 to that point in at least two images identified to contain that object based on the position and pointing direction of the imaging systems 52 when each image was obtained by the respective imaging system 52. Optionally, the processing system identifies multiple points on each object in any image obtained by one of the imaging systems and then determines the position of each identified points on that object. The database 56 is managed to store a relationship between the points on the same object to enable presentation of each image retrieved from the database 56 via the server 64 in accordance with the stored relationship.

In one embodiment, the processing system identifies a single point on each object in any image obtained by one of the imaging systems and determines the position of the single identified point on each object. The processing system then identifies pixels of any object in at least two images, quantifies changes in position of the same pixels of the object in the two images, and stores the quantified changes to enable presentation of the image retrieved from the database 56 via the server 64 in accordance with the quantified changes.

In light of the disclosure about camera assemblies in FIG. 30, the imaging system 52 may include at least three cameras or camera assemblies, e.g., camera assemblies 190, 192, 194, that obtain images of the physical premises and which have, in combination, a 360° view of an environment around the vehicle 54. Any of the alternative camera assemblies or imaging system disclosed above that achieve this 360° coverage may be used in this embodiment. The vehicle 54 may be limited to only three cameras assemblies 190, 192, 194, but which are positioned to have a non-overlapping imaging field to thereby provide the 360° view of the environment around the vehicle 54.

An inertial measurement unit (IMU) 106 may be arranged on the vehicle 54 and coupled to the processing system (see FIG. 10). The IMU 106 obtains angular velocity and linear acceleration data about the vehicle 54, in a known manner. Each imaging system 52 is preferably registered with the IMU 106 such that a position and pointing direction of the imaging system 52 can be determined by the IMU 106 (as would be readily achievable by those skilled in the art to which this invention pertains).

For example, it is possible that one camera is registered with the IMU 106 so that a pointing direction of every pixel in images obtained by the first cameras is known, with remaining cameras being registered with the first camera by forcing overlapped images to coincide by rotating the images and noting the location of the pixels containing common images or parts thereof so that a pointing direction of every pixel in images obtained by the remaining cameras is known. Also, the cameras may be housed in a common housing on the vehicle, each having a transparent covering over imaging portions of the cameras, with the cameras preferably being arranged on a common, leveled base. The housing itself may have a transparent glass portion over the imaging portions of the cameras. The cameras and transparent portion may be part of a overall camera assembly that is attached to a surface of a roof of the vehicle.

As described with respect to FIG. 10, the processing system may have a part arranged on the vehicle 54 (part 68) and a part arranged at a remote site separate and apart from the vehicle 54 (part 138 at the server 64). The vehicle-resident part 68 may be assigned to perform the steps of associating position of the imaging system 52 to that image, identifying an anchor point on each object in any obtained image, identifying images that contain the same objects and have different associated positions, and determining the position of each object. The server-resident part 68 may be assigned to manage the database to include the data about each object. The vehicle-resident communications system 58 directs data about each object to the server 64 to be received via the server-resident communications system 62.

The foregoing structure may be used in a method for viewing physical premises. In this method, a database of images of physical premises is generated using a plurality of probe or mapping vehicles 54 as described above, and the database is stored on at least one memory component at a server, e.g., memory components 56B at server 64. A searchable index of the physical premises based on identification criteria is generated using a processing system, the index including such features as address, street name, street number, city, town, village, etc. Access by a computing device to the server and to the searchable index is enabled, e.g., via a local area network, telecommunications network or the like, to enable entry of one or more identification criteria to cause retrieval of at least one image of the physical premises associated with the entered identification criteria. The retrieved image(s) of the physical premises from the server are directed to the computing device, and at the computing device, the processor thereof causes display of the retrieved image(s) of the physical premises. As such, the method provides a way to view physical premises by entering search terms causing display of physical structure associated with the search terms. The display of the computing device is controlled to provide for the desired display of the image(s) of the physical premises.

The database of images of physical premises is generated using the apparatus disclosed above. Thus, images of the physical premises are obtained using an imaging system 52 on each vehicle 54, a position and pointing direction of the imaging system 52 relative to the vehicle 54 being known. Position of the imaging system 52 when each image was obtained by the imaging system 52 is associated with or to that image. One or more points on each object in any image obtained by the imaging system 52 are identified. Multiple images that contain the same object and have different associated positions are identified using a processing system. Position of each identified point on each object is determined based on the known position and pointing direction of the imaging system when each image being used to determine the position of each identified point was obtained by the imaging system 52.

Data about each object including an identification of each object and the determined position of at least one point on the object is included in the database, along with images of the objects. The images of the physical premises are also stored in the database with an indication of the position of the physical premises. There is thus a link between object position and the images of the physical premises.

The invention therefore uses points on objects in images, including points on objects of physical premises such as houses and buildings, to later enable retrieval of images of the physical premises. The object points are used for positioning purposes, i.e., to determine correspondence between images and geographical location, so that by entering geographical location, the correct images viewable at the desired location are retrieved from the database.

Enhancements to the method include determining the position of each identified point on each object by determining a virtual vector from the imaging system 52 to that point in at least two images identified to contain that object based on the position and pointing direction of the imaging system 52 when each image was obtained by the imaging system 52.

Also, the database may be generated by identifying points on each object in any image obtained by the imaging system and then determining the position of each identified points on that object. In this case, the database includes a relationship between the points on the same object to enable presentation of each image retrieved from the database via the server in accordance with the stored relationship. Additionally or alternatively, the database may be generated by identifying a single point on each object in any image obtained by the imaging system 52 and determining the position of the single identified point on each object. Additionally or alternatively, the database may be generated by identifying pixels of any object in the images, quantifying changes in position of the same pixels of the object in the images, and storing the quantified changes to enable presentation of images retrieved from the database via the server in accordance with the quantified changes.

Other aspects of the system described above may be applied in the method, for example, enabling operative communications between vehicle-resident and server-resident parts of the processing system using wireless communications systems. The position of the imaging system when each image was obtained by the imaging system may be associated to that image by obtaining angular velocity and linear acceleration data about the vehicle from an inertial measurement unit (IMU) arranged on the vehicle, and registering the imaging system with the IMU such that a position and pointing direction of the imaging system are determined based on data from the IMU

Relevant prior art U.S. patents include: U.S. Pat. Nos. 7,813,596, 7,577,316, 7,805,025, 6,895,126, 7,239,760, and 8,213,749. Features disclosed in these patents can be applied in the invention.

### 20. Radar Plus Map-Radar Imaging

An article “Detection without reflection” published in the ITS International January February 2016 issue includes an image with three parts, a camera (left) along with 77 gHz radar (center) and low-resolution radar (right) images. Several elements of the buildings (edges) and trees can be seen in the camera and the 77 gHz radar image. If these landmarks are identified on the vehicle resident map, they can be located on the radar image. If several such landmarks are identified, an accurate estimate of vehicle position can be made. Thus, using radar imaging, which can penetrate rain, snow and fog, an accurate estimate of the vehicle position can be made even in inclement weather based on multiple such radar images using the invention.

The process can involve finding landmarks in the radar image which are also identified on the map. Points representing anchor points from the map database are placed on the radar image and adjusted to obtain the best fit to the radar image. Alternate methods such as using the principles disclosed in U.S. Pat. No. 7,110,184 and/or US 20160124087 can make use of the entire landmark profile if it is available from a database. Taking the best fit as the actual positions of the landmarks permits calculation of IMU errors. The distance determination available using radar imaging can be neglected, however, this range data can be useful particularly when the radar images are blurred. In this case, approximate distance to the landmark can be used to range gate the landmark, and particularly the anchor point, and thereby remove extraneous data and render the location determination of the anchor point easier. The fact that only the position of a few points needs to be determined vastly simplifies the radar image processing described in US20160124087.

An additional technique which can be used to image landmarks in a manner like the radar method mentioned above but using laser light, is disclosed in U.S. Pat. No. 7,733,464. Unless this system is restricted to using particular IR wavelengths where atmospheric absorption by water in a minimum, which is not mentioned, there is little advantage to this system over straight continuous IR illumination. Continuous IR illumination at the minimum water absorption bands maximizes transmission through fog, snow and rain and permit some enhanced visibility in bad weather. Some of these bands are around 0.85 and 1.2 microns.

### 21. Accurate Map Generation

As discussed above, the mapping system of this invention is based on knowing the position and pointing direction of one or more cameras with great accuracy. This is accomplished using RTK corrections to the position calculated based on the reception of satellite transmissions. RTK corrections become available when one or more RTK stations are near the vehicle and can be transmitted to the vehicle by several methods.

If a single RTK station is positioned within about 30 km of the vehicle, then the vehicle can obtain the satellite corrections directly from that RTK station. It can apply those corrections to the satellite data which it is receiving and determine its position to an accuracy which depends on the variation in the atmospheric refraction between the vehicle location and the RTK location. Furthermore, the vehicle can more precisely determine its location relative to the RTK station by comparing the phase of satellite carrier waves as received by the vehicle from one or more satellites and as received at the RTK station. This method requires line of sight communication between the vehicle and the RTK station for the highest accuracy. Typically, this method requires the placement of RTK stations approximately every 30 km and in areas where obstructions and multipath problems are minimal.

Since this requires the placement of many RTK stations, each of which could require from 1 to 24 hours to stabilize, another approach is to deploy a two dimensional array of RTK stations with a spacing of typically 80 to 100 km. If these stations form a grid then a vehicle can communicate with several such stations and interpolate the corrections from each of the nearby RTK stations. This significantly reduces the number of RTK stations needed to cover an area to be mapped. Typically, where this approach is installed, the corrections are communicated to the vehicle using the Internet and a cell phone connection from the vehicle to the Internet. Typically, this introduces a two second or greater delay in the vehicle receiving the latest corrections. In some cases, this delay can grow to five or more seconds. Each RTK station has a position error of approximately 1 cm. If a vehicle communicates directly with the RTK stations then little additional error should occur in the vehicle location. However, a 2 to 5 second delay in receiving corrections can significantly increase the vehicle position error.

Each of the above techniques requires that the vehicle maintain a lock on the satellites such that various errors have been eliminated and the vehicle can make a calculation of its position based on the satellite data. The corrections are used to correct errors in the satellite data caused by refraction through the atmosphere. If the vehicle passes under a bridge, for example, and loses the connection to the satellites, then position errors of the vehicle can quickly grow to decimeters or more. See Stephenson, S., et al., “Network RTK for Intelligent Vehicles: Accurate, Reliable, Available, Continuous Positioning for Cooperative Driving”. GPS World, 2013. 24. The vehicle must then rely on its IMU to maintain position accuracy. However, typical IMUs considered for vehicles drift rapidly and cannot maintain centimeter level accuracies for as much as one second. Until IMUs improve significantly, another technique is therefore desired to maintain vehicle location accuracies in the 1 to 2 cm range. One such technique will now be described.

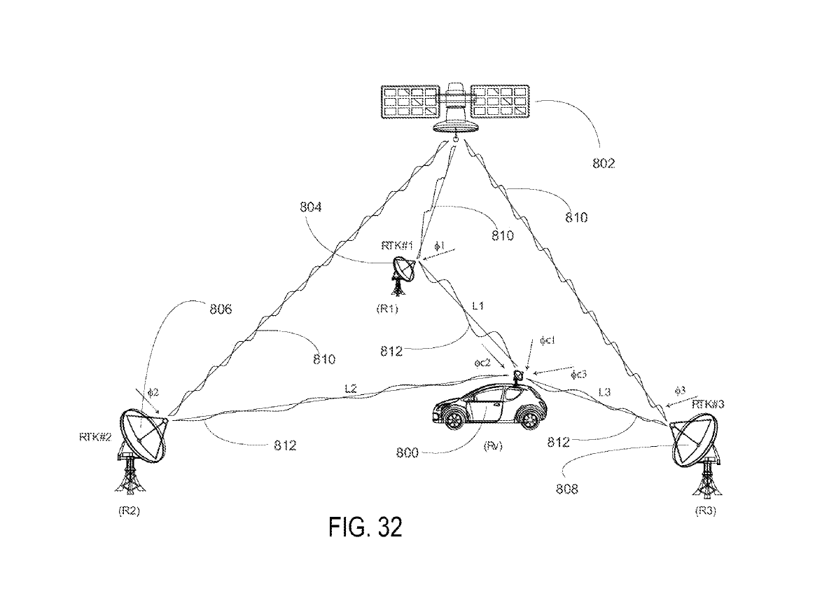

FIG. 32 illustrates a method of using a carrier wave from a common satellite and relaying it to a mapping vehicle from three or more RTK stations to provide a location method which does not require the vehicle to communicate with the GNSS satellites. Satellite 802 broadcasts a carrier wave 810 which is received by RTK stations 804, 806, and 808. Each of these RTK stations relays the carrier wave 812 to a vehicle 800.

If the vehicle can communicate with three RTK stations, then each station could relay a carrier frequency from a satellite which is easily observed by the vehicle and the three RTK stations. At the moment of satellite loss, such as caused by passing under a bridge, for example, the vehicle uses phase of the retransmitted carrier waves from the chosen satellite by the three RTK stations. By comparing phases of these three received signals, the vehicle can accurately determine its position relative to the three RTK stations. Since the RTK station positions are known, the vehicle's position will also be known. Phase calculation must consider relative phase differences of the chosen carrier signal as received by each RTK station. Also, since satellites will be coming into and leaving the viewing area, more than one such satellite can be chosen for this exercise. Since the vehicle will know its position just prior to the loss of satellite lock, this method will permit the vehicle to maintain its position information until the satellites are re-acquired. This system will also be useful to solve problems of urban canyons providing the carrier signals from the RTK stations are not blocked or refracted by intervening structures. It may be desirable to choose frequencies for the re-transformation of the carrier signals to provide a minimum refraction path to the vehicle from the RTK station.

Referring to FIGS. 32:
φ1, φ2, φ3—phases of carrier wave received from satellite by antennas of RTK#1, RTK#2, RTK#3 stations;
φv1, φv2, φv3 —phases of carrier wave received from satellite and relayed (retransmitted) by RTK#1, RTK#2, RTK#3 station to the antenna of the car;
L1, L2, L3—distances between the car and antenna of respective RTK station;
Rv—coordinates of the car;
R1, R2, R3—coordinates of the respective RTK station.

The RTK stations RTK#1, RTK#2 and RTK#3 retransmit the carrier oscillation received from the satellites to the antenna of the car.

Distances L1, i=1−3 between the car and each RTK station are measured using phase difference between phases of carried oscillation received by the antenna of the carφvi and the antenna of the respective RTK station.

Car coordinates Rv are calculated by solving the geometrical problem

Rv=f(Ri, Li(φvi−φi), i=1−3),

using three distances Li, i=1−3 and known coordinates of the RTK stations Ri, i=1−3:

considerations relative to the disclosed method are as follows.

Basically, this method allows the vehicle to accurately determine its position by two separate methods, using satellites plus RTK corrections and the carrier phase technique as illustrated in FIG. 32. The carrier phase method may from time to time have errors arising from obstructions in the paths of the signals from the RTK stations. These errors can be continuously corrected when both methods are operational. When there is a temporary loss of satellite signals, such as the tunnel, the first method will not be operational and the vehicle will need to rely on the carrier phase method. The carrier phase errors are unlikely to change during this period until satellite lock is reacquired, so the vehicle will always have at least one method of accurately determining its position and is thus not be dependent on the IMU drift.

A similar solution to the carrier phase retransmission technique discussed above, is to convert the RTK stations into pseudolites where they act like satellites with fewer refraction problems.

### 22. Line Mapping

The discussion of landmark mapping above has assumed that once a landmark is recognized, a reference or anchor point on that landmark can be readily defined. This is relatively easy for the case of street signs or other poll type landmarks. Other landmarks such as painted lane divider lines, walls or curbs do not allow the easy definition of a specific point. A point marking the beginning of a lane divider line can be easily identified. No such other generally observable point exists until the line crosses another line or ends. A map will be created of such an area based on landmarks which do have anchor points. A horizontal line can be drawn between two such landmarks and the position of the lane divider line can be referenced to this horizontal line. Distance from the edge or center of the lane divider line to the horizontal line starting at a landmark can be calculated. Thereafter, as long as the lane divider line is continuous, the distance can be calculated at intervals such as every 10 m thereby defining the line relative to the landmark derived horizontal line. This technique can also be used for mapping guardrails, walls, curbs, road edges, and any other landmark which extends parallel to the roadway. This technique is only required for landmarks which extend parallel to the road. Lines which are perpendicular to the road direction can be easily mapped as described elsewhere.

### 23. Determining Vehicle Location Without Satellite Navigation Systems

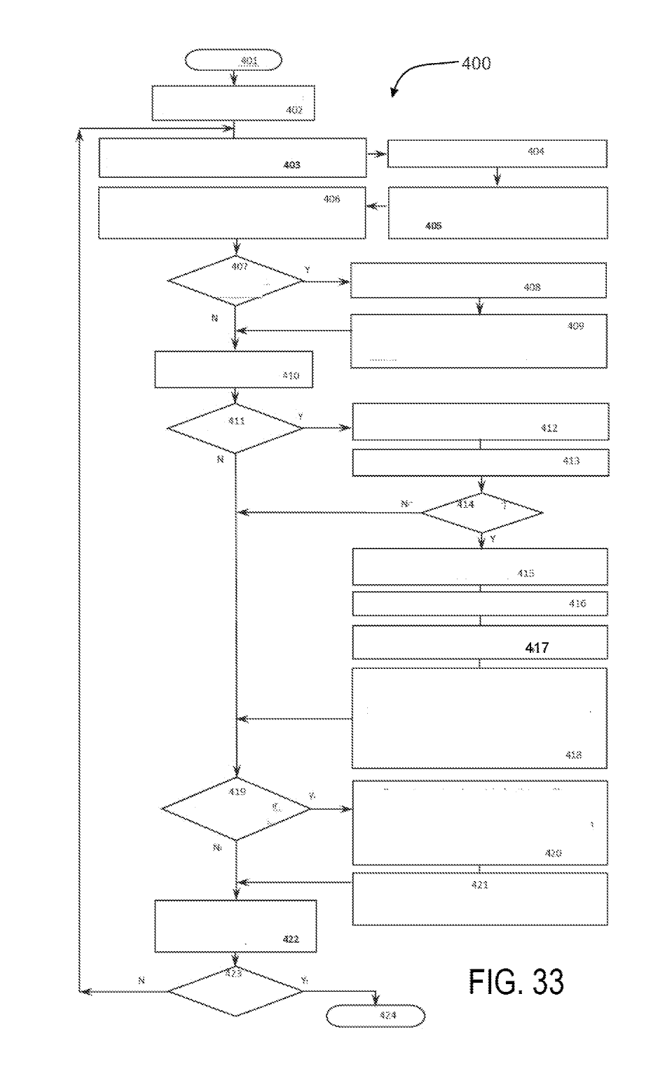

FIG. 33 is a flowchart showing a technique for correcting IMU errors using photogrammetry to eliminate the need for the GNSS satellites, thereby allowing a vehicle to locate itself using landmarks and a map. The flowchart is shown generally at 400. Each of the steps is listed below.

Step 401 is to begin.

Step 402 is the step of setting initial data, including the Kalman filter's parameters.

Step 403 is the step of reading IMU-data (detecting) with frequency 100 Hz: acceleration \vec{A}, angular speed \vec{ω}.

Step 404 is the step of error compensation for the IMU.

Step 405 is the step of calculation of current longitude λ, latitude ϕ, altitude h, Roll, Pitch, Yaw, and linear speed \vec{V}_{GNSS}.

Step 406 is the step of reading GNSS-data with GNSS or RTK correction (if available), detected with frequency 1, . . . , 10 Hz: longitude λGNSS, latitude ϕGNSS, altitude hGNSS, linear speed \vec{V}_{GNSS}.

Step 407 is the step of a query as to whether there is new reliable GNSS-data available.

If so, step 408 is bringing the GNSS and IMU measurements to common time (synchronization), and step 409 is calculation of the first observation vector: \vec{Y}₁=[λ−λ_{GNSS}))Rₑ·cos (ϕ_{GNSS}); (ϕ−ϕ_{GNSS})Rₑ; h−h_{GNSS}; \vec{V}−\vec{V}_{GNSS}] where Re=6371116 m is the average Earth radius.

Thereafter, or when there is no new reliable GNSS-data available in step 407, step 410 is taking an image (if available) with frequency 1, . . . , 30 Hz.

Step 411 is the step of a query as to whether a new image is available.

If so, step 412 is to preload information about landmarks, previously recognized at current area, from the map, step 413 is identification of known landmarks Nj, j=1, . . . , M, and step

414 is the step of a query as to whether one or more landmark(s) is/are recognized.

If so, step 415 is the step of retrieving coordinates λⱼ, ϕⱼ, hⱼ, of the j-th landmark from the map (database), step 416 is calculating local angles \textcircled{˜}ⱼand vⱼ of the landmark, step 417 is bringing the IMU measurements to time of the still image (synchronization), and step 418 is calculation of the second observation vector: \vec{Y}₂=[\vec{Y′}₁; . . . ; \vec{Y′}ⱼ; . . . ; \vec{Y′}_{m′}], j=1, . . . , M′; where M′ is a number of recognized landmarks (M′≤M), \vec{Y′}ⱼ=[λ−λⱼ)Rₑ·cos(ϕ); (ϕ−ϕⱼ)Rₑ; h−hⱼ)]−rⱼ·\vec{R}·\vec{F}ⱼ, rⱼ=[{(λ−λⱼ)Rₑ}·cos(ϕⱼ)²+{(ϕ−ϕⱼ)Rₑ}²+{h−hⱼ}²]^{1/2}, \vec{R} and \vec{F}ⱼ are calculated as in algorithm 1B.

Then, in step 419, a query is made as to whether there is new data for error compensation. If so, step 420 is recursive estimation with the Kalman filter: \hat{\vec{X}}=\vec{K}·[\vec{Y}₁, \vec{Y}₂], \hat{\vec{X}}=[Δλ, Δϕ, Δh, \vec{ΔV}, \vec{ΔΨ}, \vec{ΔB}], \vec{ΔΨ}=[ΔRoll, ΔPitch, ΔYaw] is a vector of orientation angle errors, \vec{ΔB} is a vector of IMU errors, \vec{K} is a matrix of gain coefficients, and step 421 is error compensation for longitude λ, latitude ϕ, altitude h, Roll, Pitch, Yaw, and linear speed \vec{V}.

Thereafter, or when there is no new data for error compensation in step 419, step 422 is the step of outputting parameters: longitude λ, latitude ϕ, altitude h, Roll, Pitch, Yaw, and linear speed \vec{V}.

In step 423, a query is made as to whether to terminate operation, and if so, step 424 is the end. If not, the process returns to step 403.

An important aspect of this technique is since much of the infrastructure is invariant and once it is accurately mapped, a vehicle with one or more mounted cameras can accurately determine its position without the aid of satellite navigation systems.

Initially, a map will be created basically by identifying objects in the environment near a road and, through a picture taking technique described herein, determining the location of each of these objects using photogrammetry as described in WO2016/099443 and U.S. Pat. No. 9,528,834. The map can then be used by an at least a partly vehicle-resident route guidance system to permit the vehicle to navigate from one point to another or provide navigation guidance to a driver from one point to another.

Using this photogrammetry technique, a vehicle can be autonomously driven such that it does not impact with any fixed objects on or near the roadway. Since this technique will generate maps which are accurate to within a few centimeters, it will likely be more accurate than any existing maps and thus be appropriate for autonomous vehicle guidance even when visibility is poor. Location of the vehicle during the map creation phase will be determined by GNSS satellites and a differential correction system. If RTK differential GNSS is available, then the vehicle location accuracy can be expected to be within a few centimeters. If wide area differential GNSS is used, then the accuracy is on the order of decimeters.

In many underdeveloped or developing countries, neither RTK nor wide area differential GNSS is available. Furthermore, signals from GNSS satellites are very weak and can be jammed or distorted by local area phenomena which are not reflected in the differential corrections. For example, in cities, multipath can be a significant issue.

Even in developed countries, GNSS signals are sometimes not available due to multipath or buildings or a tunnel blocking the signals. A substitute for GNSS navigation is thus needed and in fact, the U.S. Government has recently approached the industry with a request for proposal to develop a substitute system for GPS. The map database management system is such a system and once the map is implemented, it is likely to solve these GNSS-related problems.

Once the map is created by the map creation management system, a processing unit in the vehicle will have the option of determining its location, which is considered the location of the vehicle, based on the landmarks represented in the map database. This is also known as localization. The method by which this can be done is described below. Exemplifying, but non-limiting and non-exclusive steps for such a process can be:
1. Take a picture of the environment around the vehicle.
2. From a vehicle-resident map database, determine one or more identified landmarks which should be in the picture and their expected pixel locations.
3. Locate the pixel of the anchor point of each identified landmark as seen in picture (Note that some landmarks may be blocked by other vehicles).
4. Determine the IMU coordinates and pointing direction of each vehicle camera assembly from which the picture was obtained.
5. For each landmark, compose an equation containing the errors as unknowns of each IMU coordinate (3 displacements and 3 angles) which will correct the IMU coordinates so that the map pixel will coincide with the picture pixel for the anchor point.
6. Use more equations than the 6 IMU error unknowns, for example using 10 landmarks.
7. Solve for the error unknowns using the Simplex or other method to get the best estimate of the errors in each coordinate and (if possible) an indication of which landmarks have the most inaccurate map locations.
8. When the anchor point pixels coincide based on the new corrections, correct the IMU with the new error estimates. This is similar to correcting using GNSS signals with DGNSS or RTK corrections.
9. Record the new coordinates of the landmarks which are most likely to be the least accurate which can be used to correct the map and upload these to the remote site. This process can be further explained from the following considerations:
1. Since there will be two equations for every landmark, one for the vertical pixel displacement in the image and one for the lateral pixel displacement, only 3 landmarks, or three images on one landmark or a combination thereof, are needed to solve for the IMU errors.
2. If we use 4 landmarks (4(n) objects taken 3(r) at a time) we get (n!/(n−r)!*r!)=4 estimates for the IMU errors and using 10 gives 120 estimates.
3. Since there can be many sets of IMU error estimates for a few landmarks, the problem is to decide which set to use. It is beyond to scope of this description but the techniques are known to those skilled in the art. Once a choice is made, a judgment as to the map position accuracy of the landmarks can be made and the new pictures can be used to correct the map errors. This will guide selection of pictures to upload for future map corrections.
4. Error formulas could be in the form ex*vx+ey*vy+ez*vz+ep*vp+er*vr+ew*vw=dx where
   1. ex=the unknown IMU error in the longitudinal direction
   2. ey=the unknown IMU error in the vertical direction
   3. ez=the unknown IMU error in the lateral direction
   4. ep=the unknown IMU error in the pitch angle
   5. er=the unknown IMU error in the roll angle
   6. ew=the unknown IMU error in the yaw angle
   7. vx etc=the derivatives of the various coordinates and angles with respect to the x pixel location
   8. dx=the difference in the map and picture landmark lateral pixel location (this will be a function of the pixel angles)2
   9. There is a similar equation for dy.

Using the above process, a processing unit on a vehicle, in the presence of or knowledge about mapped landmarks, can rapidly determine its position and correct the errors in its IMU without the use of GNSS satellites, and accurately determine its position and orientation. Once a map is in place, the vehicle is immune to satellite spoofing, jamming, or even the destruction of satellites as might occur in wartime. In fact, only a single mapped landmark is required, provided at least three images are made of the landmark from three different locations. If three landmarks are available in an image, then only a single image is required for the vehicle to correct its IMU. The more landmarks in a picture and the more pictures of landmarks results in a better estimation of the IMU errors.

To utilize this method of vehicle location and IMU error correction, the landmarks must, of course, be visible to the vehicle camera assemblies. Normally, the headlights may not provide sufficient illumination for nighttime driving and an additional aid, e.g. near IR floodlights such as 180 in FIGS. 21-23, can be provided. In this case, the camera assemblies should be sensitive to near IR frequencies. The more of the spectrum that the camera can image, the more information that can be obtained from the environment to aid the mapping process.

Another camera-related issue is the field of view discussed above. Repeating, the preferred camera has a FOV of 120° which is believed to be the largest FOV without significant distortions at the edges. As the FOV increases, the number of pixels that are used to represent a degree tends to decrease depending on the lens design. Carefully made lenses can partially correct for this, but this becomes more difficult when the FOV exceeds 120°. It is important to note that cameras with this large a FOV have not been known to have been used on production vehicles. As discussed above, cameras with smaller FOVs can be used and coupled together to cover the desired 120 degrees but this presents registration concerns. If two cameras are used, for example, each must be registered to the IMU which means that they must be accurately registered to each other adding another step to the manufacturing process. The technique of matching images of a portion of the FOV, as discussed above, can also be used but that will add errors to the registration process. If the total FOV is to be extended beyond 120 degrees, for the purpose of obtaining accurate street view images, these errors will multiply. A preferred approach here, therefore, is to use a 120° FOV camera and to gradually increase the number of available pixels as imager technology improves over time.

Techniques described above are a form of stereo imaging where multiple images are acquired using one camera rather than two attached cameras or imagers. Position accuracy is greatly increased over conventional stereo imaging since the distance between the two images is greatly increased in comparison with a stereo camera. Registration of the images is accomplished through accurately knowing the location and orientation of the camera for each image. Although this is discussed for mapping, it is of course applicable for other purposes such as collision avoidance by monitoring nearby vehicles and determining their velocity vectors, locating pedestrians, animals etc. As discussed above, this can be easily expanded to surround-vehicle monitoring through the addition of additional cameras allowing the accurate location of all objects around the vehicle in a much more accurate and less expensive manner than can be achieved through expensive rotating lidar systems now in experimental use.

### 24. Software

Software to be used in practicing this invention conforms to automotive and GIS standards and is written knowing that human lives rely on the accuracy and errorless functioning of the system. Such standards are known to those skilled in the art and thus will not be repeated here. As disclosed above, the location of the image processing can be primarily in the cloud, on the vehicle or, in most cases, a combination thereof. During the initial map creation, full compressed images can be transmitted to the cloud and the processing needed for the initial map creation can take place in the cloud. This database of images is thus available as new landmarks are identified for inclusion into the database. It is expected that as the number of vehicles with the system increases, or the mapping distances traveled by such vehicles increases, such total image transmission to the cloud will become unwieldy and more of the processing will occur on the vehicle. This will be aided by the increased processing power expected to be vehicle resident such as the GPU systems now being developed by Nvidia. Deep learning systems now exist that can identify most if not all known objects in an image.

These systems can be modified so that they identify most if not all landmarks that exist in any image taken by a vehicle of a roadway and the surrounding space. During the stage of development and implementation of the system which uses landmarks to locate the vehicle replacing GNSS satellite systems, the deep learning systems on the vehicle will need to have the capability of recognizing landmarks which are on the vehicle-resident map. Also, for the continuous map updating feature, this landmark recognizing capability will need to be vehicle resident. Fortunately, the hardware and software already exists to support this capability.

The software that can be used in this invention include:
Vehicle resident location determination software based on the navigation system for the mapping vehicles. This includes the RTK based systems described above and methods of locating the vehicle when the vehicle loses satellite lock.
Neural Network, Deep Learning or other pattern recognition software for landmark recognition and extraction from the images. Although probably initially performed in the cloud for the initial map creation, eventually all equipped vehicles will have such software.
Vehicle resident software for removing lens distortions, camera and navigation system synchronization, pairing of location and pointing data with images, compression and storage software and bi-directional communications software for communication with the cloud. Additionally, software for image capture and extraction of landmarks, locating and tagging the images and landmarks therein with location & direction information. For production vehicles, special compression algorithms are needed to retain only changed landmarks for transmission to the Cloud.
For production vehicles, vehicle location from landmarks software will be needed for those vehicles which do not have an accurate navigation system. This software will be used to correct the IMU which is used for continuous vehicle location determination.
Cloud resident software for creation and management of the map database, receiving and processing of images or landmark information and other data from vehicles, extraction of landmarks from received images if they have not already been done on the vehicle, tagging the landmarks in the images, Determining the location of the landmarks from multiple images, placement of the tagged landmarks onto a GIS map, other map management operations, transmitting updated maps or portions thereof to vehicles.
During the mapping process using mapping vehicles, software is needed to schedule the travels of the mapping vehicles so that all roads and lanes thereon are traversed efficiently.
The cloud resident software can be managed through a website which also requires management software. The control and management of the vehicle resident software can be controlled though this website.

### 25. Using MAPS and GNSS to Warn Driver and Vehicle for Upcoming Curves

A common accident is where a truck, or another vehicle, is traveling too fast when it approaches a curve in the road. This can be aggravated if the road is not appropriately banked. From the accurate maps created as described herein, the safe speed of a vehicle can be calculated based on the road geometry and, if the vehicle is exceeding that calculated safe speed, the vehicle operator or operating system, for the case of a self-driving vehicle, can be warned or the vehicle automatically slowed when approaching such a curve. For trucks the center of mass and the moments of inertia of the loaded truck can be part of this calculation. A separate IMU appropriately mounted to a vehicle trailer can automatically determine both its center of mass and moments of inertia based on the trailer load which can be used in the roll over tendency calculations. For a truck or car which is not towing a trailer, the IMU used for vehicle positioning can be used for this purpose.

As a vehicle travels on a road, it is subjected to disturbances caused by the geometry of the road including bumps, small hills, and road roughness. This acts as a forcing function through the vehicle's suspension system to the vehicle body which will be displaced and rotated due to this input from the road geometry. Ideally an IMU would be placed on the vehicle chassis to more accurately measure the input to the vehicle body. However, such an IMU will generally not be present. However, the spring characteristics of the vehicle suspension and the properties of the shock absorbers are known for all production vehicles. From this information, a model can be made of the vehicle suspension system for each production vehicle. This is probably not necessary since the first time the vehicle encounters a significant bump from the road the natural frequencies of the vehicle can be measured as well as the damping properties of the suspension. Similarly, as the vehicle drives it will encounter a wide range of vibrations and disturbances which can be treated statistically to determine the vehicle response and thus its inertial properties. By knowing the mounting location of the IMU and measuring the response of the vehicle to a variety of these road induced disturbances, the mass and moments of inertia as well as the location of the center of mass of the vehicle can be calculated. With this information, the tendency of a vehicle to rollover can be determined. If the map contains information about the road geometry regarding curves, for example, as well as the side to side slope (roll) of the road, this information plus the inertial properties of the vehicle as calculated above can be combined to determine a safe operating speed for a vehicle about to execute a curve in the road. If the vehicle is exceeding this safe speed, a warning can be issued or the vehicle can be forced to reduce its speed.

### 26. Route Guidance Using Very Accurate Maps

Once accurate maps have been created based on the teachings of this invention, route guidance accuracy can be significantly improved. For example, a vehicle can be guided up a driveway right to the front door of a residence rather than just to within 100 meters as is now frequently the case. This is especially useful for self-driving ride sharing services. Furthermore, there is a move for automatic package delivery by such companies as Amazon. If the precise location of a package receptacle is known from a map, a robotic delivery system can place the package into the receptacle where it can be secured and protected from bad weather until the owner retrieves the package. Similarly, accurate maps of parking lots and parking garages can direct a vehicle driven by a human or a self-driving car to travel to an assigned parking spot and part therein. Drive through banking and fast food facilities are also facilitated for self-driving cars through accurate maps.

### 27. Mapping Techniques Using Probe Cellphones

It is difficult to get accurate position and pointing information for a cellphone taken image, but once an image has been acquired and if it contains three landmarks, the location of the cellphone can be accurately determined. Since the GNSS location of a cellphone can be off by many meters, this provides a method of more accurately finding the location of the cellphone.

One method is to send the picture containing the three landmarks along with the best GNSS location that can be provided by the cellphone system to the cloud where the map is matched to the cellphone image yielding where the image was acquired based on the analysis. That is, there is only one location which would yield the same relationship of the landmarks as shown in the picture. Such a system might even be life saving for hikers on mapped trails that are lost in a dangerous area or where the weather limits their visibility.

### 28. Aerial Mapping Drone

The same mapping principles discussed herein for probe terrestrial vehicles can be applied to drones allowing them to aid in the mapping process. Since drones operate above the roadway, they can move more rapidly and thus be used for mapping urban canyons and tunnels where GNSS signals are poor or nonexistent. When necessary, the drone can move to a higher altitude to get a GNSS fix for IMU calibration and return to a lower altitude to continue the mapping. Also, since the vehicle velocity can be higher, more distance can be traversed and mapped before the IMU loses calibration. Another approach is to accurately position a drone above a vehicle using one or more lasers. The drone can fly at a sufficient altitude as to maintain visibility of the GNSS satellites thereby removing the multipath effects. The drone can accurately determine its position and pass that information to the mapping vehicle which can then determine its position based on knowing the relative position of the drone to the vehicle.

Accurate IMU's are now available which greatly improve the distance that can be traveled by the vehicle between IMU corrections. A vehicle so equipped can start at a location clear of tall buildings where an accurate location can be determined and then travel perhaps a few kilometers, depending on the IMU drift, before requiring a new correction. If such clear zones are located prior to mapping, then a path covering an entire city can be laid out. See, for example, Systron Donner SDI500 Tactical Grade IMU Inertial Measurement Unit.

### 29. Summary

While the invention has been illustrated and described in detail in the drawings and the foregoing description, the same is to be considered as illustrative and not restrictive in character, it being understood that only preferred embodiments have been shown and described and that all changes and modifications that come within the spirit of the invention are desired to be protected.

This application is one in a series of applications covering safety and other systems for vehicles and other uses. The disclosure herein goes beyond that needed to support the claims of the particular invention that is claimed herein. This is not to be construed that the inventors are thereby releasing the unclaimed disclosure and subject matter into the public domain. Rather, it is intended that patent applications have been or will be filed to cover all of the subject matter disclosed above.

1. A method for managing and using a map database, comprising:
creating the database by:
driving mapping vehicles on roads for which information is sought be included in the database;
obtaining images of an area on and around roads on which vehicles travel using at least one camera assembly on each mapping vehicle while being driven along each road;
identifying, using a processor, common landmarks in a plurality of images obtained by the mapping vehicles;
determining a position of each mapping vehicle using a satellite-based position determining system at least partly on the vehicle such that the position at which each image is obtained by the mapping vehicle is accurately known;
determining the position of each of the identified landmarks in consideration of determined position of the vehicle when the image containing the landmark is obtained; and
including in the database, the determined position of the identified landmarks, data about the roads on which the mapping vehicles are driven and the images; and
enabling access to the database to enable use of the determined position of the identified landmarks, the data about the roads on which the mapping vehicles are driven and the images.

2. The method of claim 1, wherein the step of obtaining images comprises obtaining images until at least three images are obtained for each identified landmark and the step of determining the position of each of the identified landmarks comprises using real time kinematic (RTK) techniques to provide estimates of the position of the landmark in all of the obtained images.

3. (canceled)

4. The method of claim 1, wherein the step of driving the mapping vehicle consists of driving the mapping vehicle only once along each road when creating the database such that all information required to map each road is obtained during the sole driving of the mapping vehicle along that road.

5. The method of claim 1, wherein the step of identifying common landmarks comprises identifying, using the processor, the same landmark in a plurality of images obtained by the same mapping vehicle at different times from different locations, or
identifying, using the processor, the same landmark in a plurality of images obtained by different mapping vehicles from different locations.

6. (canceled)

7. (canceled)

8. The method of claim 1, wherein the database is at a site separate and apart from mapping vehicles, further comprising enabling access to the database using a communications system on another vehicle to enable a vehicular navigation system on the another vehicle to provide at least one of a navigation, guidance, and display functionality based on contents of the database including the identification, type and position information about the landmark.

9. The method of claim 1, wherein the step of enabling access to the database comprises:
directing a transmission receivable by the communications system on at least one vehicle that causes display of map data on a display of the vehicular navigation system based on the position of the at least one vehicle;
directing a transmission receivable by the communications system on at least one vehicle that causes automatic guidance of the at least one vehicle using a throttle, braking or steering system on the at least one vehicle; or
directing a transmission receivable by the communications system on at least one vehicle that causes change in operation of a throttle, braking or steering system on the at least one vehicle to cause at least one vehicle to alter its movement.

10. The method for claim 1, wherein the step of identifying common landmarks comprises analyzing, using the processor, images to determine the presence of one or more of a plurality of known landmarks of different types in the images, each of the landmarks having a unique identification and an anchor point specific to the type of the landmark such that different types of landmarks have different anchor points further comprising
considering whether to add a new landmark to the database by:
for each landmark,
determining, using the processor, a first position value for the landmark based on mapping vehicle position when at least one of the images including the landmark is obtained and at least one vector between the mapping vehicle when a respective one of the at least one image was obtained and the anchor point on the landmark;
determining, using the processor, whether the database that initially does not contain information about all landmarks and positional information includes presence of the landmark at approximately the first position value; and
when it is determined that the database does not include presence of the landmark,
considering this landmark to be a new landmark and assigning, using the processor, a unique identification to the new landmark;
selecting, using the processor and based on the image including the landmark, a type of the new landmark from among the different types of landmarks; and
updating the database to include the assigned identification, the selected type and position information about the new landmark, the step of assigning a unique identification to the new landmark comprises deriving the unique identification based on the selected type of type and anchor point specific to the selected type of landmark.

11. The method of claim 10, wherein when it is determined that the database includes presence of the landmark at approximately the first position value, the method further comprises:
obtaining a plurality of images of the landmark when the mapping vehicle is in different positions relative to the landmark;
determining, using the processor, a plurality of vectors each between the mapping vehicle when in one of the different positions and the anchor point of the landmark; and
determining, using the processor, an intersection between the determined plurality of vectors; and
updating the first position value to be the intersection between the determined plurality of vectors.

12. The method of claim 1, further comprising obtaining position of a vehicle other than one of the mapping vehicles by
determining, using the processor, a first position value for the landmark based on satellite-based vehicle position when at least one of the images including the landmark is obtained and at least one vector between the vehicle when a respective one of the at least one image was obtained and the anchor point on the landmark;
accessing, using a communications system on the other vehicle, the database of landmarks and positional information to retrieve a second position value for the landmark from the database;
analyzing, using the processor, the first and second position values for the landmark and deriving positional correction information based on differences between the first and second position values; and
deriving the other vehicle position by correcting the determined position estimate of the other vehicle using the derived positional correction information.

13. The method of claim 12, wherein the step of deriving the other vehicle position by correcting the determined position estimate of the other vehicle using the derived positional correction information comprises correcting data from an inertial measurement unit (IMU) on the vehicle that is used for vehicle position determining purposes, further comprising:
correcting data from the IMU by:
establishing a set of rules for each of the different types of landmarks that identify location of the anchor point of that type of landmark;
identifying, using the processor, one of the landmarks in an obtained image and determining the type of the landmark;
determining, using the processor, a first estimation of the location of the anchor point by applying the established rules and the determined type of landmark to the landmark;
determining, using the processor, a second estimation of the location of the anchor point by determining an identification of the landmark in the database and then retrieving positional information for the landmark from the database;
comparing the first and second estimations;
correcting the IMU based on the comparison; and
using data from the IMU as corrected to generate positional information about the vehicle.

14. (canceled)

15. (canceled)

16. The method of claim 1, further comprising allocating parking spaces based on content of the database, the step of allocating parking spaces comprising:
receiving, at a processor, requests for available parking spots from other vehicles:
identifying, using the processor, position of an available parking spot; and
when one of the parking spots is identified as being available and a plurality of other vehicles have provided requests for available parking spots,
accessing using the processor, the database and determining a travel path of each of the other vehicles from a current position of each other vehicle providing a request to the available parking spot,
determining, using the processor, a time that each of the other vehicles providing a request is waiting for assignment of an available parking spot,
assigning using the processor, the available parkins spot to one of the other vehicles providing a request based on the determined travel paths of each of the other vehicles to the available parking spot and the determined time that each of the other vehicles is waiting for an assignment of an available parking spot such that wait time is a factor in the assignment of available parking spots to the other vehicles; and
generating using the processor and sending via a communications system, a notification to the other vehicle providing the request to which the available parking spot has been assigned of its assigned available parking spot.

17. (canceled)

18. The method of claim 16, wherein the step of identifying position of an available parking spot comprising accessing the database that includes data about permissible parking spots and analyzing images to identify position of a parking spot in any of the obtained images that is not occupied and thus available by determining when in an image, a vehicle is not present in one of the permissible parking spots, further comprising causing the notification sent to the other vehicle providing the request to which the available parking spot has been assigned to activate a vehicle guidance system to cause the other vehicle to be automatically guided to the assigned available parking spot or to cause audible and/or visual directions to be provided to guide a driver of the other vehicle to the assigned available parking spot.

19. (canceled)

20. (canceled)

21. The method of claim 1, further comprising:
storing the database in non-transitory computer-readable storage medium at least partly on another vehicle;
receiving, via a destination receiving unit, one of a plurality of different destinations for a trip involving the another vehicle; and
causing operation of at least one of a display, navigation, control and guidance system in the another vehicle to change from an existing operating state to one of a plurality of different operating states as a result of receiving one of the different destinations, the specific one of the different operating states to which the display, navigation, control or guidance system is changed being determined based on the destination, the step of causing operation of at least one of a display, navigation, control and guidance system to change comprising:
causing at least one of the control and guidance system to enter into an operating state in which the control or guidance system controls movement of the another vehicle, or
directing, using a processor coupled to the database and the display, the display system to display a map derived from map data in the database based on input to a user interface having variable operation dependent on input and which is also coupled to the processor, the display being oriented in a position to enable the map to be viewable by an occupant in a compartment of the another vehicle.

22-24. (canceled)

25. A system that generates and enables use of a database, comprising:
a vehicle-mounted imaging system that obtain images of the environment around the vehicle, a position and pointing direction of said imaging system relative to the vehicle being known;
a positioning system arranged at least partly on the vehicle and configured to provide the current position of the vehicle;
at least one memory component capable of storing the database;
a processing system coupled to said imaging system, said positioning system and said database and that:
associates position of said imaging system when each image was obtained by said imaging system to that image,
identifies at least one point on each object in any image obtained by said imaging system,
identifies a plurality of images that contain the same object and have different associated positions,
determines the position of each identified point on each object based on the known position and pointing direction of said imaging system when each of the plurality of images being used to determine the position of each identified point was obtained; and
manages the database to include data about each object including an identification of each object and the determined position of at least one point on the object, and the images including the object; and
a server coupled to the database and that controls access to said database to enable retrieval of images and data from said database.

26. (canceled)

27. (canceled)

28. The system of claim 25, wherein said imaging system comprises at least three cameras, each of said three cameras having an imaging field of 120° and each adjacent pair of said three cameras being positioned to have a not more than 15° overlapping imaging field, said at least three cameras being housed in a common housing having a transparent covering over imaging portions of said at least three cameras, said at least three cameras and said transparent covering being part of a camera assembly attached to a surface of a roof of the vehicle.

29-31. (canceled)

32. The system of claim 25, wherein said processing system determines the position of each identified point on each object by determining a virtual vector from said imaging system to that point in at least two images identified to contain that object based on the position and pointing direction of said imaging system when each of the plurality of images was obtained by said imaging system, said processing system identifying a plurality of points on each object in any image obtained by said imaging system and then determining the position of each of the plurality of identified points on that object, said processing system further managing said database to store a relationship between the plurality of points on the same object to enable presentation of the at least one image retrieved from said database via said server in accordance with the stored relationship.

33. (canceled)

34. (canceled)

35. The system of claim 32, wherein said processing system identifies a single point on each object in any image obtained by said imaging system and determines the position of the single identified point on each object.

36. The system of claim 35, wherein said processing system further
identifies pixels of any object in the at least two images;
quantifies changes in position of the same pixels of the object in the at least two images; and
store the quantified changes to enable presentation of the at least one image retrieved from said database via said server in accordance with the quantified changes.

37. (canceled)

38. The system of claim 35, wherein a first part of said processing system is arranged on the vehicle and a second part is arranged at a remote site separate and apart from the vehicle, said first part of said processing system is configured to perform the steps of associating position of said imaging system when each image was obtained by said imaging system to that image, identifying an anchor point on each object in any image obtained by said imaging system, identifying a plurality of images obtained by said imaging system that contain the same objects and have different associated positions, and determining the position of each object.

39. The system of claim 35, further comprising an inertial measurement unit (IMU) arranged on the vehicle and coupled to said processing system, said IMU obtains angular velocity and linear acceleration data about the vehicle, said imaging system being registered with said IMU such that a position and pointing direction of said imaging system are determined based on data obtained by said IMU.
